(19) United States
(12) Patent Application Publication
(10) Pub. No.: US 2006/0063490 A1
(43) Pub. Date: Mar. 23, 2006

(54) System for simultaneously transmitting multiple RF signals using a composite waveform

(76) Inventors: David M. Bader, Erwinna, PA (US); Benjamin L. Goodman, Kintnerville, PA (US); John E. Rylander, Rochester, MN (US); Rickie A. Sprague, Howell, MI (US); Steven F. Starcke, Rochester, MN (US)

Correspondence Address: ARTHUR FREILICH, 9045 CORBIN AVE, #260, NORTHRIDGE, CA, 91324-3343, US

(21) Appl. No.: 11/223,668

(22) Filed: Sep. 9, 2005

Related U.S. Application Data
(63) Continuation of application No. PCT/US04/07667, filed on Mar. 11, 2004.
(60) Provisional application No. 60/454,243, filed on Mar. 12, 2003.

(51) Int. Cl. H04B 7/00

(52) U.S. Cl. 455/45; 455/102

(57) ABSTRACT

A digitally controlled media multicasting system containing a signal processing system accepting and optionally modifying one or more independent single- or multi-channel baseband signals (typically, but by no means necessarily, audio or video signals); amplitude-, frequency-, or phase-modulating specified RF, IF, or LF carrier wave(s) in accord with said baseband signal(s); and then compositing the modulated carrier waves into a smaller quantity of waveform(s), said waveform(s) being (as necessary) frequency-multiplied or -shifted, and amplified for wireless transmission.

### RELATED APPLICATION

This application is a continuation of international application PCT/US2004/007667 filed on Mar. 11, 2004 and claims priority based thereon and on U.S. provisional application No. 60/454,243 filed on Mar. 12, 2003 which applications are incorporated herein by reference.

### BACKGROUND OF THE INVENTION

Analog broadcasting has been for decades the preferred medium for wirelessly delivering high fidelity audio and video. Inexpensive and effective, it continues to dominate to this day.

But digital technology is fast encroaching on analog's turf. Beyond the interesting legal requirement that US commercial television broadcasters go exclusively digital, digital has numerous practical advantages: it is typically more robust (i.e., more successfully resistant to interference, distortion, and degradation) whether on the air, on wires, or on persistent media such as CDs and DVDs, which makes it more physically portable. It's also more logically portable, the same software logic working on a wide variety of different hardware substrates, and just as importantly, the same hardware working with a wide variety of different software logics-even simultaneously. The quality is arbitrarily high, and digital media are increasingly easily manipulated (equalized, pixelized, etc.) for superior artistic quality and for individual environments and tastes.

On top of this, the digital components are becoming cheaper by the month. DSPs, PALs, FPGAs, DACs, & ADCs have all been following Moore's Law, to the delight of designers, OEM customers, and ultimately consumers, and the proliferation of PCs has made de facto DSPs available to hundreds of millions of people worldwide.

(In order to emphasize the digital control aspect, “DSP” will in this document unless otherwise specified refer to digital signal processors that also include logic and control capabilities, a common but not universal DSP capability. Sometimes only a control processor will be necessary which is labelled here “DCP”.)

While many aspects of digital media (its generation, storage, transmission, and manipulation, e.g.) are nearly ubiquitous, most thoroughly in the case of wired audio but also increasingly with wired and broadcast video, digitally modulated wireless broadcasting generally is fairly new—e.g., digitally modulated analog FM transmission. Applications by Mellot (20020011904) and Zhang (20010000313) depict different digital means for basic, single-signal baseband modulation, e.g.

But such valuably simple approaches don't begin to exhaust the utility of digital technology for FM broadcasting, nor for a wide variety of other analog and digital RF broadcast applications (NTSC, PAL, AM, BPSK, QPSK, etc.).

### SUMMARY OF THE INVENTION

The main object of the current invention is, in a media localcasting context, the transmission of multiple simultaneous RF signals via a digitally controlled signal processing system, ideally (but not necessarily) with a smaller quantity of—perhaps even just one—composite output waveform(s).

This permits one device instantiating the invention to reach multiple individual (or sets of) analog or digital RF receivers while allowing different content for each—another object of the invention.

A typical application of this would be a local multimedia multicasting system in which multiple audio and/or video streams could be wirelessly broadcast from a content server to similarly multiple (and typically very conventional, off-the-shelf) nearby receivers in a home, business, hotel, cafe, apartment, building, or so forth, interactively or on a pre-scheduled basis.

Broader, secondary applications include use of digitally controlled or modulated digital or analog RF to reach non-audio-visual devices. This approach has multiple advantages over traditional shared-bandwidth device communication (e.g., 802.11b). It allows simpler, thinner, smaller, and cheaper clients, since potentially much less processing power is required to receive and decode the signal. It reduces latency of the signal, since the signals are never delayed by other traffic in the same stream (frequency-division multiplexing rather than coarse, in-stream time-division multiplexing, resulting in multiple simple streams at different frequencies rather than synchronously or asynchronously [i.e., on an irregular or ad hoc basis] interleaved media data, as necessary in shared-medium streaming, such as over a shared network segment), thereby ensuring a continuous, rather than merely continual, stream of information, reducing or typically eliminating the need for any discontinuity-induced buffering by the receiver.

The system is based on a digital control (and in some embodiments, signal) processor, broadly construed: commonly just the CPU in a PC, Macintosh, handheld, workstation, etc., but alternatively (in a standalone box or highly autonomous PC adapter card, e.g.) any of the more exotic but cheaper-in-bulk specifically digital-signal-processing-oriented processors, or if only control (not processing) is digital, cheaper processors still.

The invention receives single-, dual-, or multi-channel (typically, but not exclusively, audio and video baseband) input from a plurality of sources (including, in many embodiments, its own storage capabilities), typically simultaneously. In the simplest embodiment, for each baseband input, it then digitally specifies a carrier wave (that is, digitally directly creates a modulated carrier wave, digitally modulates a pre-created or pre-existing carrier wave, or digitally controls analog versions of these processes), using (e.g.) AM, FM, or PM modulation conventions (and their many subsidiary variants), simultaneously or shortly thereafter compositing them, that is, combining them into a single, more complicated, relatively broadband waveform, via digital or digitally-controlled-analog arithmetic adding or averaging, the composite being in any event proportional to the sum of the simple carriers which comprise it. (There may be occasions when multiple composite signal outputs would be desirable, e.g., going to a distinct transmitter for each of multiple bands, such as AM, FM, UHF, 2.4 GHz, etc.)

Before broadcast and if necessary the signal is converted to analog using a high performance DAC. (With analog processing or certain forms of square wave or digital broadcasting output, such conversion would in principle not be necessary.) If the signal is IF (or LF), it would typically be moved to the relevant RF band using a frequency multiplier, mixer, SSB modulator, or other upconverter. The resulting RF signal is then fed to an appropriately-broadband RF amplifier, which then broadcasts the signal via a standard antenna.

### LIST OF FIGURES

FIG. 0A: Local Multi-Casting Media Server Overview Legacy Frequency Transmission

FIG. 0B: Software Overview Flowchart

FIG. 0C: Multi-Casting Media Server Contextual Overview, Legacy Frequency Transmission

FIG. 0D: Multi-Casting Media Server Contextual Overview, 900 MHz Transmission

FIG. 0E: Multi-Casting Media Server Contextual Overview, 900 MHz Multi-Transmitter.

FIG. 1: Basic overview of the simplest form of the compositing aspect of the invention

FIG. 2: Compositor Software Input overview flowchart

FIG. 3: Compositor Software Processing Detailed Overview flowchart

FIG. 4: Compositor Software Change-Settings flowchart

FIG. 5: Multi-Band via Multi-DSP/DAC Embodiment Overview

FIG. 6: Single-DSP, multi-DAC Embodiment Overview

FIG. 7: IF (Intermediate Frequency) Embodiment Overview

FIG. 7A: IF Mixer Embodiment

FIG. 8: Multi-DAC, Single Frequency Multiplier Embodiment Overview

FIG. 8A: Multi-DAC, Single Mixer Embodiment Overview

FIG. 9: Multi-DAC/Frequency Multiplier Embodiment Overview

FIG. 9A: Multi-DAC/Mixer Embodiment Overview

FIG. 10: Single-DAC, Multi-Frequency Multiplier Embodiment Overview

FIG. 10A: Low-Frequency-Input Mixer Embodiment

FIG. 10B: Easier Signal Processing, Harder Filtering

FIG. 10C: Harder Signal Processing, Easier Filtering

FIG. 10D: Single-DAC, Multi-Mixer Embodiment Overview

FIG. 11: Digital Synthesizer/Numerically Controlled Oscillator Embodiment

FIG. 12: Compositor Software Processing Overview for DS/NCO

FIG. 13: Multi-DS/NCO Embodiment Overview

FIG. 14: Compositor Software Processing Overview for Multi-DS/NCO

FIG. 15: Paired-Baseband Single-DS/NCO Embodiment Overview

FIG. 16: Compositor Software Paired-Baseband DS/NCO Overview flowchart

FIG. 17: Paired-Baseband Multi-DS/NCO Embodiment Overview

FIG. 18: Single DAC, Multi-Analog-Modulator Embodiment Overview

FIG. 18A: Single DAC, Multi-Smart-Modulator Embodiment Overview

FIG. 18B: Single DUC Compositing Embodiment Overview

FIG. 18C: Multi-DUC/DAC Embodiment Overview

FIG. 18D: Multi-DUC with Digital Summer Embodiment Overview

FIG. 18E: Digital Baseband Modulator Embodiment Overview

FIG. 18F: Digitally Controlled Pure-Analog External Baseband Modulators Embodiment Overview

FIG. 18G: Digitally Controlled External Digital Baseband-Input Modulators Embodiment Overview

FIG. 19: 900/2400/5700/24000 MHz Single-Stage Transmission Overview

FIG. 20: 900/2400/5700/24000 MHz Multi-Stage Transmission Overview

FIG. 21: 900/2400/5700/24000 MHz Meta-Transmission Overview

FIG. 22: Simplified Sub-Case of Baseband & Low-Frequency Compositing

FIG. 23: Baseband Compositing 900/2400/5700/24000 MHz Single-Stage, Multi-Stage Overview

FIG. 24A: Multiple 1-Bit-Serial DSP Direct-Digital RF Carrier Output (DAC-less)

FIG. 25: Multiple 1-Bit-Serial DSP Direct-Digital IF Carrier Output (DAC-less)

FIG. 26: Multiple 1-Bit-Serial DSP Direct-Digital Baseband Output (DAC-less)

FIG. 27: DSSS Baseband Spreading via Pseudo-Random Noise (PN) Codes

FIG. 28A: Digitally Controlled, Mixed Digital and Pure Analog Processing Broad Embodiment Overview

FIG. 30A: Sample Devices Supplying Input to TV-Oriented Embodiments

FIG. 31A: RF Television Frequency Wireless Single-Stage Transmission Overview

FIG. 32A: 900/2400/5700/24000 MHz Television Wireless Dual-Stage- & Meta-Transmission Overview

FIG. 33A: 900/2400/5700/24000 MHz Television Wireless Single-Stage Transmission Overview

FIG. 34A: Composite 802.11* Television Wireless Single-Stage Transmission Overview

### THE PREFERRED EMBODIMENT OVERVIEW

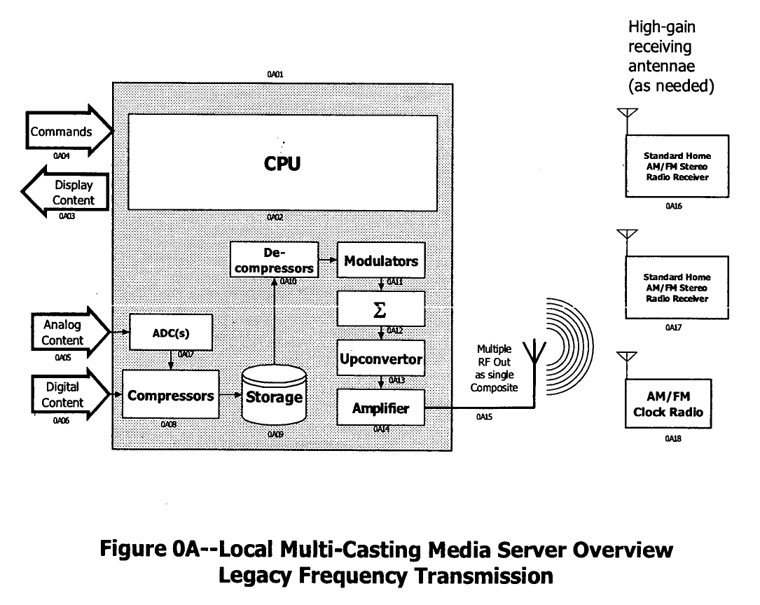

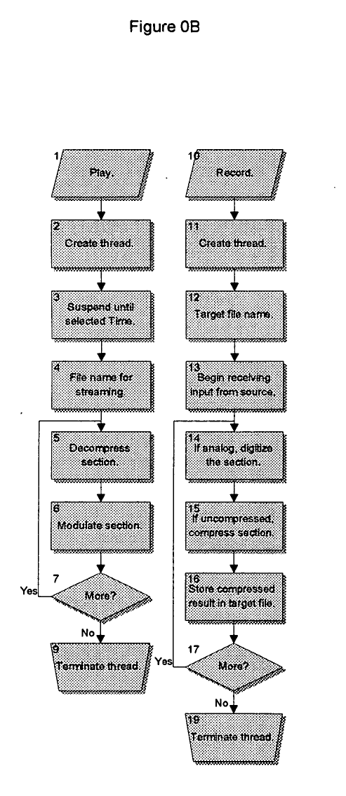

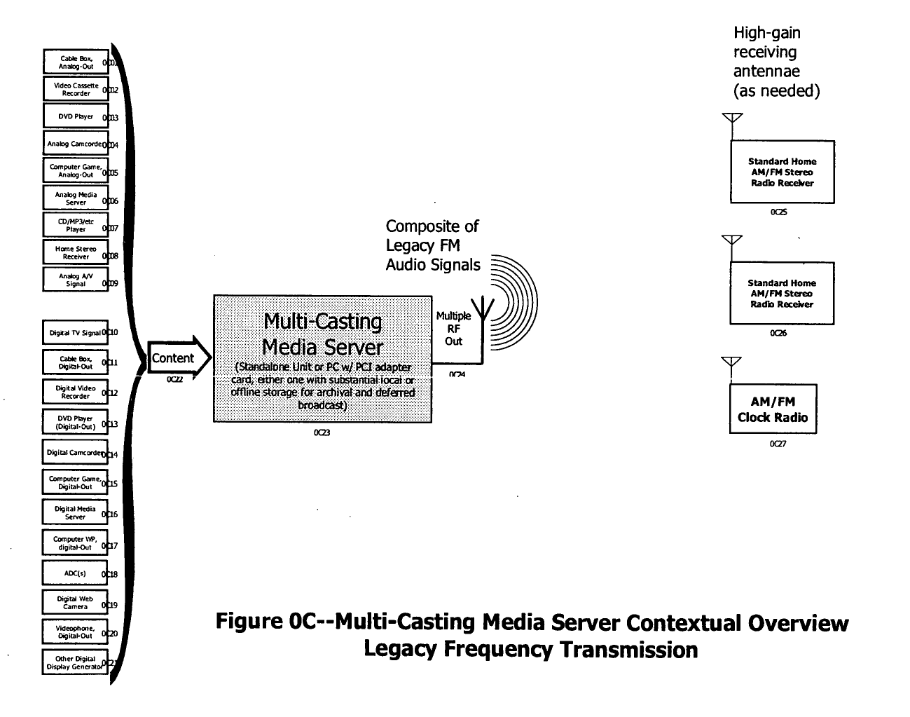

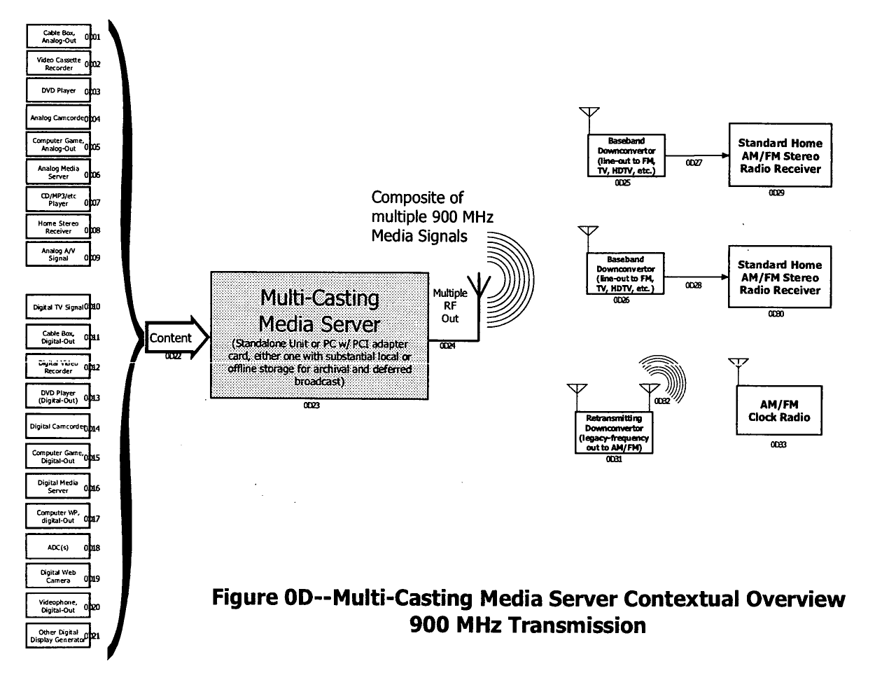

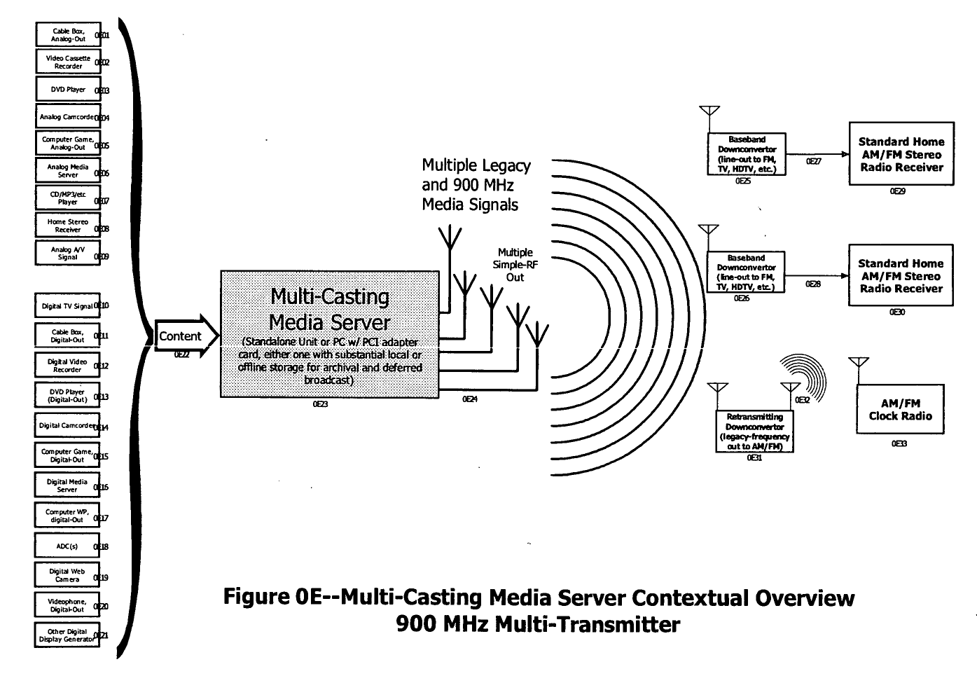

FIG. 0A depicts the preferred localcasting embodiment of the invention, with succeeding figures showing some basic and important variations.

FIG. 0A shows the local multi-casting media server (0A01) with some internal detail and external context. (In the preferred embodiment, this server exists as a standalone unit with its own local CPU and storage, but other desirable embodiments would have the server hosted by a PC via a PCI or similar interface card, only the components not available in the PC—e.g., the ADCs and radio transmission components-then included on the card.)

Under CPU (0A02) software control (see flowchart overview below in FIG. 0B), the local multicasting media server displays its current content and options (0A03) and responds to user commands (0A04) to record/acquire and play media files according to user wishes. This is depicted in block-diagram-form in FIG. 0A, and in parallel flowchart form in FIG. 0B.

Content acquired may come in either of analog (0A05) or digital (0A06) forms. If analog (0A05), the content is first converted to digital by an analog-to-digital convertor (0A07), and then passed to a compressor (0A08). (In the preferred embodiment, the compressor is simply a software component executed by the CPU, but in other embodiments, hardware may be used for some or all compression needs.) The type of compression applied, of course, varies with the type of media signal initially received. Audio compression of the mp3, wma, ogg, or similar type would be applied to audio signals. The preferred embodiment deals only with audio, but other desirable embodiments would use MPEG-1, -2, -4, QuickTime, or similar sorts of video compression applied to a video media input signal.

Digital content input (0A06) might also require compression (e.g., raw PCM audio, as from a conventional audio CD), in which case the compressor (0A08) would again come into play; otherwise, the data would pass the compressor unchanged.

The compressed data are then sent by the CPU to storage (0A09), preferably a hard disk drive of significant size (100 GB or more). Once in storage, the media are available for playback at any time.

When a play command (0A04) is received (either directly from the user, or on a time-triggered basis from a previous user command), the relevant media files are retrieved from storage (0A09), decompressed (0A10), and then used to modulate (0A11) intermediate frequency carrier signals—one carrier per concurrent media file to be played. The resulting IF carriers are then composited (0A12), collectively upconverted to the target frequencies, (0A13), and finally amplified (0A14) and broadcast (0A15) at legacy RF frequencies, multiple RF carriers being transmitted as a single composite waveform, the individual carriers being resolved without difficulty by the ordinary legacy receivers (0A16-8).

FIG. 0B describes this same process in purely software terms with a brief flowchart.

When the command is given to record or acquire media data (0B10), a thread is created (0B11) that will continue executing so long as more input data are available. The target file is created (0B12), and receipt of input from the external source begins (0B13). If the source is analog, then (since all local compression and storage are digital) the information is first digitized (0B14), section by section as it's received. (Analog information is generally received in continuous real-time stream.) The (now) digital information section is, if not already compressed (e.g., raw PCM audio versus music already in MP3 form), compressed appropriately (0B15) and appended to the target file. If there are more data incoming (0B17), execution continues with step OB14; otherwise, the thread successfully terminates (0B19).

Given a play command (0B1), as with record, a new thread is created (0B2), which thread will continue to exist until completed. If immediate playback is request, execution continues; if the playback request is for a future time, the thread is suspended until the operating system restarts it at the desired time (0B3). The specified file (0B4) is opened from storage and decompression begins (0B5). As each section of the file is decompressed, it is immediately used to modulate an IF carrier wave (0B6). The output carrier wave is summed with other modulator carrier wave output, but in the preferred embodiment, this is done in hardware. If there are more data in the file (0B7), the thread continues executing at step 0B5; otherwise, if successfully terminates (0B9).

The preferred and related embodiments rely upon any of a wide variety of input sources, as shown in FIG. 0C. Cable television set-top boxes (0C01) currently typically offer analog output for a conventional analog television receiver; that output could as well be used as an input to this preferred embodiment of the invention. Likewise, a video cassette recorder (0C02), DVD player (0C03), analog camcorder (0C04), video/computer game analog-out (0C05), analog media server (0C06—which, it's important to note, may deal with audio instead of or in addition to video), CD/MP3 player (0C07—or there may be another sort of compression used, of course [WMA, MC, ATRAC, Ogg, etc.]), a home stereo receiver (0C08), or more generally, any analog TV/video or audio signal (0C09).

Of course, contemporary input sources are progressively switching to digital output, and the invention includes means of accepting that as well. For example, a digital television signal (0C10), which signal might come from a cable set-top box digital out (0C11), digital video recorder (0C12—though as of this writing, most of them output an analog signal by default), a DVD player (0C13), digital camcorder (0C14), or a digital video output from a computer/video game (0C15). As above, another media server, in this case digital-out (0C16), could be a source of a variety of content. One might also receive input more generically digital: e.g., DVI or other non-TV-format digital display output from a computer (0C17—which might be displaying word processing information, e.g.). Still more generic, an analog signal (of whatever sort, but the format would need to be acceptable to the software and hardware design of the localcasting server) could be digitized by ADC hardware (0C18). A digital web cam (0C19), videophone (0C20), or other digital display generator (0C21) exemplifies still more input source options for the preferred embodiment.

Collectively, these various input sources are called in this figure “content” (0C22), which is received (and stored) by the local-multi-casting media server (0C23). (Storage, versus redistribution alone, is preferable since that offers tremendous flexibility to the users with respect to not only place but also time and quantity of media playback.)

This software here taken for granted, the media server uses the desired baseband media signals to modulate legacy-type and -frequency carriers (each destination individuated by its own frequency), said carriers (0C24) then being broadcast (typically after compositing) to nearby legacy-frequency receivers, such as a pair of AM/FM stereo receivers (0C25-6) and an AM/FM clock radio (0C27). Note well that in principle, “legacy receivers” just as well include analog and digital television sets, except that in practice, and in the US, current FCC regulations prohibit any intentional radiation in those legacy, television-channel frequencies.

Even in the AM and FM frequency ranges, output is strictly limited, making use of high-gain receiving antennae (to supplement or replace the legacy devices' standard antennae) sometimes desirable, depending on factors such as the sensitivity, range, and line-of-sight of the receiver with respect to the transmitted signal. (One might, e.g., use helical resonators for higher gain, so long as a certain amount of “aiming” the receiving antenna toward the transmitter along with a certain amount of tuning toward preferred frequency ranges in permissible or desirable [since both not only increase the strength of the targeted signals, but reduce the strength of unwanted rival signals]; but any of a wide variety of high gain antennae may prove feasible in particular instances.)

Another way around these regulations is via the use of 900 MHz (or similarly less regulated, such as 2400, 5700, or 24000 MHz) transmissions and receiver-attached downconvertors, as shown in FIG. 0D.

The input-side of the invention is the same as in FIG. 0A. Any of a wide variety of audio, video, and possibly other analog and digital inputs (0D01-21)—collectively, the input content (0D22)—is received by the local-multi-casting media server (0D23). The content is then, under software control as outlined above, used to modulate multiple 900 MHz RF carriers which are then composited, which carrier(s) are then broadcast (0D24). (In this context, “900 MHz” actually refers to the span of 902-928 MHz; “opened up” by the FCC to permit wider, deregulated exploitation by the private sector.)

The biggest difference comes on the receiving side. Rather than direct legacy reception (as in 0A), the receivers-proper are downconverters. Downconvertors (0D25-6) receive the 900 MHz signal(s), demodulate them according to their original modulation format, and then conduct the resulting baseband signals (0D27-7) to connected stereo receivers (0D29-30). (This method also handles video, bypassing the FCC's prohibition.)

Some downconvertors (0D31) usefully instead retransmit the signals at legacy frequencies (0D32), the low FCC power limits being overcome by downconvertor proximity. This also works perfectly with legacy devices that may lack an auxiliary input, such as clock radios (0D33), or in cases where connecting another cable is inconvenient. (Note that this is ineffective in the case of legacy-frequency television video, since the FCC-approved power limits are not merely low, but zero.)

Note that one may well wish to mix these embodiments, using FIG. 0A as a model for audio, FIG. 0D for video, for example, in one hybrid device the broadcasts in both legacy and 900 MHz (or similarly deregulated) bands.

Note too that some receivers might use high-gain antennae not only to receive very low-power legacy-frequency signals, but even to receive higher-power signals in a noisier, high-interference environment, or at longer range.)

Another derivative from the preferred embodiment would be simply to use multiple narrowband transmitters for the multiple signals, as shown in FIG. 0E. This figure is made intentionally identical, mutatis mutandis, to FIG. 0B. Labeling aside, the only diagrammatic difference is the quantity of transmitting antennae (collectively 0E24; the quantity of five is arbitrary and is meant simply to illustrate plurality) and (implicitly) the quantity of transmitters. (It's important to note that one could have multiple amplifiers or transmitters sharing antennae as well-this option is hereby noted but not illustrated.)

### DETAILED DESCRIPTION OF THE SIMPLEST-IN-PRINCIPLE EMBODIMENT OF THE COMPOSITOR ASPECT (1 DSP. I DAC. PCM)

Perhaps the most distinctive aspect of this local multicasting is the multi transmission aspect, most especially when (as in the preferred embodiment) this is effected via compositing to significantly reduce transmitter costs and design complexity. Highly optimized for multi-signal transmission, this permits communicating with multiple media presentation devices-particularly legacy receivers which are designed to operate on a single frequency at a time-very simply and at a very low cost relative to rival approaches (e.g., 802.11-based technologies).

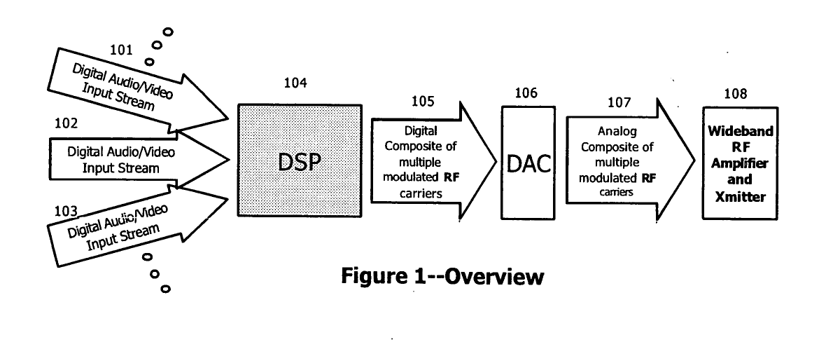

FIG. 1 displays the simplest embodiment of the compositing aspect (hereafter, “compositor”) in an overview form.

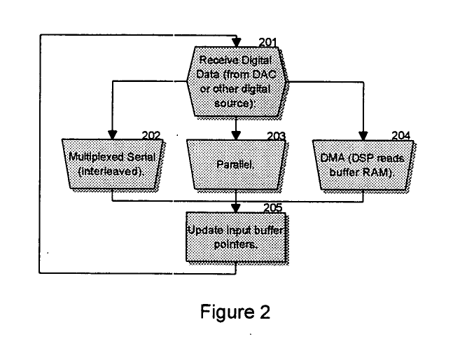

A plurality of digital audio and/or video baseband input signals (represented by 101-103) are received by the DSP (104) and placed into memory. This process is detailed in FIG. 2, a simple flowchart that list the various means available to the DSP to acquire the data-means well known to prior art, but helpful to recall here. This flowchart is separated from the main processing flowchart to indicate that this may happen asynchronously (perhaps interrupt driven, e.g.). The DSP acquires data in 201 from any of a variety of sources: multiplexed/interleaved serial (202), which may be serial at either the bit or a higher (e.g., byte or word) level; parallel (203), the processor simultaneously accepting input on a variety of input ports (typically via scanning them serially-even so, the data arrives at the DSP in parallel); and/or via DMA (204), which demands more intelligence from the data source but frees the DSP input-handler from any but the most modest housekeeping tasks. Whatever the means of input, the DSP logs the location of the buffer(s) where the data are stored (205), if any, so that it can be processed soon and so that new input can be received at once without the premature loss of earlier data. (If the receipt of input is synchronous and the DSP horsepower abundant, one might skip buffering and proceed directly to process the particular data just received, but this is not a typical embodiment.)

Note that while in this example and generally, the input streams are depicted as audio/visual and the subsequent flowcharts are based upon that, nothing in the compositing aspect of the invention per se requires the streams to be such. Both in principal and, mutatis mutandis, in practice, the streams could be any baseband digital signals with no substantial change to the spirit or even the hardware of the compositor, though of course the details of software processing in a particular embodiment may vary substantially. (E.g., one would not have an external user or internal software control to change the tone, volume, or sampling rate of an e-mail.).

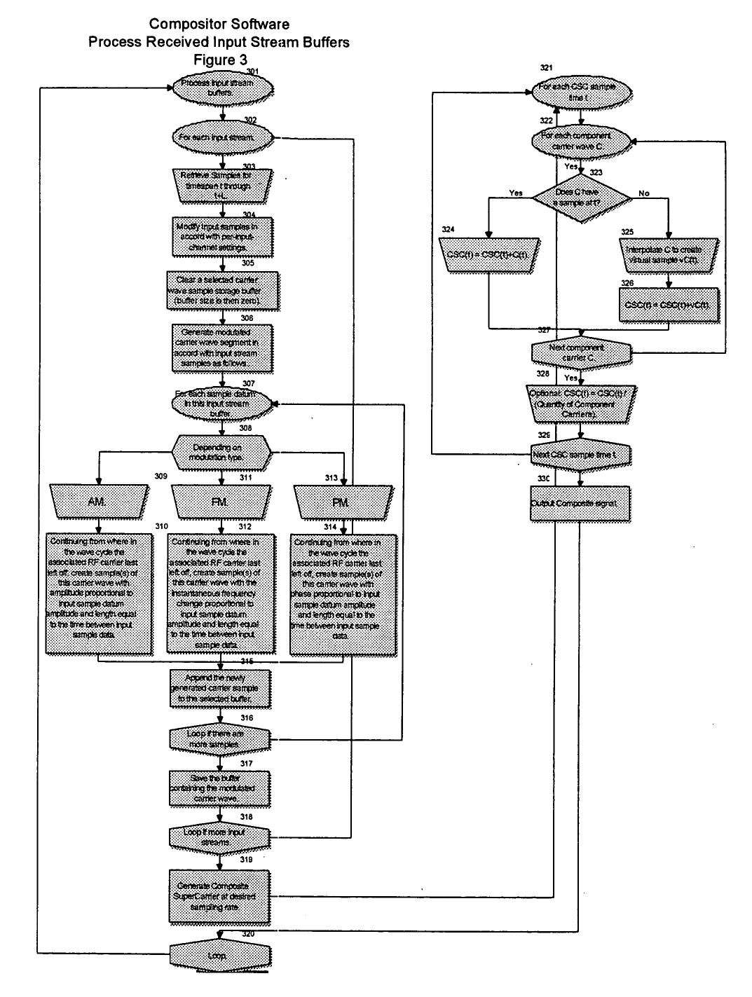

The DSP then processes the buffered inputs according to the Flowchart in FIG. 3.

The DSP begins to process the memory buffers (301). As detailed above, this processing may be interleaved synchronously with moving new input to memory, or it may be interrupted as needed for that task, the input may be placed in memory via DMA (requiring no immediate DSP attention), or the input may skip buffering and instead be synchronously sampled directly as processed.

For each input stream (302), if necessary the new input samples are retrieved (303) from the buffer in memory for a span of time t through t+L, where L is the latency period (i.e., the amount of time of sampling stored in the buffer, signal output being delayed from the input by that amount plus processing time)-this is not necessary if the input is not buffered (in which case L will be very small, typically the quantity of time between individual samples).

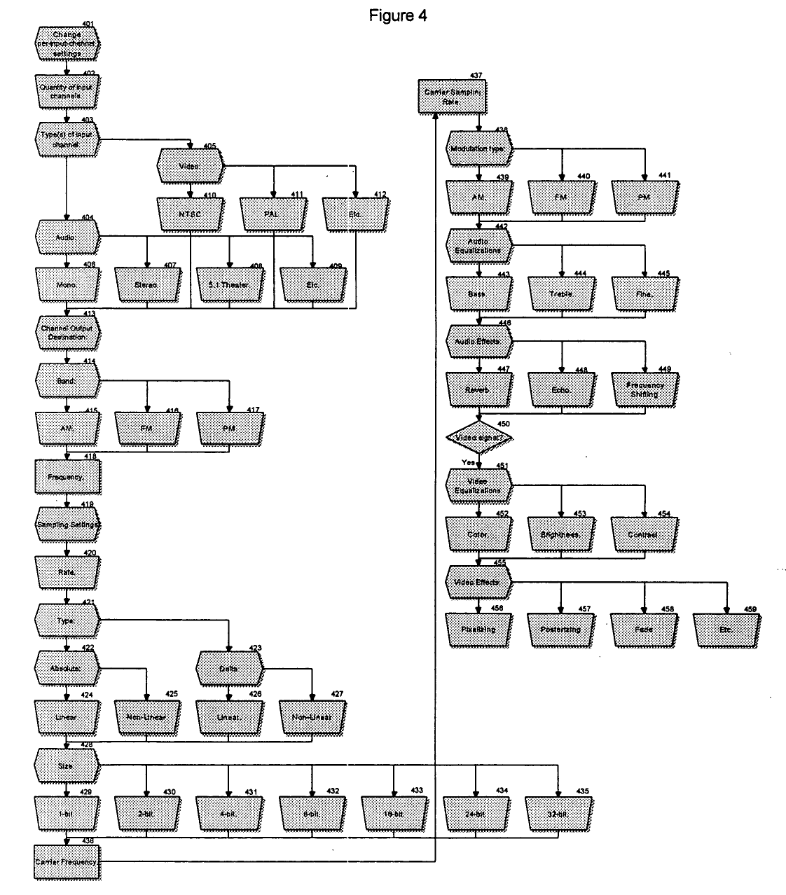

The received samples are then modified (304) in ways well known to prior art to affect the signals as previously specified: equalizing the audio, adding reverb, adjusting video contrast, and so forth. (The specification of the parameters of these modifications is given below and diagrammed in FIG. 4.)

Once the incoming baseband signal is in the desired form, processing moves to the RF carrier waves. The input data are used to create directly a modulated RF carrier wave signal (rather than modulating a pre-existing or pre-created unmodulated carrier wave, though one could easily take that approach instead); the precise mathematics of the modulation will depend entirely on which method of modulation is preferred. (The selection of this preference, like audio and video modification settings, is described below and diagrammed in FIG. 4.)

To process the input samples, a processing loop (307) is started looping through each datum in this input stream buffer. In the actual implementation, there would likely be a separate loop for each modulation type, but for simplicity of exposition and to make clear the conceptual commonalities, we share the loop between modulation types, choosing a modulation type within a loop (308) instead of before any loops.

If the modulation type is AM (309), continuing from where we left off (unless we are just starting this carrier) we create samples of a digital carrier wave of a constant frequency (which frequency is set in FIG. 4), varying the amplitude of the carrier wave envelope in proportion with the amplitude of the baseband input stream (310). This carrier will typically have many more samples per unit time than the baseband input stream—the precise amplitude variation will be applied to each carrier sample in the span of time covered by the input sample.

The precise mathematical expression of the carrier wave as modulated by baseband signal is given by the following formula:
AMᵢ(t)=A·(1+S·m(t))·sin(ω_{c}_{ᵢ}·t)

Expressing that in ordinary language, the amplitude of the modulated AM carrier at moment in time t is equal to an amplitude constant A (representing basically the broadcast strength of the signal) multiplied by the sum of the baseband signal scaling constant S times the amplitude of the baseband “message signal” m at time t plus 1 (such being added to ensure that the sum is non-negative), this finally being multiplied by the sine of ω_{c}_{ᵢ} (this carrier's frequency) at time t.

The resulting carrier wave sample(s) are then appended to the carrier wave sample buffer (315), and the loop continues if there are more samples (316). If not, the carrier wave buffer is stored for later compositing.

If the modulation type is FM (311), then instead of the amplitude of the modulated carrier envelope varying with the amplitude of the baseband signal (as in AM), the frequency deviation of the modulated signal varies in proportion with the amplitude of the baseband signal (312), carrier sampling considerations being even more significant, typically, given the typically higher frequency of an FM carrier.

The resulting carrier is mathematically equivalent to the wave generated by:

$${FM}_{i} ( t ) = A \cdot sin ( {ω}_{{c}_{i}} \cdot t + S \cdot {\int }_{0}^{t} m ( τ ) ⅆ τ )$$

The amplitude of the modulated FM carrier at moment in time t is equal to an amplitude constant A multiplied by the sine of the sum of ω_{c}_{ᵢ} (this carrier's frequency) at the time t (as with AM above) plus the product of a scaling constant S times the integral up to the time t of the baseband signal m, this integral producing a phase shift that (when applied continuously) implies exactly the frequency deviation noted in the preceding paragraph.

If the modulation type is ordinary PM (phase modulation) (313), then the phase of the modulated signal is varied in proportion to the amplitude of the baseband signal (314), with carrier sampling considerations being similar to the previous modulation types noted.

Mathematically, ordinary PM is described by this formula:
PMᵢ(t)=A·sin(ω_{c}_{ᵢ}·t+S·m(t))

The amplitude of the modulated PM carrier at time t is equal to an amplitude constant A multiplied by the sine of the sum of ω_{c}_{ᵢ} (this carrier's frequency) at the time t plus the product of a scaling constant S and the baseband signal m at time t. (This is very similar to FM modulation, except that the integral is removed in PM.)

There are, of course, other modulation techniques that could easily be “plugged-in” to this flowchart (see DSSS below, e.g.), but these three (and variations on them) are best known and most used (pure digital and spread-spectrum aside, as described below—but even these can aptly be considered typically variations on ordinary phase modulation).

Once all input streams have been processed (318), the resulting carrier waves are composited (319) at the desired sampling rate into a composite supercarrier (CSC).

If all of the component carriers Cᵢ are sampled at the same rate as CSC, the composite supercarrier wave can be simply summarized this formula: CSC(t)=C₁(t)+C₂(t)+C₃(t)+ . . . +Cₙ(t). If the sampling rates vary, interpolation and/or resampling will be required. Adopting the simplest compositing formula, if the composite supercarrier has a sample at time t while one or more component carriers do not, each component carrier lacking a sample at t would be interpolated as though drawing a straight line connecting the component carrier samples nearest to t and then determining the y-coordinate of that line at x-coordinate t. If tₐ is the time of the relevant component carrier sample nearest but before t and tb is the time of the sample nearest but after t, then the formula calculating the interpolation (and the resulting “virtual” C (t) to be summed as in the preceding paragraph) is:

$$vC ( t ) = \frac{C ( {t}_{b} ) - C ( {t}_{a} )}{{t}_{b} - {t}_{a}} \cdot ( t - {t}_{a} ) + C ( {t}_{a} )$$

Spelling this out algorithmically, for each CSC (composite supercarrier) sample time t (321), the DSP loops (322) through each component carrier wave C. If C has a sample at t (323), C (t) is summed with the current CSC (t) (324), the result being stored in that same CSC (t); otherwise, a virtual sample is interpolated (325) as per the formula above, and it then is summed with CSC (t) (326). After arithmetically adding the real or virtual sample as appropriate, the DSP loops to the next component carrier wave (327), if any.

Optionally, after all component carriers are summed for CSC (t), CSC (t) is then divided by the quantity of component carriers summed-this attenuates the amplitude of the signal (which may be preferable for digital processing or storage-to permit CSC (t) to have the same sample datum size as the component carrier samples, e.g., or to normalize the amplitude) while still maintaining the basic information of the signal. (With most forms of modulation, one could divide or multiply the composite carrier by any reasonable constant and still maintain full signal integrity, to adjust signal strength for proximity or distance, e.g.)

CSC (t) being fully calculated, the DSP loops to the next time t, if any (321).

All times t being computed and the composition therefore completed, the result of that composition is then buffered for synchronous output (330, 105) to the DAC (106) and the DSP proceeds to process the next set of buffered or synchronous input streams (321). The DAC (106) outputs an analog composite RF carrier wave (107), which is then passed to an RF wideband amplifier and transmitter (108).

Distinct from but tightly connected to the core compositing process above, a user or a control program can vary any of the settings used to modify the baseband or carrier-modulated signals as described in FIG. 4. Theses settings may be dynamically and spontaneously changed whenever and to whatever extent desired-a substantial advantage of a digital approach. (Note that this figure doesn't necessarily exhaust the options involved.) These settings will sometimes be changed by via a user interface, and at other times (at the discretion of the program designers) by other parts of the software (e.g., sampling settings might be automatically determined by available processing power or implied by user-specified quality requirements-again, substantial advantages to a digital approach).

When a user- or program-request to change settings is received (401), the program confirms settings for a wide variety of parameters. The quantity of input channels (402) can vary, depending on what should be broadcast. Then for each input channel, numerous other settings apply as follows.

First, what is the type of input received by the channel (403)? If audio (404), the signal might be monophonic (406), stereophonic (407), “5.1” home theater sound (408), or any of many other possible audio categories (409). If video (405), the signal could be in the American broadcast standard NTSC (410), the European standard PAL (411), or any of numerous other formats (412), such as a purely digital format.

Next, a destination for the output must be selected (413). This will typically be a selection from the installed set of audio and video output devices available, such as radio receivers and television sets. Related to this is band and frequency_selection (414), most obviously applicable with respect to audio radio broadcasts, choosing between AM (415) or FM (416) frequencies. But there are also more exotic choices available in principle, such as Phase Modulation (417), of which standard FM is (mathematically equivalent to) a specific variant. If this is being set by a user interface, the choice will be presented in a high-level, non-technical, general way (e.g., for a video signal, one might select “Channel 5”). As noted above, in many instances, this setting will simply be implied by the input sources and output destinations selected.

In some situations, setting a signal power level (418) will prove advantageous. This would allow, e.g., reduced signal strength to close-by or very sensitive receivers, or increased for the contrary conditions or when there is significant RF noise.

Intermediate output sampling settings (419) consist of the sampling rate (420) (e.g., the quantity of samples per second), type (421), and size (428). The type of digital sample can be specified as either absolute (422) (e.g., a number representing the amplitude of a wave), or delta (423) (e.g., a number representing the change in amplitude). Within each of absolute or delta types, there is a sub-type of linear (424, 426) (e.g., the amplitude of the sampled wave is directly proportional to the number representing the amplitude) or non-linear (425, 427) (e.g., the amplitude of the sampled wave is non-linearly mapped via a function or lookup table to desired absolute or delta values, this being done to allow less data to cover more ground at the expense of some degree of accuracy). The size of the sample (428) can vary widely, often being something of an inverse of the sampling rate (especially with delta samples). With very high-speed delta sampling, one might even use a 1-bit sample size (429); for higher quality or more complicated signals (e.g., video), one can increase the sample size to get more data per sample (430-435).

With the (either intermediate or final, depending on the embodiment) carrier frequency (436) a function of the user- or program-selected frequency (414), the carrier sampling rate (437) can be varied to meet the fidelity requirements of the carrier at that frequency. The carrier will be modulated (438; 439-441) in accord with the high-level band setting (414) except in IF embodiments, the setting here ideally permitting greater detail with respect to type of phase modulation (441), e.g.. (The details of various sorts of phase modulation are not, of course, an object of this invention.)

Before carrier modulation, the baseband input signal may be modified in all, any, or none of a variety of ways. Audio equalizations (442), such as the common bass (443) and treble (444) or finer, precise-frequency adjustments (445), may be applied. There may also be various effects available (446), such as reverb (447), echo (448), and frequency shifting (449).

If the signal is a video signal (450) (or, typically more accurately, a video-audio composite), similar equalizations (451) may be applied, such as color (452), brightness (453), and contrast (454) adjustments. Likewise, a variety of video effects may be applied to the baseband signal, such as pixelizing (456), posterizing (457), fade in/out (458), and myriad others (459).

It should be emphasized that there are myriad additions to (e.g., innumerable forms of filtering for various other signal-shaping or noise- or bandwidth-reduction purposes) and other combinations and permutations of the parameters discussed here, these potentially important details not being mentioned here since they are not objects of the invention.

Once any settings are changed, the input stream processing algorithm (301-311) immediately applies these changes in the course of preparing the baseband signals for carrier-modulation and in the modulation and compositing process itself.

With other, non-media signals (e.g., those intended for a plurality of embedded medical devices--any comprehensive list would continue indefinitely), or with more complicated embodiments as below, the flow will be noticeably different in detail (with very different user-selected parameters, or the DSP controlling rather than sampling the carrier modulation, e.g.), but the end results will be very similar.

### Multi-DSP, -DAC, and if/Frequency-Multiplier/Mixer Embodiments

Numerous variations may often enhance the compositor, especially when practical issues such as cost are considered.

One of the practical issues in implementing this compositor is the cost of the DSP. Depending on the quantity, complexity, and frequency of the waves being processed, putting all the necessary power in a single DSP may be a sub-optimal solution, splitting the processing up into bands or even individual signals sometimes being more cost effective.

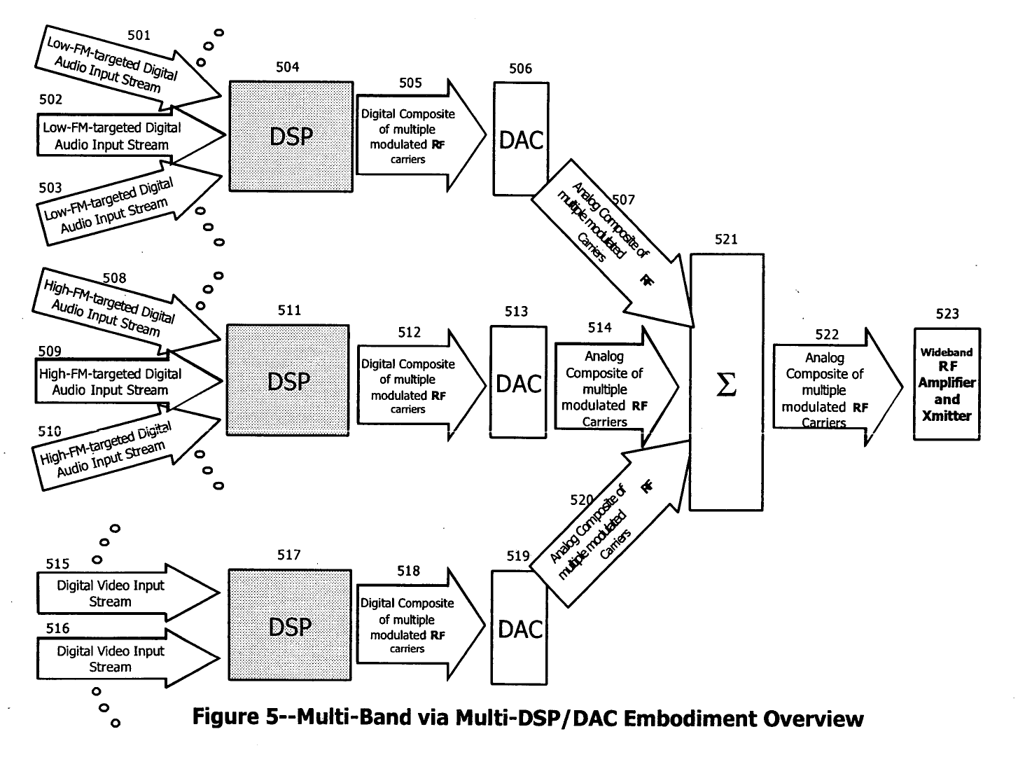

FIG. 5 depicts one embodiment of this solution, similar to FIG. 1 except breaking down the input and processing into different bands or band segments. (Keep in mind that there are myriad other possible variations along these lines, of course, with different combinations of DSPs and input signals.) In the first of three input and processing sections of the figure, the DSP (504) receives a plurality of baseband signals (501-503) targeted for the Low-FM band (i.e., frequencies close to the lower FM boundary of 88.1 MHz). These signals are digitally processed as in FIGS. 2-4, the digital composite RF wave (505) being sent to the associated DAC (506) for conversion to analog RF, which analog signal is in turn sent to the Summer (521) to be (in this example) further composited with the analog end-products of sections 2 and 3 of this figure.

The second and third sections are analogous to the first. In section 2, a plurality of High-FM-targeted baseband signals (508-510) go to the DSP (511) for processing as in FIGS. 2-4, the DSP delivering the digital RF composite (512) to the DAC (513) for conversion to analog (514), which signal is then (like the Low-FM-targeted signal (507) from section 1) sent to the summer (521). Section 3 accepts a plurality of video input signals (515-516), similarly processed by the DSP (517) in accord with FIGS. 2-4, the composite signal (518) being sent to the DAC (519) for conversion, the resulting analog RF signal (520) then being sent to the summer (521). (Only two input signals are shown instead of three to represent the significantly higher processing demands that a signal with video frequencies and complexity commonly requires, but the precise quantity is not at all material to this embodiment or to the compositor generally.)

The summer (521) composites the already more-narrowly composited signals (507, 514, 520), adding them in analog form to produce the final “supercarrier” (522) which is sent to the wideband RF amplifier and transmitter (523).

This type of embodiment, then, successfully spreads the high processing requirements amongst multiple DSPs, thereby permitting slower and cheaper DSPs to be used.

Depending on the frequencies involved and the state of the technology marketplace, one may wish instead simply to multiply the quantity of DACs, thereby using a number of cheaper DACs instead of one more expensive DAC-even while using a single DSP.

How exactly does this reduce the load on the DAC, since at least one DAC will need to be running at twice the highest targeted output frequency? In two major ways: first, it permits greater optimization of the sampling rates for different frequencies, rather than forcing one DAC conversion sampling rate to encompass all frequencies (which in some cases would require either a higher sampling rate or a lower quality output signal); second, it then permits one to use a mix of DACs according to one's performance needs, lower frequencies using less expensive DACs.

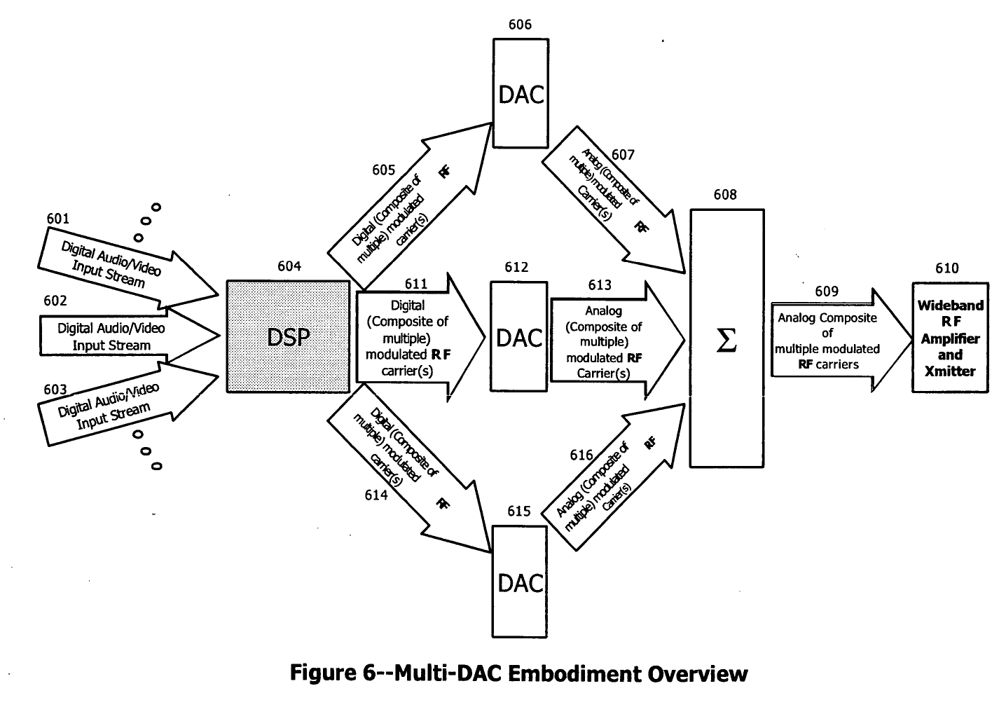

FIG. 6 depicts this as something of a synthesis of FIGS. 1 and 5. The DSP (604) receives a plurality of baseband digital signals (601-603; in fact, in this embodiment with three DACs, there would typically be well over three inputs), as per FIG. 2. It then categorizes the incoming signals (according to mutual proximity in the target frequency, e.g., there being commonly one category per DAC), and processes each category in accord with FIGS. 3 and 4. The plurality of RF digital composites (605, 611, 614) are fed each to its own DAC (606, 612, 615), and the resulting RF analog composite signals (607, 613, 616) are summed (608) and jointly sent to the wideband RF amplifier and transmitter.

A third important variation in embodiments (that dramatically improves the impact of the second as well) is the use of Intermediate Frequencies (IF) instead of Radio Frequencies (RF) in the DSP's processing. Why might this matter?

It's largely a matter of sampling: in order to accurately sample any wave, one must have at least twice as many samples as there are cycles in the wave segment being sampled, and ideally significantly more. Basically, the closer the sampled wave comes to cycling at half the sample rate or beyond, the more aliasing-induced distortion becomes an issue. The obvious solution to this problem, then, is to oversample, i.e., sample at substantially more than twice the frequency of the wave-10× oversampling, e.g. But the obvious problem with this obvious solution is that each sample requires DSP handling, meaning that if one multiplies one's sampling rate ten-fold, one multiplies the portion of the processor's time dedicated to wave generation and manipulation roughly ten-fold as well.

There's another, more clever solution available: if one doesn't want to increase the sampling rate, one can instead decrease the frequency of the wave being sampled. This works quite well with the compositor's digital processing of either digital or analog radio signals; indeed, it's critically important to recognize that IF variations may beneficially modify numerous other variations and their embodiments, very commonly substituting for pure-RF processing.

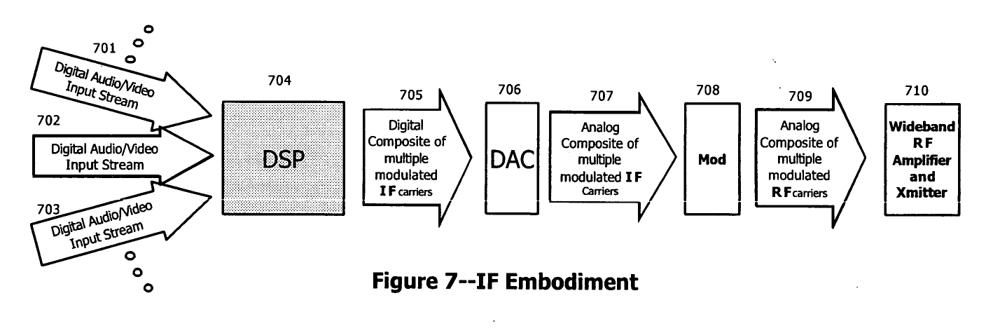

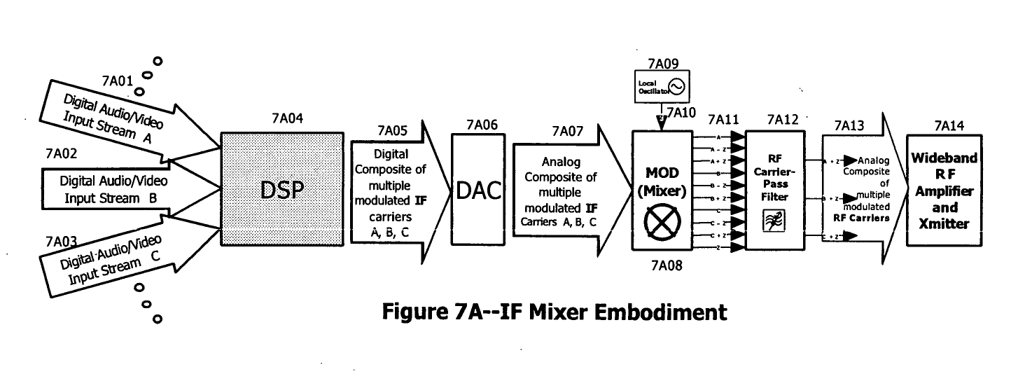

FIG. 7, a variation on FIG. 1, shows how: the digital processing itself is done on an intermediate frequency (IF) wave rather than a radio frequency (RF) wave, the IF composite wave then being frequency-multiplied outside the DSP up to radio frequency for final output. Digital inputs (701-703) are received by the DSP (704) and processed as in FIGS. 2-4, with the single, critical exception that the RF carrier (305, and implicitly throughout) is replaced by an IF carrier in the process design. This substantially reduces the digital processing power required for successful generation and modulation of the carrier wave, reducing it roughly to IF/RF (arithmetically) of what it was. The digital IF composite (705) is then passed to the DAC (706) for conversion to analog, and then another change from FIG. 1: the analog IF composite (707) is passed to a frequency multiplying modulator (708; mixers and digital upconverters, alternatives to multipliers, will be covered shortly), the resulting analog RF composite (709) then being amplified and broadcast (710).

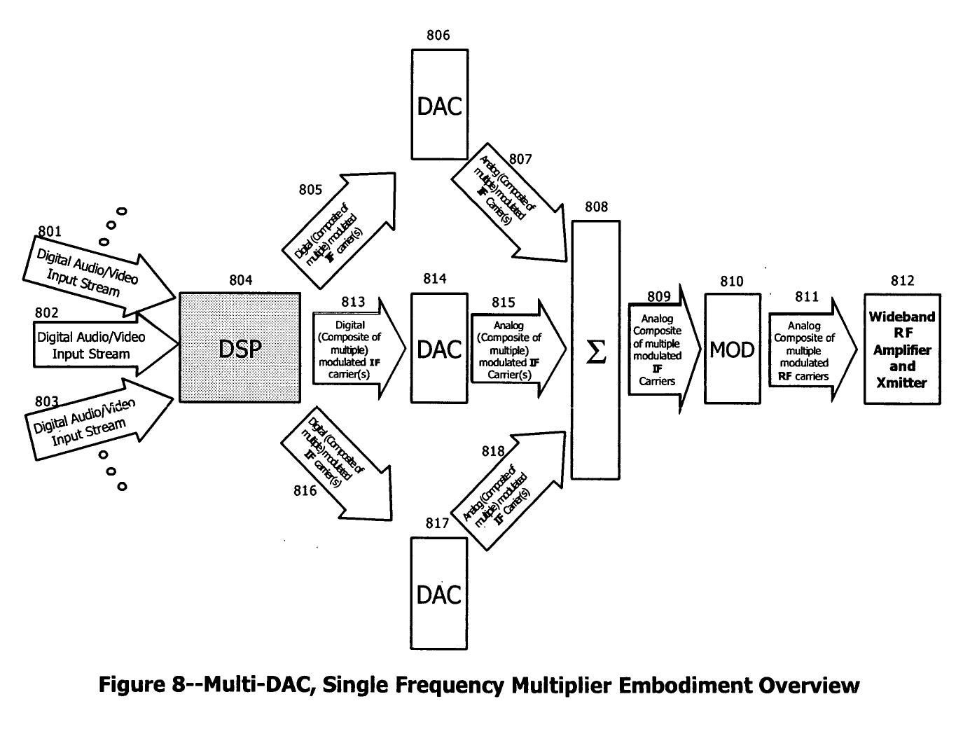

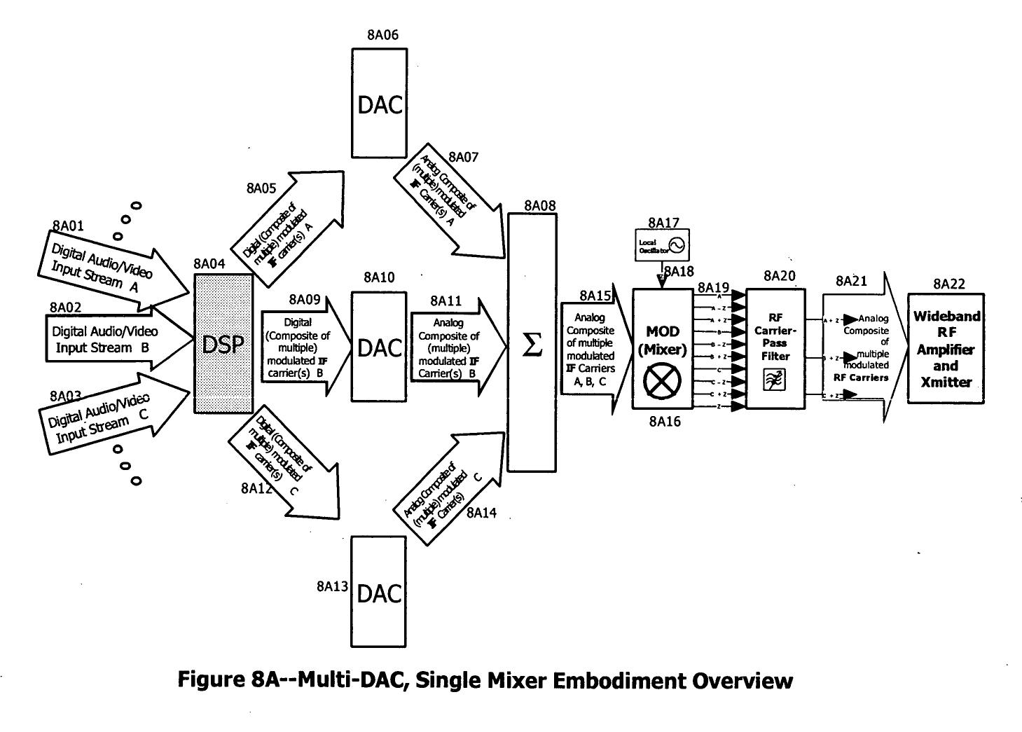

For example, combining this variation with the second variation (multiple DACs) is quite useful, as FIG. 8 depicts, combining features of FIGS. 6 and 7. As per FIG. 2, a plurality of digital input streams (801-803; these represent an arbitrary number of inputs, typically well over three, as per FIG. 6) is received by the DSP (804), which then categorizes the incoming signals (according to mutual proximity in the target frequency, e.g., there being routinely one category per DAC-again as per FIG. 6), and processes each category in accord with FIGS. 3 and 4, except that, as in FIG. 7, the DSP processing is done at an intermediate rather than radio frequency (modifying 305 explicitly, implicitly throughout FIG. 3). The IF digital composites (805, 813, 816) are fed each to its own DAC (806, 814, 817), and the resulting IF analog composite signals (807, 815, 818) are in turn summed (808), the sum (809) then passed to the frequency multiplying modulator (810). After frequency-multiplication to the appropriate target radio frequency, the resulting RF composite of the input composites (811) is then amplified and transmitted (812).

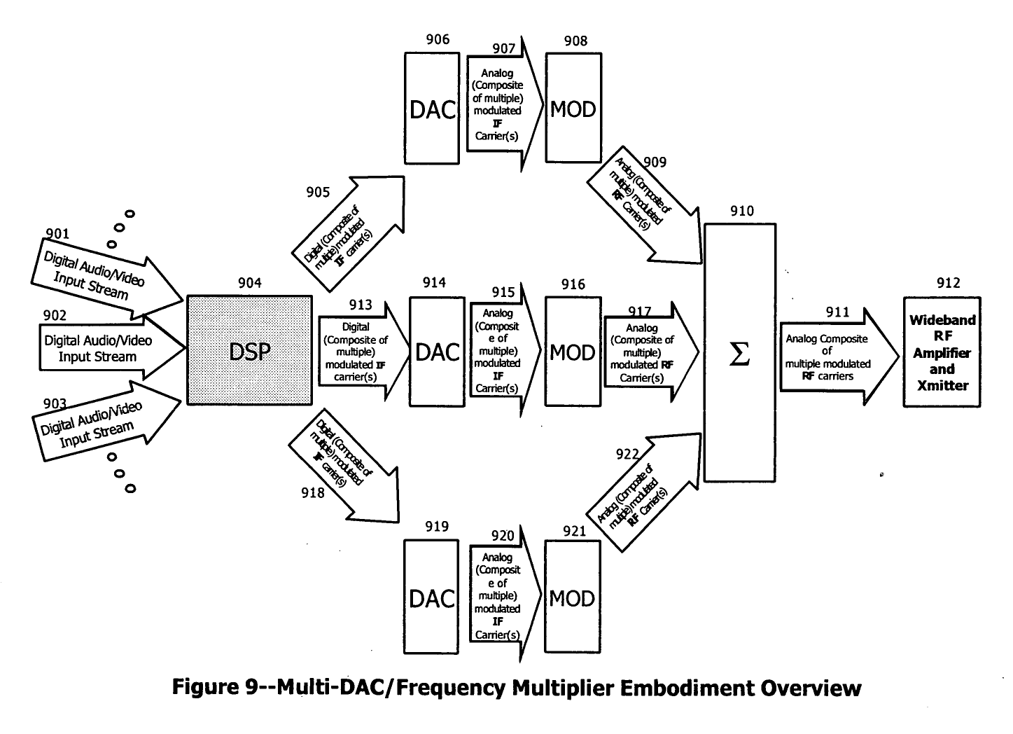

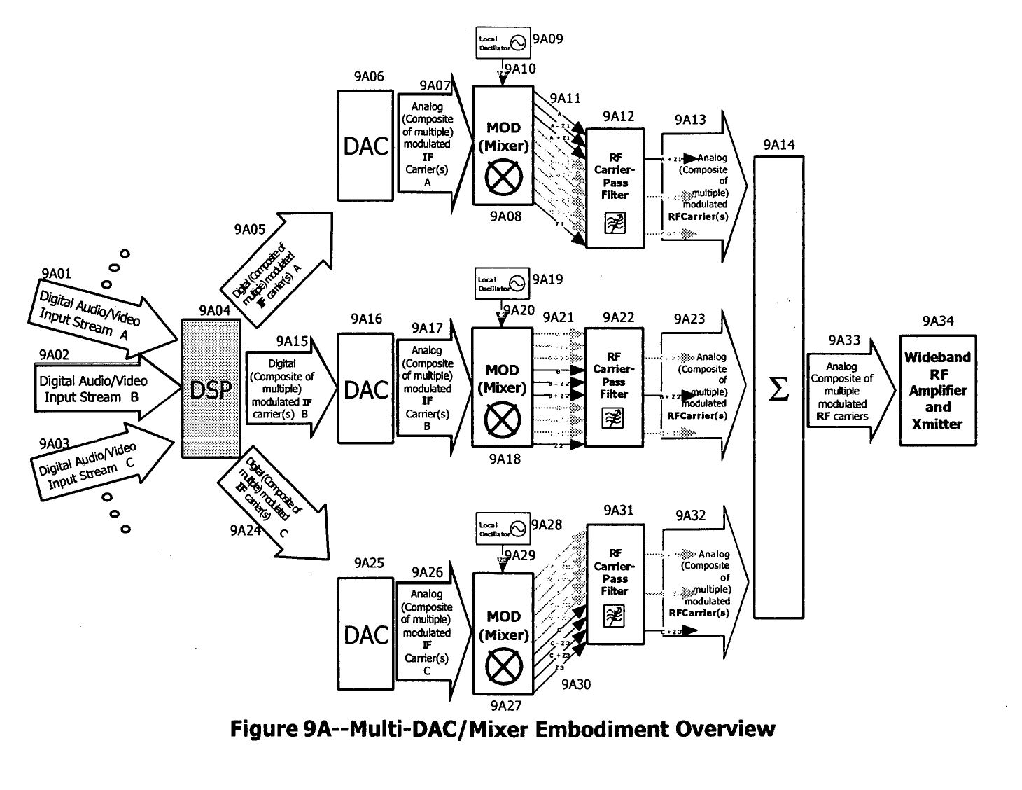

FIG. 9 is an enhanced use of frequency multipliers, using one per DAC instead of sharing one between DACs. Digital input streams (901-903) are accepted and processed by the DSP (904) as per FIGS. 2-4 except with the IF modification (305, passim) noted in FIG. 7 and the categorization pre-processing used in FIG. 8. The resulting digital IF composites (905, 913, 918) each goes to its respective DAC (906, 914, 919), each resulting analog IF composite (907, 915, 920) then being passed to its own frequency multiplier (908, 916, 921). Only now, with the RF analog composites (909, 917, 922), are the signals finally summed (910), the resulting analog RF composite (911)-perhaps better called a meta-composite or super-composite-being amplified and then transmitted (912).

The benefit in FIG. 9 is greater even than it first appears. Not only does this approach reduce the sampling rate necessary for each DAC (as is true in FIG. 8 as well), but because each DAC's output is frequency-multiplied independently from other DACs, each DAC's sampling rate can be reduced to the bare minimum required for its own composite signal, irrespective of its signal's ultimate position in the wideband transmission. That is, since the DACs are not sharing a frequency multiplier, they do not need to process their own signals at any dramatically faster (or slower) rate simply to ensure that their higher (or lower) target frequency is achieved. Simplifying it mathematically: if hypothetical target frequency A is 1 while B is 100, with multiple frequency-multipliers one needn't have B's intermediate frequency be 100 times that of A's, since instead B's frequency multiplier could be 100 times A's. On the other hand, if B's multiplier were only 1.1 times A's, it might prove optimal cost-wise to share a frequency multiplier and then shift A's and/or B's IF to compensate, so that A's and B's IFs would have the same ratio as their RFs, a single, shared frequency multiplier then yielding the proper RF results-which is precisely what FIG. 8 depicts.

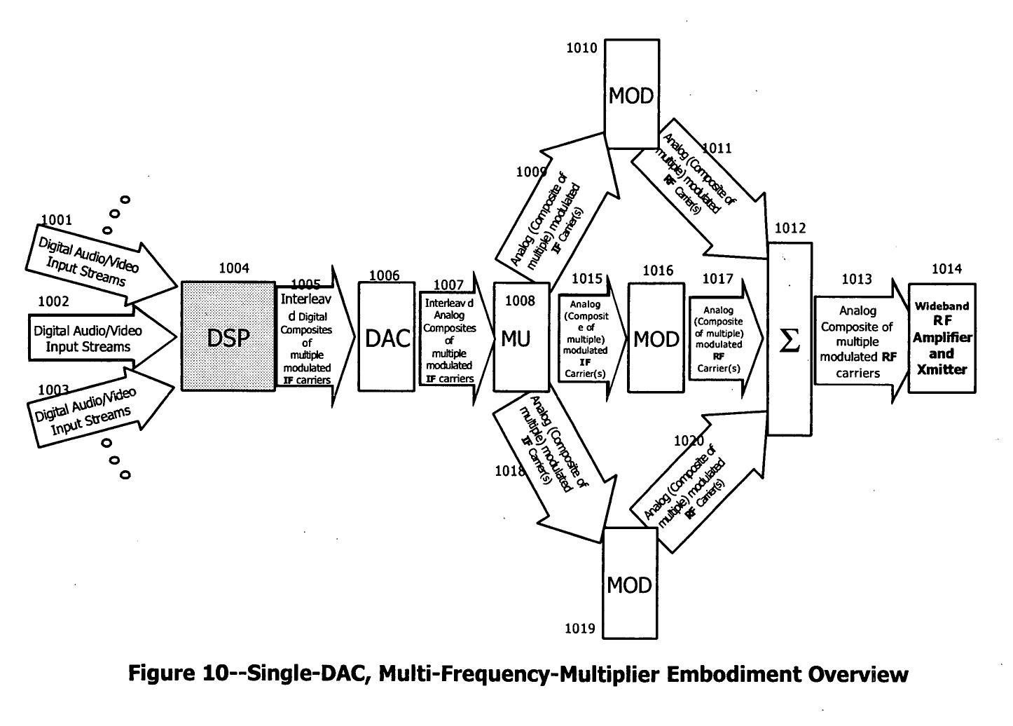

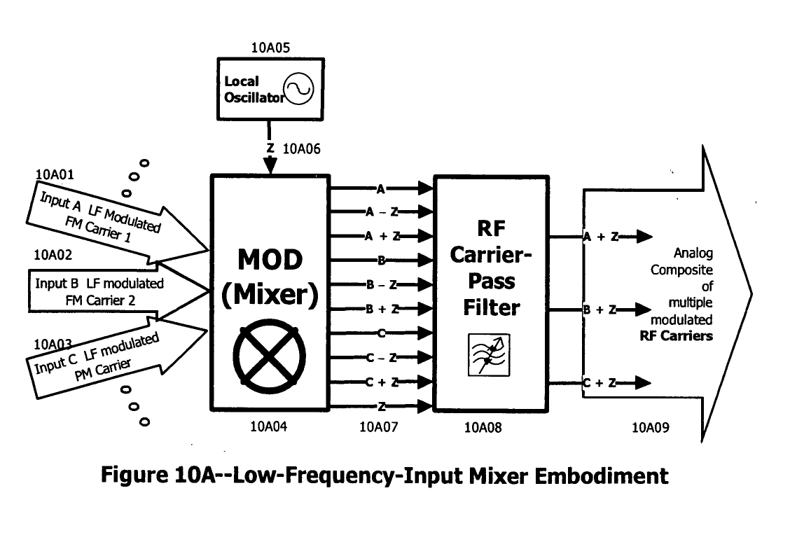

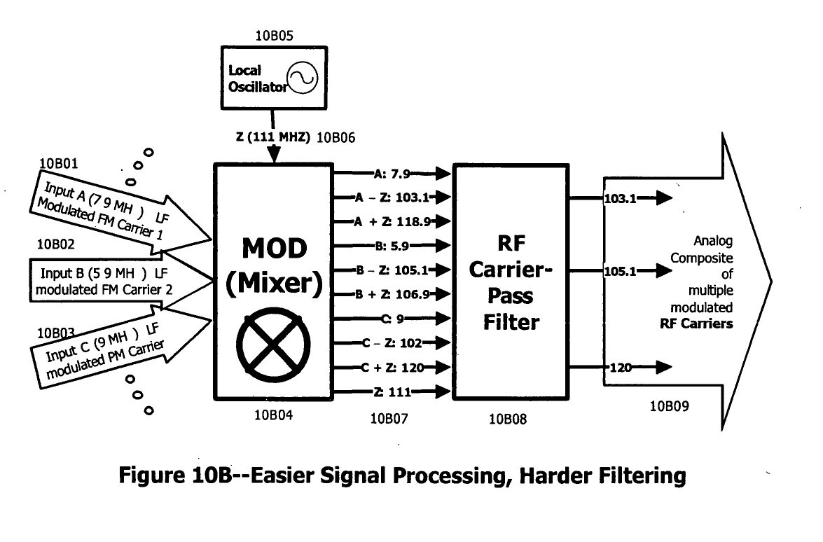

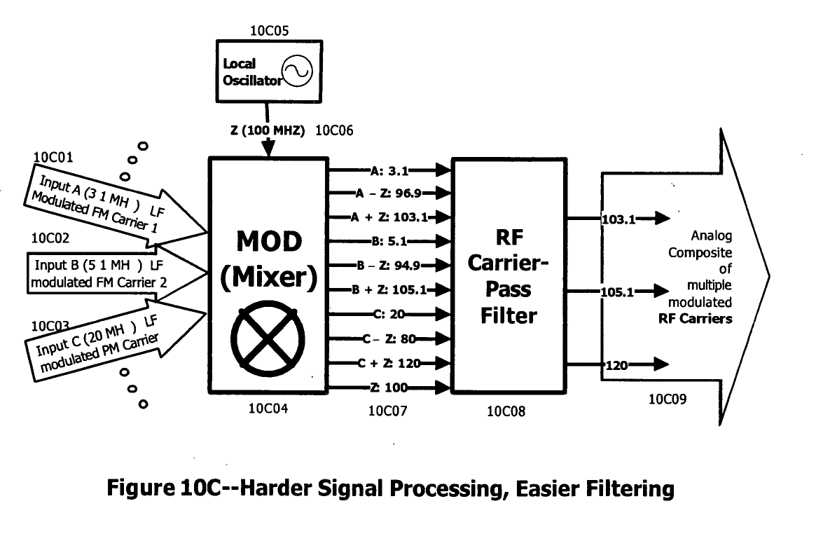

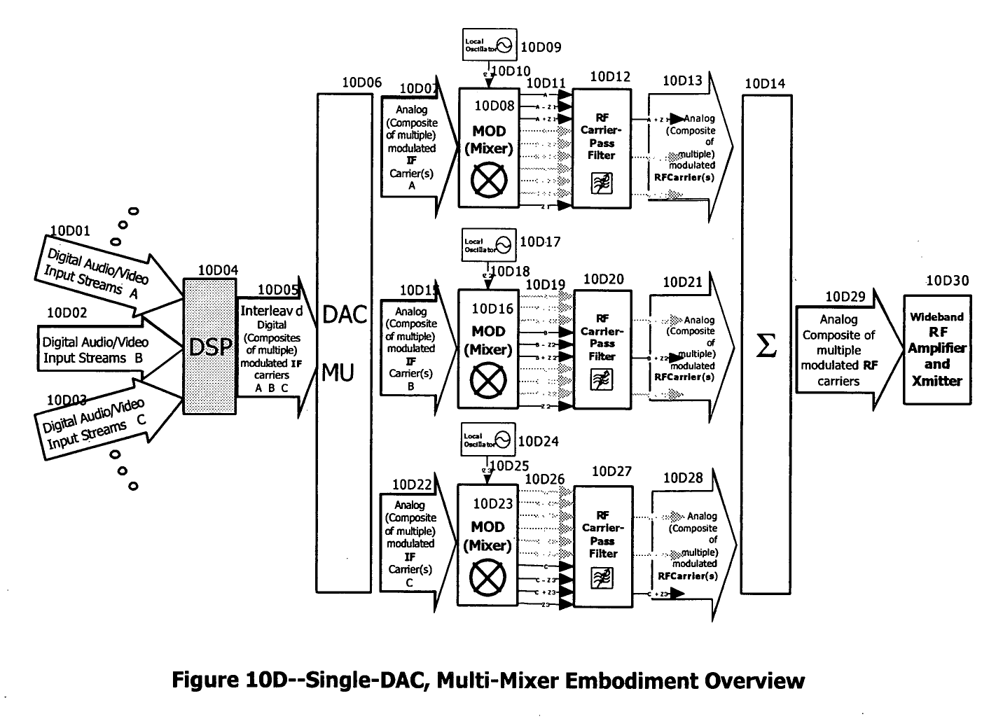

FIG. 10 shows a functionally equivalent variation on FIG. 9 in which a single (higher performance) DAC is used with a multiplexer to effectively simulate multiple DACs. (The multiplexer here is shown as a separate component, but multi-channel DACs typically have one built-in.) Up to and including the DSP (1004, 904), and including and beyond the frequency multipliers (1010, 908; 1016, 916; 1019, 921) FIGS. 9 and 10 are substantially identical. But the DSP (1004) in FIG. 10, rather than distributing the plurality of composite IF signals to their respective DACs instead interleaves them (1005) and then sends this interleaved plurality to the sole DAC (1006), which in turn therefore generates interleaved analog composites (1007), which the multiplexer (1008) then breaks down (109, 1015, 1018) and distributes to the relevant frequency multiplying modulators (1010, 1016, 1019). (It's assumed and necessary that the multiplexer (1008) has sample-and-hold capability, which maintains the analog voltage level until the DAC updates it, rather than having it drop to zero as soon as the DAC (1006) and multiplexer (1008) move on to the next interleaved sample from another composite.)

Note that it will sometimes prove useful to hybridize FIGS. 8 and 9/10, doing some of the frequency multiplication individually-enough to make the resulting second-order IF composites have the proper frequency ratios relative to other second-order IF composites-and the balance of it shared after summing. This would reduce the demands on the summer component since it would operate only at low, second-order IF speeds.

Another extremely powerful IF variant of the compositor comes with its implementation using classic mixer technology instead of frequency multipliers proper.

Before proceeding, it's worth noting that when upconverting either a baseband or IF signal, it's often desirable not to end up with the full array of mixer-generated frequencies. This desideratum is commonly achieved via mixers configured as single-sideband (SSB) modulators. Such modulators are constructed in various ways: dynamically or statically filtering out unwanted frequencies, phase shifting complementary signals (using, e.g., a Hilbert transform and a discussed-below l/Q modulator) with resulting unwanted-sideband cancellation, and so forth. We'll focus on the conceptually simplest approach, explicit filtering, but this focus is illustrative and not definitive—in many instances, the compositor could profitably use other SSB or (as with ordinary AM audio and analog television broadcast) myriad non-SSB mixer/modulator configurations.

An ideal radio frequency mixer multiplies the instantaneous amplitudes of two signals together (versus an audio mixer, which adds the same according to some proportion); this has a result that follows mathematically

$$sin ( u ) \cdot sin ( v ) = \frac{1}{2} [ cos ( u - v ) - cos ( u + v ) ]$$

but is surprising to the uninitiated: if sine waves of frequencies a and b, respectively, are inputs into the multiplier, the output consists of sinusoidal (though nominally cosine) waves precisely of frequencies a+b and a−b. (While it might appear that this form of multiplication is not commutative, this is incorrect since cos(u−v) equals cos(v−u), the cosine function not varying with the sign of its argument.) An ideal mixer (in this respect like an ideal frequency multiplier) also preserves the aspects of the waves important to most forms of modulation, making mixing an ideal way to shift carrier frequencies to any desired level: simply mix the baseband (for suppressed-carrier AM), baseband-plus-1 (for normal AM, given a baseband signal ranging from −1 to 1), or IF (for FM, PM, or another route to AM) signal of frequency a with a (local oscillator) sine wave of near-carrier frequency b to produce the desired signal at the desired frequency, the result is a carrier at either a+b or a−b, the complementary carrier (typically along with other extraneous signals resulting from imperfect mixing) being removed by a filter. (Filtering is sufficiently important to sometimes be a factor in choices of a and b-the resulting frequencies of a+b and a−b [and, practically, a and b as well, as described below] should be at least far enough apart to facilitate filtering.)

Moreover, mixers have an often-unused capability of particular import to the compositor: they accept composite inputs and (ideally) treat them as though they were separate multiplicands to separate mixers which happen to have the same multiplier. This means, e.g., that an entire IF composite can, with a suitable mixer, a suitable local oscillator, and suitable filtering, straightforwardly be frequency shifted to any desired location in the RF band.

FIG. 10A depicts one instance of these capabilities in a schematic form that makes apparent how a mixer with its affiliated local oscillator and filter could be readily substituted for any frequency multiplier in any of the previous or succeeding figures.

While in principle there's no limit on how many signals can be mixed, practically it can get messy, so FIG. 10A shows just three signals, all low-frequency (which frequency is often either cheaper, or higher quality, or both-though in the compositor it's functionally similar to an IF signal, and indeed is perhaps best thought of as nothing more than an IF signal at a lower-than-usual frequency): a pair of FM signals (10A01, 10A02), and one PM signal (10A03). This configuration was chosen to display concisely both the power and the complexity of composite mixing, both explained forthwith.

While composite mixing is an exceptionally simple and powerful tool, allowing one to composite an arbitrary number of inexpensive, high-quality LF or IF signals, one must be aware of certain implicit limits when harnessing mixers for the compositor. In particular, taking for granted the local oscillator input, since a mixer both produces two output frequencies for every one put in and usually has some input signal leakage directly into the output as well, a designer needs to make sure that the outgoing signals are not so close that they either (a) interfere with each other or (b) are too difficult to filter properly-a special challenge in a dynamically changing frequency environment. Further elements of FIG. 10A explicate this.

The three LF input signals (A through C [10A01 through 10A03]) are sent to the mixer (10A04), as is the output Z (10A06) from the local oscillator (10A05). (The local oscillator here and throughout may be controlled by the DSP or other CPU if said oscillator is, e.g., a DS/NCO or (via DAC) a VCO; or it may be otherwise tunable or set to a fixed frequency.) The mixer output (10A07) is as desired and then some, consisting of all of the following: the original signals A, B, C, and the local oscillator frequency Z (all through leakage); the three frequency-sums of the composite input and the local oscillator A+Z, B+Z, and C+Z,; and the three frequency-differences A−Z, B−Z, and C−Z. To prevent needless power consumption and needless interference with other devices, the signal would be filtered (10A08) resulting finally in the desired RF composite (10A09).

Only by plugging in frequency numbers can we see the potential difficulties and tradeoffs. Suppose the goal is to broadcast signals at 103.1 (FM), 105.1 (FM), and 120 MHz (PM). To keep the modulated signals at as low a frequency as possible (so far as digital processing goes, thereby increasing digital quality and/or reducing digital costs), we might be tempted to use a local oscillator frequency of, say, 111 MHz (local oscillator MHz, producing a simple sine wave, are cheap and easy, so we needn't worry about their minimization), and then use LF or IF input frequencies of 7.9 (A), 5.9 (B), and 9 (C) MHz. But note then what exactly is output, and what filtering is needed to get the desired final product, as depicted forthwith in FIG. 10B.

Low-frequency modulated carriers A (7.9 MHz; 10B01), B (5.9 MHz; 10B02), and C (9 MHz; 10B03) are sent to the mixer (10B04) where they are mixed with the signal from the local oscillator (10B05), Z (111 MHz; 10B06) from the local oscillator (10B05). This produces the preliminary composite output stream (10B07) which includes both the wanted (103.1,105.1, and 120 MHz signals) and unwanted (all the rest) mixer results.

Since in this instance the unwanted signals are interspersed with the wanted, the “carrier-pass” filter (10B08) must be fairly sophisticated, not only filtering out the low A, B, and C frequencies, but also letting through only particular signals within a relatively narrow spectrum range, filtering out only and all the rest in that same range, likely using an array of filters or a comb filter.

Ideally this filter (or filter array) is dynamically variable (although the technologies of filtering are not an object of the invention), the precise frequencies being passed varying with DSP instructions, but the compositor does not require this, particularly because one might adjust the frequencies input to, and hence output by, the mixer to match static filter capabilities, rather than adjusting the filter, though this may require greater processing power. One particularly simple example of this is described forthwith regarding FIG. 10C.

If the DSP horsepower is readily available, one may well wish to use different frequencies to simplify filtering, even at the expense of somewhat higher LF/IF frequencies. This is depicted in FIG. 10C.

To achieve the very same end in FIG. 10C as were obtained in FIG. 10B, e.g., one may instead use a different means, picking frequencies for A (10C01) of 3.1 MHz, B (10C02) of 5.1 MHz, C (10C03) of 20 MHz, and, from the local oscillator (10C05), for Z (10C06) of 100 MHz. This produces the preliminary composite output stream (10C07) which includes both the wanted (103.1, 105.1, and 120 MHz signals) and unwanted (all the rest) mixer results, as in FIG. 10B but with one significant difference: all of the unwanted signals, the highest being the leakage from the input Z (10C06) at 100 MHz, are well below all of the wanted signals, the lowest being A+Z at 103.1 MHz. This approach results in an extremely simple filtering task: just cut off everything at and below any arbitrarily selected frequency between 100 and 103 MHz, with the frequencies above that cutoff all being part of the desired RF composite.

Either way (i.e., using either of the approaches exemplified by FIGS. 10B and 10C with their respective tradeoffs), the compositor works well with a suitable mixer

It's worth spelling this out more concretely.

FIG. 7A (a variation on FIG. 7) shows a basic IF Mixer embodiment of the compositor. Three input streams (7A01-7A03), precursors of carriers A, B, and C (here as in FIGS. 10A, 10B, and 10C, as well as 7A-10D), are accepted by the DSP (7A04). (Remember that, as always, three is only a suggestive quantity—it could be whatever quantity one wishes and has the hardware to handle.) The DSP processes them (mutatis mutandis as in FIGS. 3 and 4) to produce a composite (7A05) of the modulated IF carriers, which composite goes to a DAC (7A06) for conversion to analog. This analog IF composite (7A07) is then sent to the mixer (7A08) for up-conversion to the desired RF frequencies. The upconversion result will be determined not only by the IF input, but also by input (7A10) from the local oscillator (7A09), which together yield the messy composite of all mixed frequencies (7A11). The RF “carrier-pass” filter (7A12) receives this mix and filters out all but the desired frequencies (and this and subsequent examples, the desired results being at frequencies equal to the IF input frequencies plus the local oscillator frequency, said frequencies being output (7A13) to the wideband RF amplifier and transmitter (7A14).

FIG. 8A (a variation on FIG. 8) depicts the multi-DAC version of this embodiment. Digital AN input streams (8A01-8A03) go to the DSP (8A04) which modulates the same quantity (in this example, three) of IF carriers (8A05, 8A09, 8A12). (As the text of 8A05, 8A09, and 8A12 makes clear, in principle the DSP could be sending multiple signals to each DAC-a true composite-but in this and subsequent [FIGS. 9A, 10D] examples doesn't.) The DACs (8A06, 8A10, 8A13) convert their input to analog (8A07, 8A11, 8A14), which analog signals are summed (8A08) resulting in a composite (8A15). This IF composite is sent to a mixer (8A16). A local oscillator (8A17) sends the signal (8A18) to be mixed with the IF composite. The mixed output (8A19) reaches a filter (8A20), only the desired frequencies (8A21) passing through, as per the filter design (or, with a dynamically variable filter, as per the filter design and control). This filtered composite output is then amplified and transmitted (8A22).

FIG. 9A (a multi-DAC and multi-mixer embodiment—a variation on FIG. 9) likewise has three digital AN input streams (9A01-9A03), received by a DSP (9A04). As in FIG. 8A, the DSP processes the inputs into three modulated IF carriers (9A05, 9A15, 9A24) which are sent to DACs (9A06, 9A16, 9A25), the resulting analog IF carriers (9A07, 9A17, 9A26) being mixed (9A08, 9A18, 9A27) with a properly configured local oscillator's (9A09, 9A19, 9A28; depending on the design, the local oscillator(s) might be shared) output (9A10, 9A20, 9A29), the results (9A11, 9A22, 9A31) being passed to “carrier-pass” filters (9A12, 9A22, 9A31), only the desired signals (9A13, 9A23, 9A32) passing through the filters. These desired signals are then summed (9A14) resulting in an analog composite of RF carriers (9A33) which are then broadcast (9A34).

The gray arrows in the mixer and filter output here and in FIG. 10D represent the hypothetical results of mixing optional composite inputs (with more than three embodiment inputs), as per the parenthetical comments on items in the figure and in which case each mixer might have, as shown in gray, its own, localized A, B, and C to deal with, as in FIGS. 10A-10C and FIGS. 7A-8A. (Even given this depiction of options available, one must remember that the quantity and frequencies of carriers and filtering choices can vary substantially from what is depicted here.) Only the black arrows represent signals present in the basic embodiment of FIG. 9A as described immediately above, and FIG. 10D as described immediately below.

FIG. 10D represents a variation on FIG. 9A (analogous to the variations in FIG. 10 compared with FIG. 9) with multiple DACs being replaced by a single, higher-performance DAC combined with a multiplexer. Three (as always, representing any arbitrary number) AN digital input streams (10D01-10D-03) go to a DSP (10D04) which, as usual, uses each to modulate a digitally generated IF carrier, these carriers then being not composited (unless, again as usual and per the on-figure parenthetical comments, there are multiple carriers per mixer) but interleaved (10D05) and passed to a combination DAC and multiplexer (10D06). The DAC/MUX combo (presuming a sample-and-hold capability commonly available with such units) outputs several different IF carriers (10D07, 10D15, 10D22) to mixers (10D08, 10D16, 10D23). Each mixer also receives (and possibly shares, in some designs) from an associated local oscillator (10D09, 10D17, 10D24) an input (10D10, 10D18, 10D25) to mix with the incoming carrier. The results of the mixing (10D11, 10D19, 10D26) go to a filter (10D12, 10D20, 10D27), only the preferred signals (10D13, 10D21, 10D28) then being summed (10D14), the resulting analog RF carrier composite (10D29) then being amplified and transmitted (10D30).

### External Modulators

Of course, if the goal is to reduce DSP requirements and if other considerations (quality, flexibility, performance, and cost, e.g.) permit or even demand, one may wish to offload some or all IF, RF, or even mere baseband frequency processing to external modulators, either digital or analog--all the while retaining programmable, digital control. (“External” in this context means “outside the controlling/primary DSP”, typically implying specialized rather than generalized hardware.)

### DS/NCO Embodiments

One way of externalizing a great deal of supra-baseband frequency signal processing is to use a digital synthesizer (DS) or numerically-controlled oscillator (NCO), broadly construed. As desired, these have the potential to dramatically reduce DSP processing requirements, since the DSP would no longer have to process samples at either intermediate or radio frequencies, but instead typically at baseband signal frequencies (given one DS/NCO per baseband input)-a substantially easier task, particularly for lower-cost DSPs.

With most digital synthesizers or numerically controlled oscillators, all that will be numerically controllable is the frequency; a much better term to describe them would be “numerically tuned oscillators.” But this is our patent, so we get to define the term the way it should have been defined, as broadly as the name rather than the most common usage suggests. By “numerically controlled oscillator” or “digital synthesizer”, here is meant an oscillator or synthesizer in which any desired combination of frequency, amplitude, and/or phase is digitally, instantaneously controllable. (This would include, therefore, numerical amplitude, frequency, and phase modulators.)

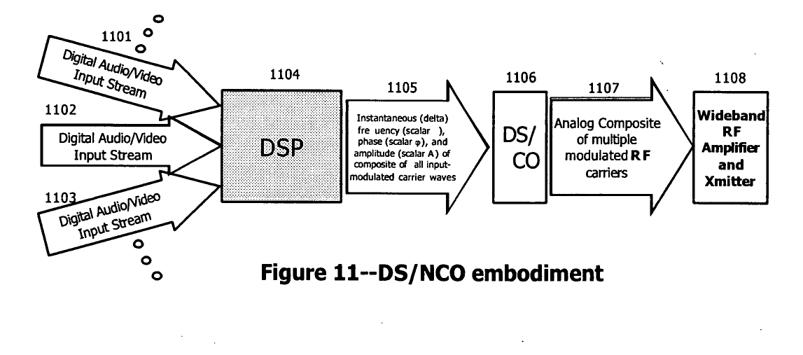

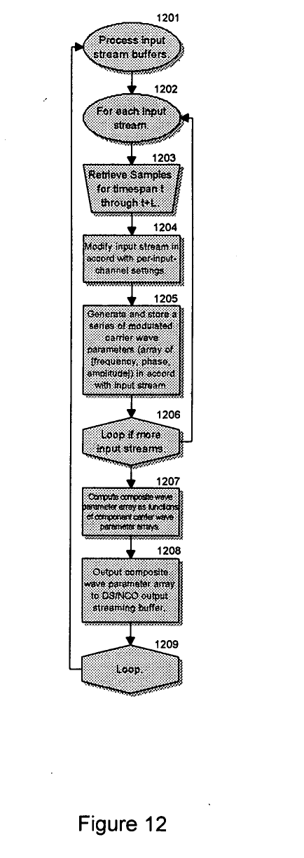

FIG. 11 shows one crude but effective way the compositor can harness this capability using just one DS or NCO. Digital input streams (1101-1103) are accepted by the DSP (1104) in accord with FIG. 2, and processed in accord with FIG. 4, but FIG. 3 is no longer as straightforwardly applicable, therefore being replaced by FIG. 12.

FIG. 12 begins (1201) as FIG. 3 does (301-304): for each input stream (1202), the new input samples are retrieved (1203) for a span of time t through t+L, said samples then being modified as per the settings determined in FIG. 4.

But then FIG. 12 diverges significantly from FIG. 3: rather than generating a digital sample of the carrier waveform itself (as in 305 and its successors), the DSP (1104) computes the key characteristics of the carrier waveform (1205): its instantaneous frequency, phase, and amplitude as they vary throughout the buffered sample. This array of key characteristics is stored in memory, the DSP then proceeding to the next input stream (1206).

After all input streams have been so processed, the DSP calculates the characteristics of the composite super-carrier (1207), which parameters are of course a function of the parameters of the component carrier waves. The resulting array of parameters (1105) is then sent to a buffer (1208) to be streamed synchronously (in a separate thread of DSP execution, or via DMA) to the DS/NCO (1106), which in turns generates the analog RF carrier (1107) determined by the streamed parameters, which carrier is then amplified and broadcast (1108). Note that step 1207 may have to be performed at rates substantially higher than the baseband frequencies involved, depending on the degree of fidelity required for the composite; note also that of course this can be done at IF rather than RF (the output being at some stage frequency-multiplied to RF) to reduce DSP demands or increase analog composite carrier output fidelity.

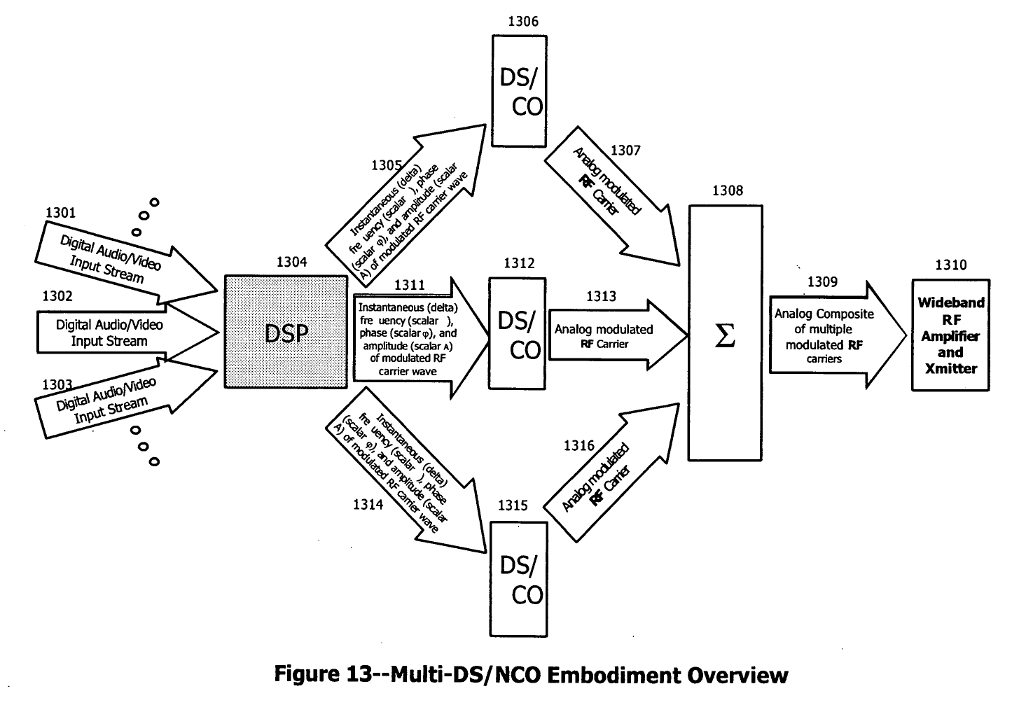

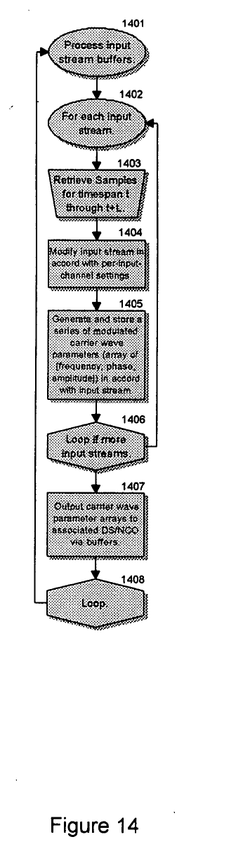

To reduce demands on the DSP even more substantially, one can use multiple DS/NCOs, as in FIGS. 13 and 14. This eliminates the need for the computationally relatively intensive step of determining the parameters of the composite wave from its component wave parameters (1207)—as noted, this is not always a trivial task-and is typically preferable to the one DS/NCO solution described above.

Digital input streams (1301-1303) are accepted by the DSP (1304) in accord with FIG. 2, and processed in accord with FIGS. 14 and 4, FIG. 14 being a modification of FIG. 12. The early and middle processing (1401-1406) is identical with FIG. 12. But then, instead of calculating the frequency, phase, and amplitude information (the last varying only in AM) of the composite carrier wave based on the same characteristics of the component waves, those characteristics of each component carrier are digitally streamed (1407; 1305, 1311, 1314) directly to an associated DS/NCO (1306, 1312, 1315) via a memory buffer (again parallel to FIG. 12, but with a greater quantity of streams—one for each DS/NCO). Once these output stream buffers are set up, the DSP loops back (1408) to receive the next set of input stream buffers. Note that the parameter streaming rate for each will be comparatively low, related (and commonly identical) to the sampling rate of the baseband input channel rather than to the RF or IF carrier frequency, with the DSP resources needed to compute these streams similarly exceptionally low. It's also important to realize that, depending on the particular DS/NCO used and on one's software preferences, the phase and frequency parameters can be interchangeable in whole or in part, i.e., one, or the other, or a bit of each can be used to successfully characterize the simple carrier wave.

The DSs/NCOs (1306, 1312, 1315), receiving the necessary digital parameters, generate the specified analog RF (or, if preferable, IF, with later frequency multiplication or mixing [typically immediately prior to transmission]) carrier waves (1307, 1313, 1316) which are then summed/composited (1308), that sum, the composite super-carrier wave (1309), then received by the wideband RF amplifier and transmitter (1310).

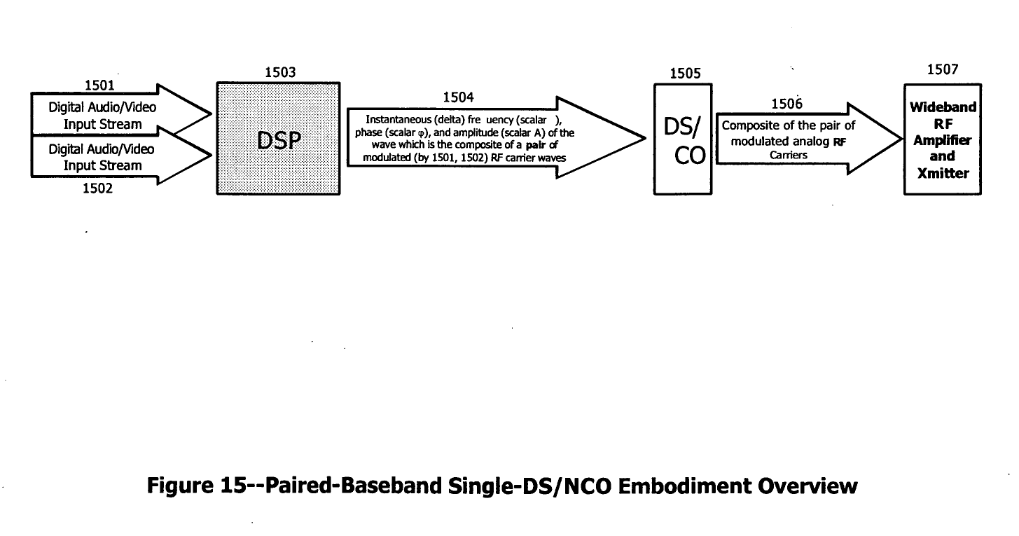

An interesting, flexible, and powerful hybrid of the single- and multi-DS/NCO approaches comes via sending two (2) baseband signals per DS/NCO, as described below and shown in FIGS. 15-17.

This approach relies on a useful mathematical identity, namely, where

$$sin ( u ) + sin ( v ) = 2 cos ( \frac{u - v}{2} ) sin ( \frac{u + v}{2} )$$

$$ⅆ u / ⅆ t = {ω}_{1} + {m}_{1} ( t )$$

$$ⅆ v / ⅆ t = {ω}_{2} + {m}_{2} ( t )$$

$$u = {\int }_{0}^{t} \frac{ⅆ u}{ⅆ t} ⅆ t = {ω}_{1} t + {\int }_{0}^{t} {m}_{1} ( τ ) ⅆ τ$$

$$v = {\int }_{0}^{t} \frac{ⅆ u}{ⅆ t} ⅆ t = {ω}_{2} t + {\int }_{0}^{t} {m}_{2} ( τ ) ⅆ τ \\$$

This identity is useful in that it permits us to reduce substantially the digital signal processing requirements. When two FM waves are composited using this identity and direct FM mathematics, one is able to perfectly characterize the resulting wave via the following two formulae:

$$f = \frac{( {ω}_{1} + {m}_{1} ( t ) ) + ( {ω}_{2} + {m}_{2} ( t ) )}{2}$$

$$A = cos ( \frac{u - v}{2} )$$

Where f is the frequency of the dual-carrier composite wave and A is the amplitude. Not only does this conveniently and in a computational simple form reduce the two waves to one, but f (which conveniently is precisely the average of the two otherwise independent carrier frequencies) need only be updated at the same rate as the baseband samples that modulate each carrier in the dual-carrier composite. A, on the other hand, is not invariant with respect to a given baseband pair of samples but rather (because u and v vary continuously rather than continually with time) is a wave of frequency ω₁ minus ω₂—typically much higher than baseband, but also much lower than an RF or even IF frequencies, meaning that if it's sampled out to a DS/NCO's amplitude-input, less DSP “horsepower” is used than in the simplest embodiment or even the first DS/NCO embodiment. (The same identity and similar formulae apply to many other forms of sine-wave-based modulation, not just ordinary FM.)

These DS/NCO embodiments together permit switching between various processing-cost models entirely in software-the very same compositing hardware can, on-the-fly, switch from a very low load (say, n) single modulated carrier per DS/NCO design to a medium-load (perhaps 100 n) two-carriers per DS/NCO solution, and if desired from there to a higher-load (perhaps 10000 n) multiple-carriers-per-DS/NCO approach; or any combination of these with multiple hardware DS/NCOs.

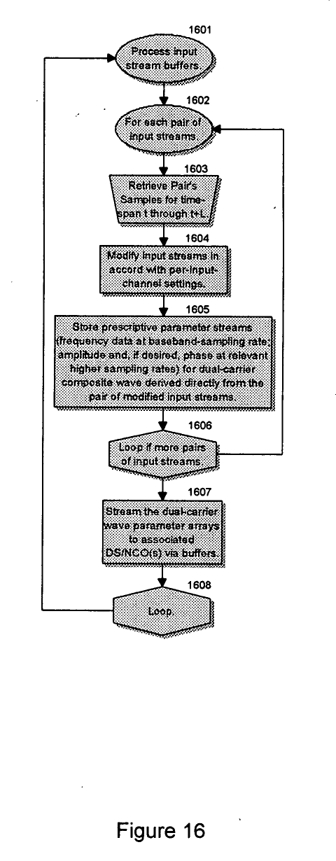

Stepping through this diagrammatically, FIG. 15 shows this dual-carrier approach with a single DS/NCO. A pair of baseband input signals (1501, 1502) are received by the DSP (1503) which processes the pair as described in FIG. 16 and as per the formulae above (or their equivalents for the relevant type of modulation). The instantaneous frequency, phase (as applicable, depending on the relevant modulation type), and amplitude for the dual-carrier wave is then passed to the DS/NCO (1505) which in turn produces an RF composite carrier wave based on those parameters (1506), which wave is then amplified and broadcast. (Consistent with variations of earlier embodiments, this may be advantageously implemented using IF instead of RF when appropriate.)

FIG. 16 details the DSP's processing. Receiving the input stream data (1601), for each pair (there's only one pair in FIG. 15) of input streams (1602), the relevant baseband samples (for time span t through t+L) are fetched (1603) and modified according to the specifications set in FIG. 4 (1604). Using the formulae noted above (or their equivalents for the particular form of modulation chosen, e.g., in FIG. 4), the DSP computes and stores characteristics for the dual-carrier composite of the pair of input streams (1605). If there are more input streams-there aren't in FIG. 15—then the loop continues (1606) until each stream has been processed.

Once all streams have been processed, the stored dual-carrier parameters are streamed at the appropriate rates (1607), one dual-carrier stream per DS/NCO, and preferably via DMA or some other non-DSP-intensive means. Once each dual-carrier stream has started, the algorithm loops back to repeat the entire process (1608).

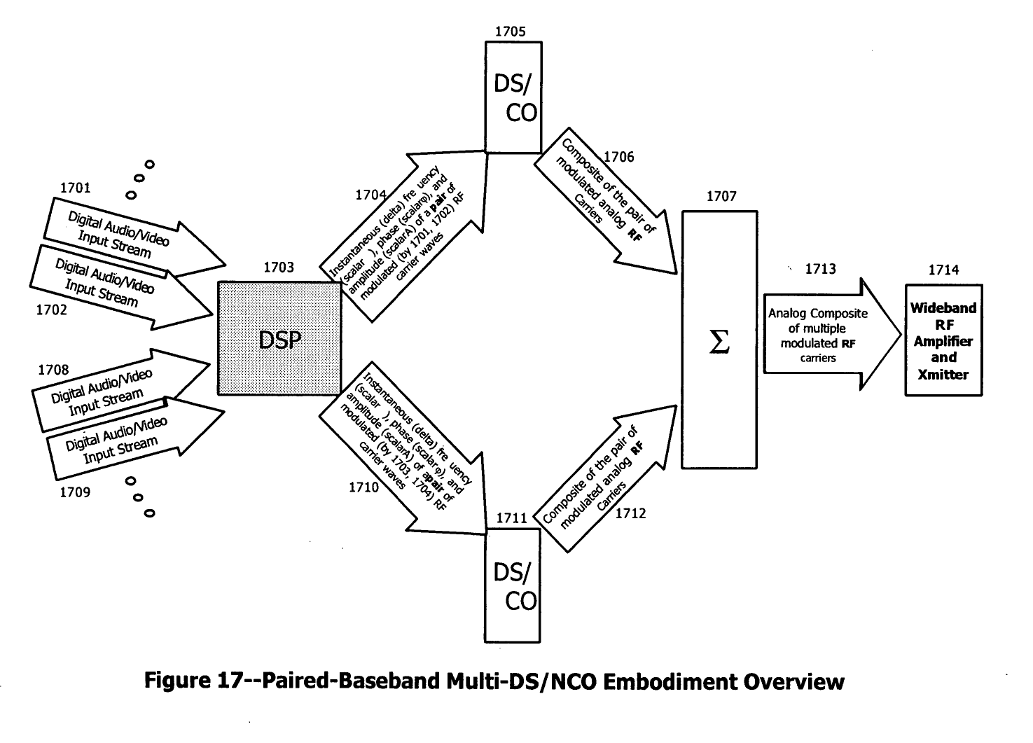

FIG. 17 depicts an embodiment similar to that of FIG. 15, but with multiple DS/NCO's and the necessary summation hardware. The initial items in the figure exactly retrace the steps of FIG. 15: a pair of baseband input signals (1701, 1702) are received by the DSP (1703) which processes the pair as described in FIG. 16 and as per the formulae above (or their equivalents for the relevant type of modulation). The instantaneous frequency, phase (as applicable, depending on the relevant modulation type), and amplitude for the dual-carrier wave is then passed to the DS/NCO (1705) which in turn produces an RF composite carrier wave based on those parameters (1706), which wave is then passed not the to RF amplifier, but to the summer (1707). Similarly, another pair of baseband input signals (1708, 1709) are received by the DSP (1703), which as before calculates therefrom the precise characteristics of a dual-carrier wave modulating a carrier for each of the baseband signals in the pair in accord with FIG. 16, these characteristics then being streamed (1710) to the associated DS/NCO (1711), which then sends its own dual-carrier composite analog RF signal (1712) to the summer (1707). The summer then adds the two (or more, with obvious replication as per 1708-1712), outputting the composite of the composites (1713) to the RF amplifier and transmitter (1714) for broadcast.

### VCO Embodiments

Another sort of external modulator may in some cases be highly advantageous for reasons of cost or flexibility: voltage-controlled oscillators (VCOs). DSs and NCOs obviate DACs since they use digital input, but one could, perhaps because of cheaper components (e.g., a shared, multiplexed DAC) or a richer or more specific analog feature-set than cost-effective DSs or NCOs provide (e.g., higher phase resolution), use a DAC not to generate the IF or RF carrier directly (as in the simplest embodiment), but to control analog modulators (VCOs) which in turn generate the appropriate IF or RF carriers and composites, the DACs making the analog hardware indirectly-digital synthesizers and indirect/y-numerically-controlled oscillators.

Paralleling our broader notion of “numerically controlled oscillators”, we here use a similarly broader-than-usual definition of “voltage controlled oscillator”, meaning not only an oscillator whose frequency varies with an input voltage (more properly called a “voltage-tuned oscillator”), but also including oscillators which vary the amplitude or phase via input voltages, these instantaneous analog capabilities being present in any desired design-time combination (one, two, or all three of the above)-like DS/NCOs but with analog inputs. That these various “VCO” designs will have substantially different underlying circuitry is of no moment to the compositor. (Again in parallel with their digital kin, this broad notion includes analog amplitude, frequency, and phase modulators.)

(There's no reason in principle, of course, why an oscillator couldn't have both analog and digital inputs as controls or signal sources, but given the extant detail of this disclosure, the hybridized changes required to adapt to such devices should be obvious to one ordinarily skilled in the art without further elaboration.)

In principle, and assuming the changes necessary for using an analog rather than digital control input, one could use a VCO wherever one would otherwise involve a DS or NCO.

To avoid explication venturing into tedium, only one of the myriad conceivably useful variations will be described in detail here, an embodiment conceptually implied but not expressed earlier: modulating single- and dual-carrier carriers via analog modulation under digital control using VCOs.

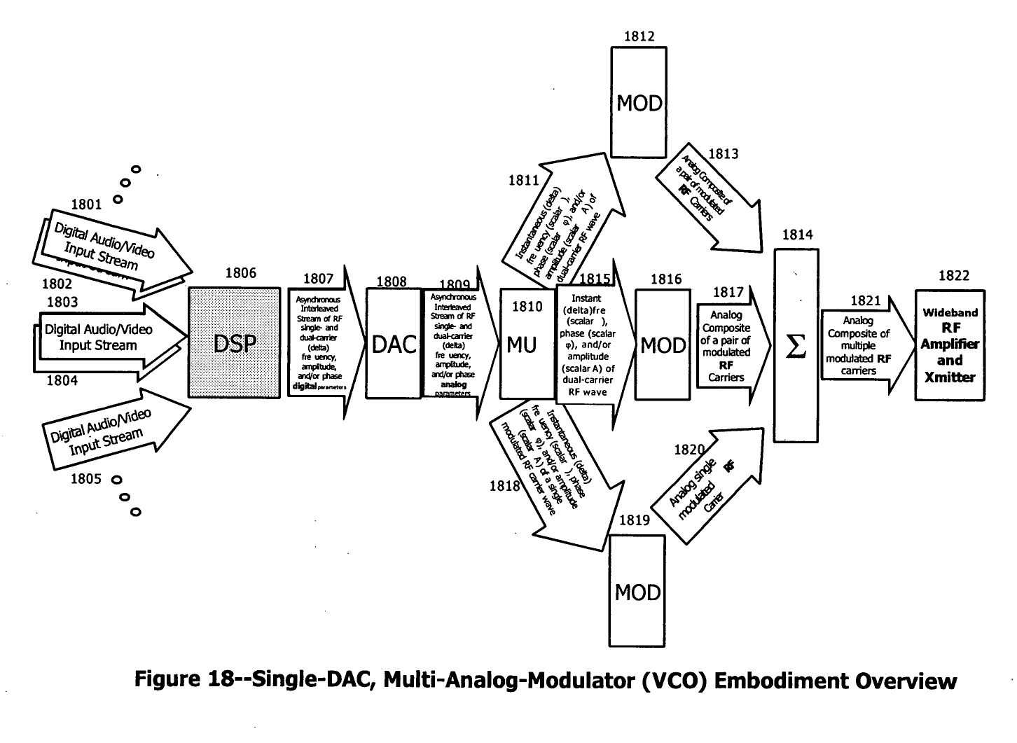

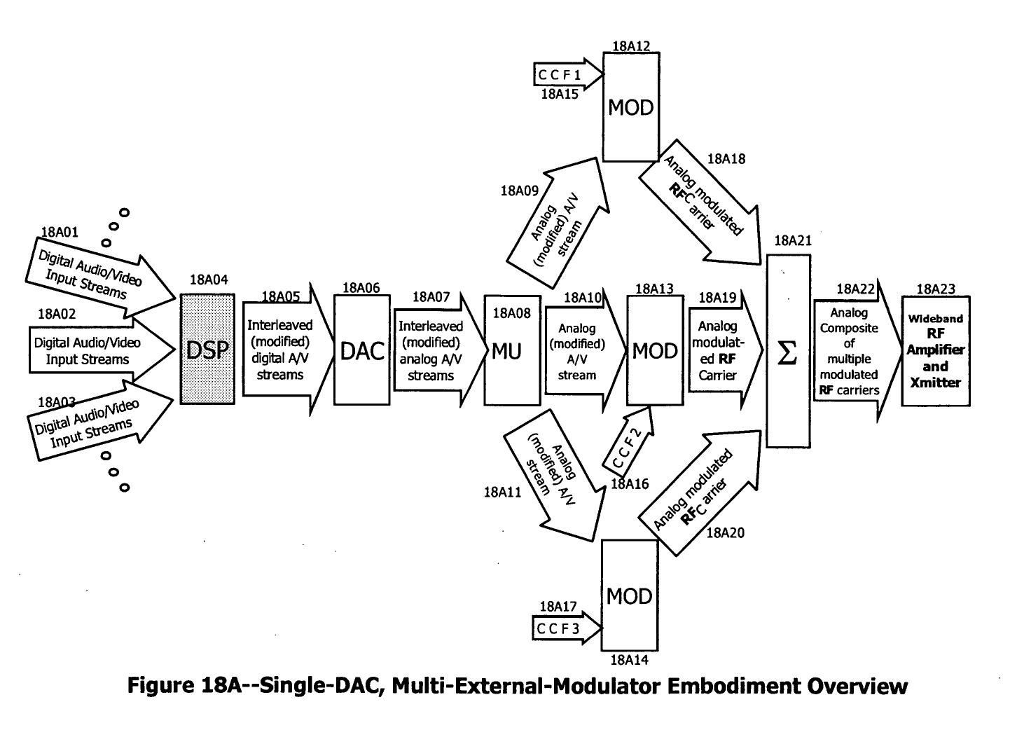

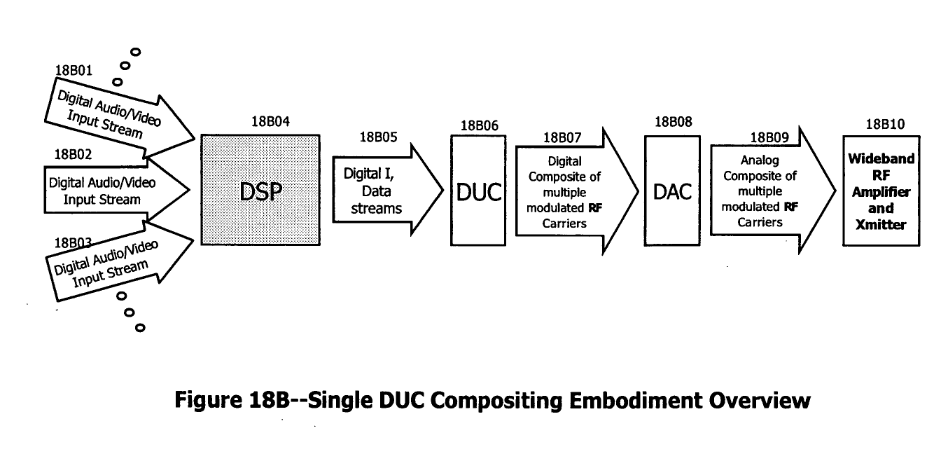

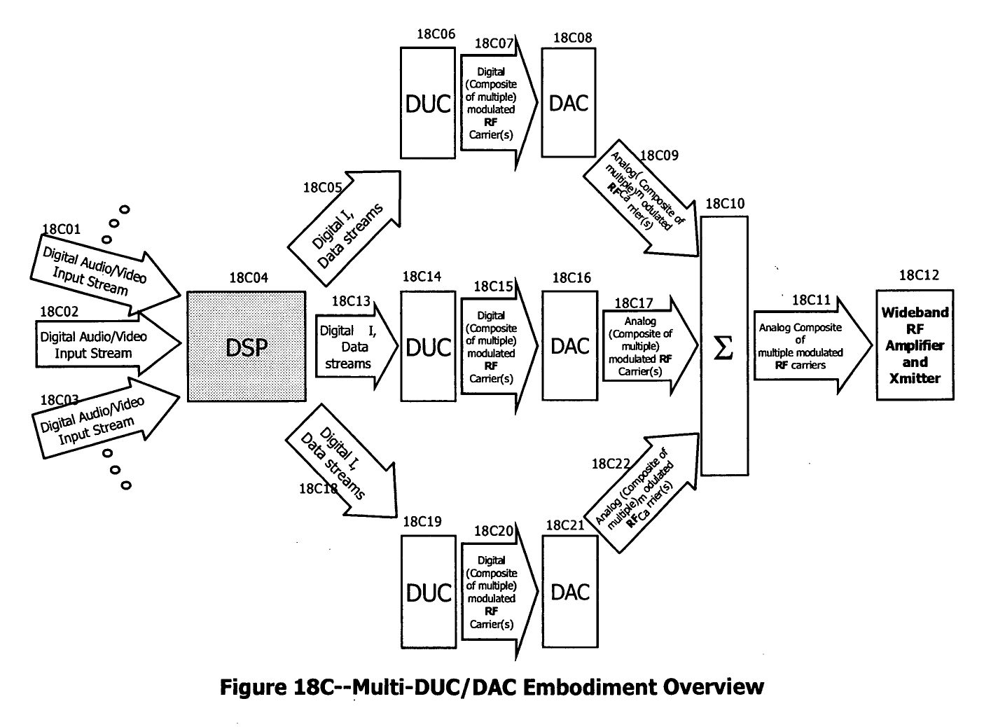

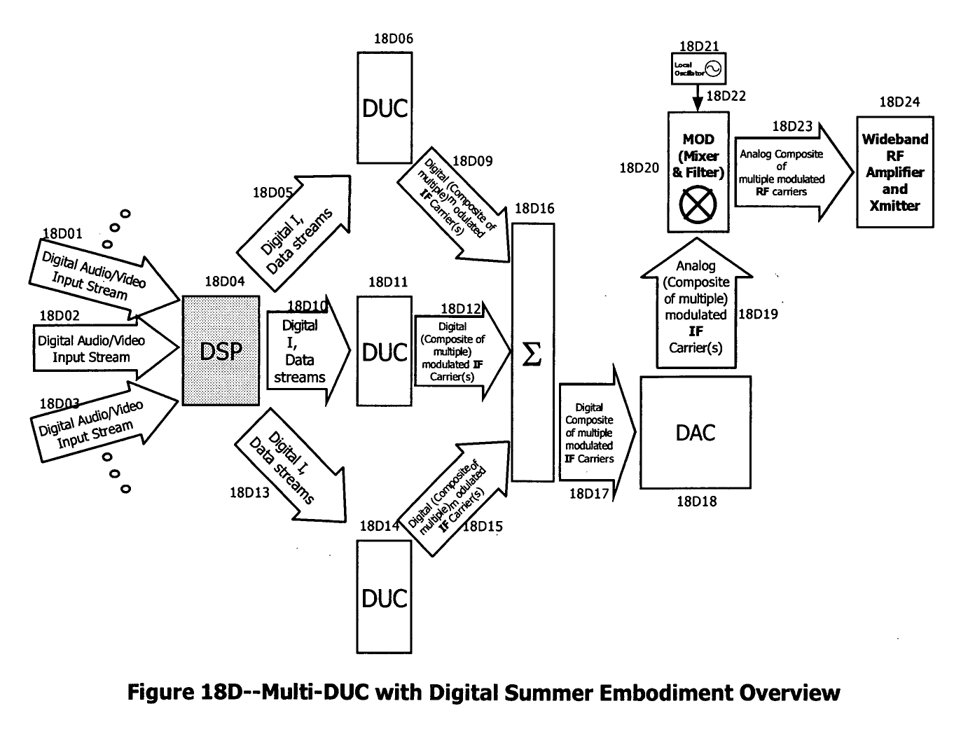

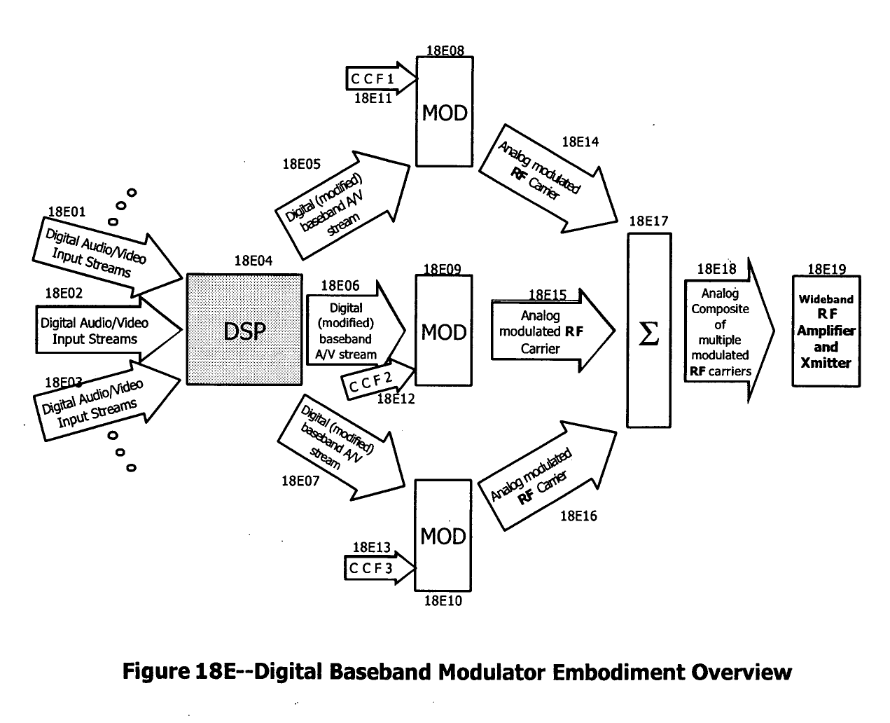

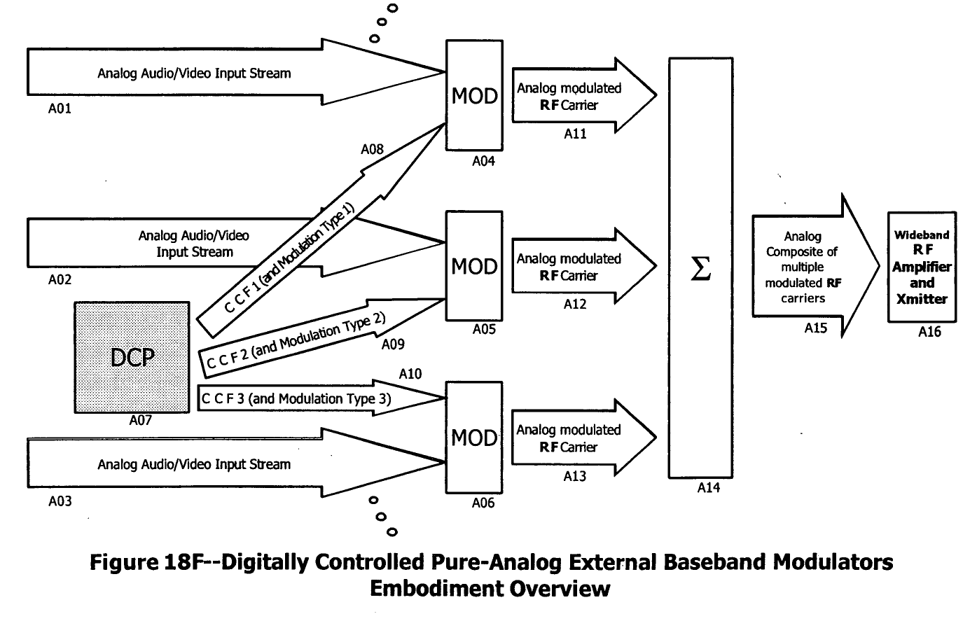

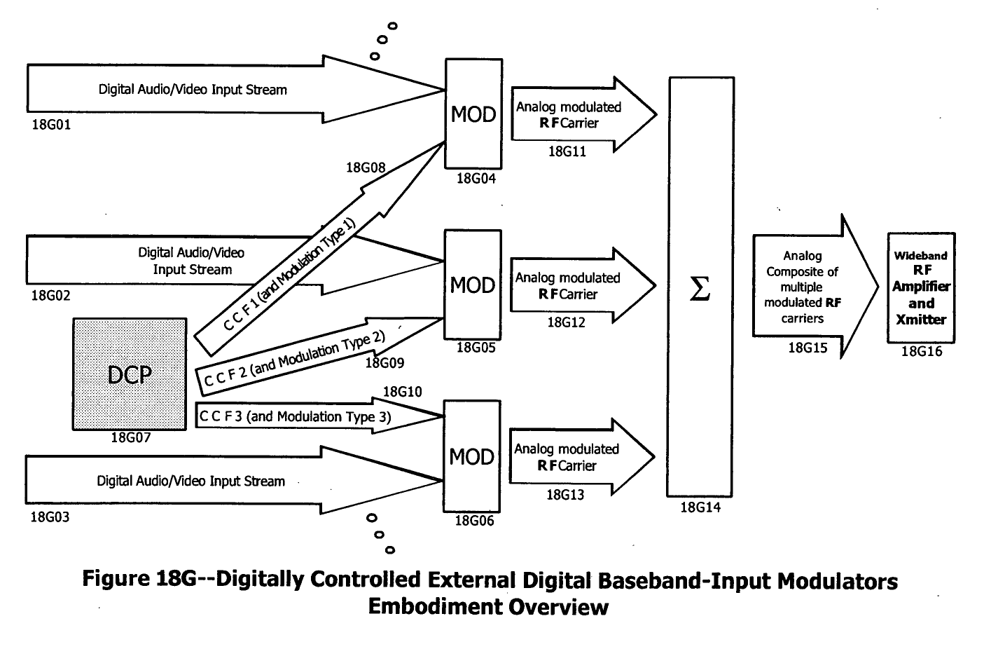

In FIG. 18, baseband input signals (two pairs, 1801-1802 and 1803-1804; and a singleton, 1805) are received by the DSP (1806). The signals are processed as in FIG. 14 (1805) and, for the two pairs, FIG. 16 (1801-1802, 1803-1804), yielding one single-carrier and a pair of dual-carrier digital parameter streams, all interleaved (1807), typically asynchronously (i.e., with each stream having a different sampling rate perhaps varying over time). These streams are fed to a DAC (1808) which outputs the resulting analog quantities (1809) to a DSP-controlled multiplexer (1810). (Note that such multiplexers are often built-in to the DAC integrated circuit package.) Under DSP control, the multiplexer (1810) distributes the analog results to the various inputs of the analog modulators as appropriate, sending dual-carrier composite frequency and amplitude (and, depending on the application, phase) information (1811, 1815) to analog voltage-to-frequency (or, voltage-to-phase, or both, if preferable) converters (1812, 1816), producing in each case a dual-carrier RF (or IF, if desired and with commensurate frequency multiplication or mixing later) signal (1813, 1817); and sending single-carrier frequency, phase, and amplitude analog information (1818) to (e.g.) an analog phase-modulator (1819), which then outputs a single RF (or IF, qualified as in 1813 and 1817) carrier (1820). Each carrier signal (1813, 1817, 1820) is received by the summer (1814) for analog compositing, the resulting composite (1821) then being sent to the RF amplifier and transmitter for broadcast (1822).

### Digital Upconverters

More recently, a simple, digital option has emerged for external modulation that's useful for digital signals or for upconverting IF signals to their proper RF location: digital upconverters.

Digital upconvertors (DUCS) can be understood as simple, semi-programmable, narrowly tailored mini-DSPs, often dedicated to mixing or, more often, to I/Q modulation (which combines a pair of mixers, a shared local oscillator [one mixer having a 90-degree phase shifter between it and the local oscillator], and a summer-all digital). Their advantage over full-fledged DSPs is usually a combination of performance and price, each of which is optimized for this particular task, while retaining DSPs' big advantage: purely digital processing.

The most interesting property of I/Q modulators, and the fundamental reason for their use, is that their particular combination of local oscillation (the signals from the shared oscillator unshifted and shifted by 90 degrees of phase to the two mixers, respectively), mixers, and a summer effects a precise conversion of the rectangular I and Q “coordinates” into the standard polar, phase and amplitude description of a single wave: each individual combination of I and Q (x and y) values correlates directly with a unique phase (f [symbol] ) and amplitude (r) shift of the carrier, exactly as though one plotted the points on a Cartesian grid and then, leaving the points in place, replaced the Cartesian coordinates (which indicate I and Q values) with polar coordinates (indicating the resulting wave's phase and amplitude). Importantly, this process is very easily reversed to yield the original I and Q values, making it simply ideal for digital modulation. (There are important practical limitations on this, of course-the noisy and imperfect real-world transmit and receive precision for I and Q commonly limit the number of discrete values for each to anywhere from 2 [e.g., QPSK] to 16 [256QAM], as of this writing.)

In FIG. 18B, the simplest example, a single DUC and DAC get the job done. Digital input streams (18B01-03) are accepted by the DSP (18B04), which derives from these corresponding streams of I and Q values (18B05), the rate and values of which will depend upon the particular modulation type(s) desired, as well as whether the input streams are being combined or interleaved, or are instead or also being sent to multiple I/Q modulators within a single DUC (a common configuration). (The DUC internal local oscillator frequency is, in this and other DUC embodiments, typically under DSP or other digital control rather than hardwired; this is not depicted just to avoid clutter, especially given the common case of multiple l/Q modulators and local oscillators within one DUC package.) These I/Q streams are accepted by the DUC (18B06) and mixed and summed (and possibly collectively summed, if this is a multi-modulator DUC) into the desired, much higher frequency digital RF (or in some cases [not depicted] for reasons of cost or capability, IF, in this embodiment and subsequent DUC embodiments) composite (18B07). A DAC (18B08) converts this digital RF composite into an analog RF composite (18B09), which signal is then broadcast (18B10). (If the composite is IF, it will then commonly go through an additional stage of upconverting, typically using an analog mixer/SSB modulator or a frequency multiplier.)

FIG. 18C offers a more complicated but powerful approach. As usual, a plurality of digital inputs streams (18C01-03) is received by the DSP (18C04). The DSP derives from these corresponding streams of I and Q values (18B05), and then distributes one (or more) of them (18C05, -13, -18) to each DUC (18C06, -14, -19), each DUC then upconverting (i.e., in this case, I/Q modulating and possibly then summing) the I/Q streams it receives to the desired RF (or, if preferable or necessary, and with further upconversion downstream, IF) frequency carrier(s) (18C07, -15, 20). Associated DACs (18C08, -16, -21) then convert the digital RF carriers to analog (18C09, -17, -22), which analog RF carriers (which themselves may be composites) are then summed (18C10), the composite (18C11) then being broadcast (18C12).

It's typically the case, of course, that actual embodiments are determined not by conceptual simplicity or elegance so much as by purely practical considerations such as design and manufacturing cost and the imperfections in actual (versus ideal) hardware; such compromises can lead to embodiments such as the one in FIG. 18D, which begins the same way as does FIG. 18C: a plurality of digital input streams (18D01-03) go to the DAC (18D04), the input streams used to generate corresponding streams of I and Q values (18D05, -10, -13). These streams each each have an associated DUC (18D06, -11, -14) which upconverts (as in 18B and 18C) the signals to higher frequency, in this case IF carriers (18D09, -12, -15), which carriers are then digitally summed (18D16). This instantaneous digital, arithmetic sum (18D17) is then passed to a DAC (18D18), which converts the composite IF carrier into its analog equivalent (18D19), which in turn goes to the mixer (18D20), which also receives input (18D22) from the appropriately tuned local oscillator (18D21), and therefore outputs the final RF composite carrier (18D23). (It's assumed, though not spelled out in this figure for space reasons, that the output from the mixer is properly filtered as shown in earlier embodiments, or that an SSB mixer configuration is used.) Finally, the RF composite carrier is amplified and transmitted (18D24).

It's important to note that while I/Q modulators (whether digital, as discussed here, or their functionally basically identical kin, analog) are typically used to transmit digital information they are not essentially digital. E.g., one could easily calculate the I and Q values to produce the proper instantaneous rate of continuous phase shift necessary to produce an FM audio carrier (since frequency is identical to the rate of change of phase), or to vary the amplitude to produce an AM signal (for AM radio, or for television video, e.g.) while allowing the phase to go relatively unshifted. (This isn't the ordinary way to create such signals, but it may be ideal in some circumstances, as when one wishes for independent reasons to do any of a wide variety of modulation techniques with only one kind of digital modulator.)

Along similar lines, in conjunction with a Hilbert transform one can use an l/Q modulator as a part of a single-sideband modulator (as noted earlier), or one can use an l/Q modulator as a simple mixer by sending one's to-be-mixed signal to one input, and setting the other to zero-each of which could be useful in various embodiments of the compositor, but neither of which warrant further, detailed disclosure here.

### External Baseband Modulators

Reducing DSP signal processing most radically, using suitable DS/NCOs or suitable VCOs one could offload all supra-baseband or even all simpliciter signal processing, either redirecting it or simply avoiding it, depending on ones design and requirements. (With extremely simple modulation requirements, such as audio AM radio, a simple mixer is sufficient as noted earlier; normally, it takes more, but the various possible external baseband modulator ingredients are too broad and insufficiently germane to detail here—a “black box” approach is used instead.)

Looking first at DS/NCO instances, one is faced with a simple choice between offloading all except baseband or offloading even that, too. Should one wish to retain DSP baseband processing for these baseband signals, thereby allowing the DSP to modify them as desired (e.g., changing an audio signal's tone, volume, pitch, reverb, noise, and so forth), one could utilize a design relying on external (i.e., non-DSP) baseband-input DS/NCO-based modulators.

FIG. 18E shows an exemplary simplified embodiment of compositing using external digital baseband-input modulators. A number of incoming baseband digital streams (18E01-03) are received by the DSP (18E04), which (typically, but optionally and under program control) modifies the data streams (e.g., as before, in accord with FIG. 4) and then sends the resulting baseband digital data streams (18E05-07) to external digital modulators (18E08). These modulators also rely upon carrier centerline frequency information (18E11-13) in digital form, usually from the DSP but in principle from other sources (or even built-in). The digital external modulators will then create modulated carriers of the requested frequencies (18E14-16). (The modulation type is not specified here, the assumption being that a particular format of modulation will be part of the modulator's design; if the modulator, is more flexible, this too may be under DSP or other control.) These carriers are then composited (18E17), the composite (18E18) then being broadcast (18E19).

An intriguing alternative possibility-potentially useful because permitting one to use a very simple digital control processor, or to nearly completely free up the DSP for more important signal processing requirements--is to have the baseband-input external modulators accept the digital baseband signals directly, bypassing the DSP entirely with respect to signal processing (for just these signals).

This is shown in FIG. 18G: baseband digital inputs (18G01-03) go directly to digital baseband modulators (18G04-06). The DSP (18G07-here labelled DCP [Digital Control Processor] to emphasize its role in this embodiment) controls the modulators (18G04-06) by sending control information including the relevant centerline carrier frequencies (18G08-10) and optionally (if the design calls for this) the modulation type. Each modulator then outputs the relevant analog modulated carriers (18G11-13-RF and analog in this example, but potentially IF or digital in otherwise similar embodiments, of course) which are collectively received by the summer (18G14), which then outputs the composite carrier (18G15) for broadcast (18G16).

For even lower cost solutions (as of this writing, and albeit often with [sometimes acceptable] tradeoffs in quality and other accepts of capability), one can take a similar approach using VCOs (broadly construed, as described earlier).

FIG. 18A represents one typical example of this type of embodiment. Digital inputs (18A01-3-AN streams again in this example, but in principle could be any digital data, particularly if the DAC output were coarse and hence suitable for typical digital modulation formats even using a nominally analog modulator) are received by the DAC (18A04), optionally modified (optional with respect to this figure—in particular concrete instantiations of this embodiment, modification may be mandatory [e.g., applying baseband spreading as in DSSS below, or digitally applying FM stereo encoding, or digitally modifying tone, volume, compansion or noise levels, etc.]), and then interleaved with other signals (18A05) and sent to a DAC (18A06). The resulting interleaved analog signals (18A07) are multiplexed (18A08), the individual signals (18A09-11) then going from the multiplexer to their respective VCO modulators (18A12-14).

Many conventional VCOs have a carrier centerline or baseline frequency hardwired at the time of the circuit's design, the only input then being a voltage varying this hardware frequency; the broader notion of VCO used here has no such limitation (though conventional VCOs obviously fall within the scope of our this broader usage). Hence, in FIG. 18A, each of the VCO modulators also receives an optional carrier centerline frequency (CCF-18A15-17); as with local oscillator controls in the mixer figures above, the ultimate source and form of this signal is not depicted simply to make the depiction more general, since the digital or analog CCF input may be (a) the CCF waveform itself (or a proportional-frequency predecessor if the VCO hardware adjusts the incoming CCF signal) from any of the DSP via a DS/NCO or simple crystal with digital divider/multiplier, the DSP via a DAC and a conventional VCO, an otherwise tunable or fixed frequency local oscillator, or from an external source; or (b) an indicator of the desired frequency from, e.g., a DSP-controlled-via-DAC variable capacitance, a DSP-controlled digital signal, or an external source. Not shown but easily applicable with slight modifications, the DSP could also issue instructions controlling the type of modulation, were the VCOs so configured.

These analog external modulatorsNCOs may be extremely sophisticated (as with possible flexible modulation selections noted immediately above) or extremely simple. In the case, e.g., of an ordinary AM signal, all that is minimally required is a mixer with suitable local oscillator CCF input; for an FM signal, a precise-enough conventional voltage-controlled oscillator with a suitable baseline frequency.

The modulators, selected (or possibly instructed) according to the desired forms of modulation and frequency ranges, output analog (or possibly digital) modulated RF carriers (18A18-20), which carriers are then summed (18A21), the composite (18A22) then being amplified and transmitted (18A23). (One could, of course, output IF carriers instead, mixing or multiplying them up to the desired frequencies.)

AMᵢ(t)=A·(1+S·m(t))·sin(ω_{c}_{ᵢ}·t)ω_{c}_{ᵢ}. Likely the lowest cost solution (as before, as of this writing and with quality and performance tradeoffs) is to simply bypass the need for DACs and any DSP-based digital signal processing (though not, in this invention, ultimate digital control) and rely upon direct analog baseband inputs. In cases where digital control without digital processing, even at a simple baseband level, is adequate, digital expenses can be reduced deeply (typically at the expense of some, in certain cases unnecessary, flexibility and quality). This is further from the ideal of purely digital processing, but closer (compositing aside) to what's commonly been done in the past. A VCO modulator can accept a baseband signal directly and modulate it using the desired technique (AM, FM, or PM, e.g.—typically a hardware analog modulator will be dedicated to one type, but this isn't necessarily so) to the specified frequency (specified, e.g., via an outside oscillator which may be DSP-controlled, or a possibly-DSP-controlled voltage—it all depends on the hardware details of the modulators in question, which details are not an object of the invention). Multiples of these will provide multiple signals for compositing.

$${FM}_{i} ( t ) = A \cdot {sin ( {ω}_{{c}_{i}} \cdot t + S \cdot {\int }_{0}^{t} m ( τ ) ⅆ τ )}_{{ω}_{{c}_{i}}}$$

FIG. 18F shows-parallel to the digital version depicted in FIG. 18G—analog baseband inputs (18F01-03) go straight to analog baseband modulators (18F04-06), bypassing the DSP (18F07-labelled DCP as in 18G07) which controls said modulators (18F04-06) by sending control data such as the relevant centerline carrier frequencies (18F08-10) and optionally the modulation type, etc. Each modulator then outputs the relevant analog (or quasi-digital/coarsely analog) modulated carriers (18F11-13-RF here, but potentially IF in otherwise similar contexts, of course) which are all composited by the summer (18F14), which then outputs this composite carrier (18F15) for broadcast (18F16).

ω_{c}_{ᵢ} PMᵢ(t)=A·sin(ω_{c}_{ᵢ}·t+S·m(t)) As shown, then, external baseband modulators offer exceptional practical utility in numerous embodiments, having the chief virtue of allowing one in the simplest instances to move all (or all supra-baseband) signal processing off the sometimes (especially when very high sampling rates would be necessary) more expensive DSP to special-purpose circuitry for the signals involved. A significant number of examples have been given—in this light for one ordinarily skilled in the art it's apparent that any of myriad configurations would be adequate were they responsive to analog (indirectly digital) or directly digital control with respect to (as needed, and typically instantaneous) amplitude, frequency, and/or phase modulation and ultimately produced the desired composite waveform(s). There are indefinitely many other combinations and permutations of DUCs, DACs, mixers, frequency multipliers, and so forth, but these variations do not change or deviate from the essence of this aspect of the invention.

### Single-STage-, Multi-Stage-, and Meta-Transmission of Composites at 900, 2400, 5700, and 24000 MHZ

In many instances it's useful to broadcast signals over different, particularly higher, frequencies than those used by legacy consumer devices such as AM/FM stereos or televisions, particularly to overcome regulatory concerns limiting unlicensed transmission power in an otherwise more-desired spectrum (e.g., transmission power in the FM band is limited by FCC rules as of this writing to under 19 nanowatts; transmission in the various TV bands is generally prohibited). Not only newer but also, in many cases, legacy devices can be better served via covering all or most of the transmission distance using a less-restricted spectrum (e.g., near 900, 2400, 5700, or 24000 MHz).

$$vC ( t ) = \frac{C ( {t}_{b} ) - C ( {t}_{a} )}{{t}_{b} - {t}_{a}} \cdot ( t - {t}_{a} ) + C ( {t}_{a} )$$

There are many ways to exploit the higher frequencies using this compositor. Most obviously, one could simply transmit composite signals in any of these frequency ranges to a receiver in that same range. This would not be a standard legacy receiver, but might be a very similar device, frequency aside, perhaps then outputting a baseband signal via cabling connected to a legacy stereo or television, or possibly being a proprietary target with such capabilities built-in (a 900, 2400, 5700, or 24000 MHz television or stereo, e.g.).

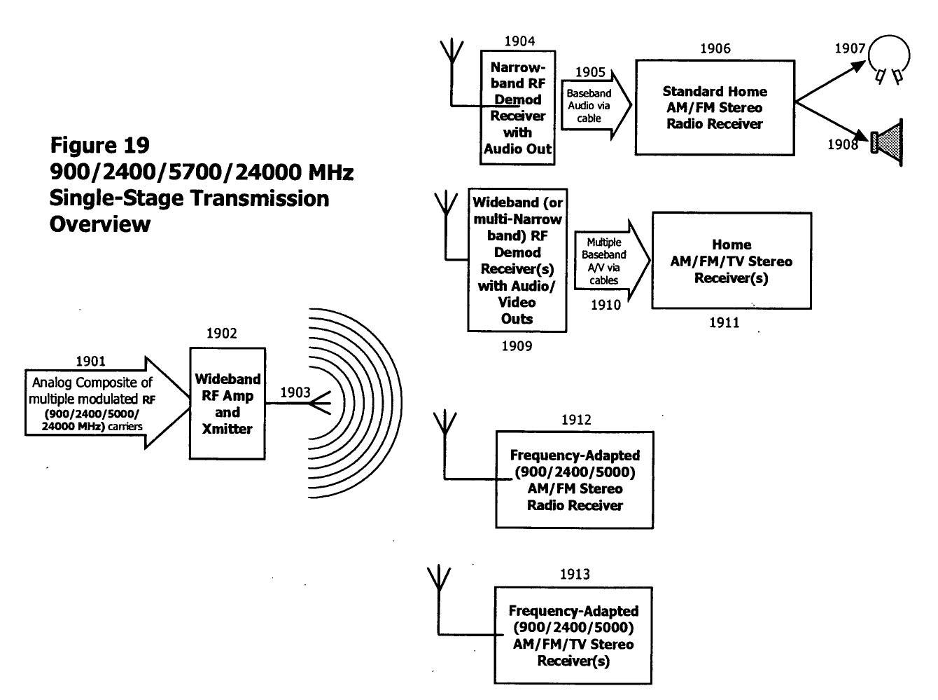

FIG. 19 displays this well.

An instance of the compositor (much of which is not shown) produces an analog composite (1901) of multiple modulated RF signals at any of the less-regulated frequency ranges (near 900, 2400, 5700, or 24000 MHz). This signal is passed to a sufficiently wideband transmitter (1902; though the carriers will often be close together, making the transmitting requirements narrower than is usually meant by “wideband”) where it is broadcast (1903).

One receiver (1904) is a narrow-band demodulating receiver with audio output—e.g., an AM or (more likely) FM receiver receiving at the transmitter's (1902) higher frequency instead of somewhere in the ordinary AM or FM band. This receiver outputs audio (1905) via a cable to, e.g., a standard home stereo (1906), which stereo of course converts the audio signal to sound via headphones (1907) or speakers (1908). This application, while simple, could be invaluable, easily allowing transmission of audio to a variety of receivers (like 1904) within existing FCC regulations.

But there are other pleasant variations on the theme. Using the same kind of transmitted signal (1903), one could more-or-less combine a number of simple receivers (akin to 1904) into a composite receiver (1909), which could be a single receiver which then decomposites and demodulates the signals—basically, the inverse of the compositor—or (as in prior art) a plurality of receivers sharing the same box (akin to a TV's housing separate audio and video receivers, e.g.). This composite receiver (1909) then outputs the variety of signals received and demodulated into baseband signals over cables (1910) connecting to, in this example, one or more home stereos and/or televisions (1911).

Of course, one could profitably take other approaches with they very same signal (1903), building the higher-frequency receivers directly into the devices that would otherwise receive them from downconverting receivers (e,g. 1904, 1909), resulting in a frequency-adapted AM/FM stereo receiver (1912) or even a frequency-adapted combination AM/FM/Television receiver (1913), e.g..

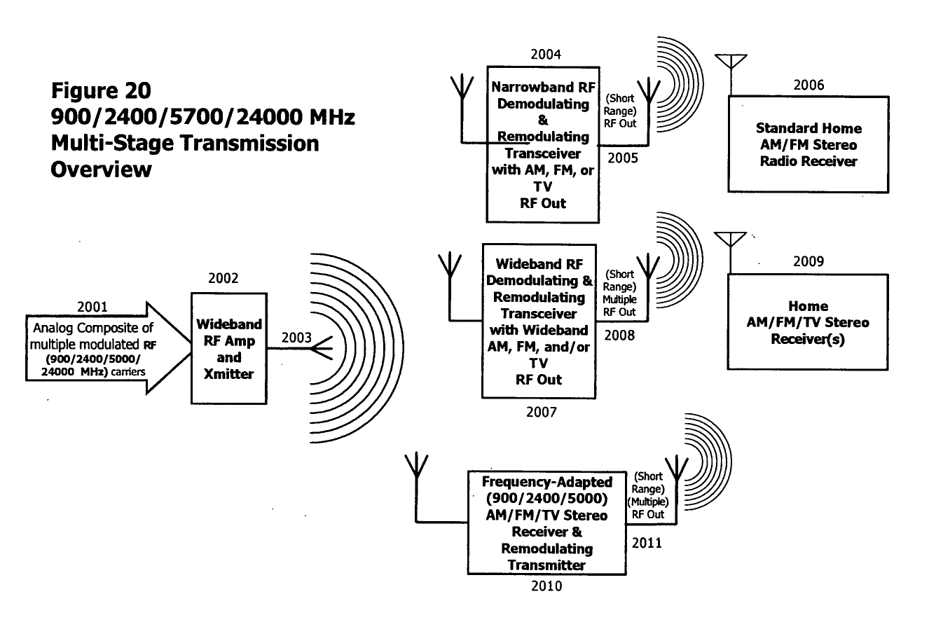

In cases where cabling or in-building are impractical or otherwise undesirable, unlike FIG. 19, FIG. 20 depicts an effective multi-stage transmission approach offering the permissible power and range advantages of higher-frequency and the compatibility advantages of legacy-frequency transmissions. As in FIG. 19, in FIG. 20 an analog composite of multiple modulated higher-frequency RF carriers (2001) is sent to an amplifier and transmitter (2003), which transmitter is at least somewhat wideband, and which then broadcasts the signal (2003) on the original incoming frequencies (from 2001). But then the differences from FIG. 19 enter the picture.

The first receiver (2004) takes a portion of the transmitted signal (2003), demodulates it back to baseband (or IF), but then rather than sending the baseband signal out via cable, it instead remodulates and then re-broadcasts the signal (2005) at a legacy frequency (in this example, at some permitted frequency in the AM or FM bands) to be picked up by a standard home stereo radio receiver (2006).

The second exemplary receiver (2007) likewise receives at least a portion of the signal (2003) but extracts multiple carriers from it (again, via either containing multiple receivers in one “box” or by containing a more sophisticated single-receiver decompositor—cf. 1909 and 1913) and demodulates them to baseband (or IF), then remodulating and rebroadcasting (2008) the plurality of signals (using another instance of the compositor, or via multiple narrowband transmitters) to one or more radio or television receivers (2009 and 2006) at legacy frequencies, potentially offering each multiple stations from which to choose. (Regulator limits will often constrain these transmissions, though these constraints are subject to change.)

The third example (2010), a modified (frequency-adapted) AM/FM receiver and/or television, parallels the last example in the previous figure (1913), receiving at least a portion of the incoming composite signal (2003) via (as in 1909) either multiple internal receivers or a single, more sophisticated decompositor. Some of these signals are consumed internally, as it were, the device being itself directly a presenter of media to viewers and/or listeners, but unlike its predecessors (1912 and 1913), it then remodulates from baseband (or IF) and retransmits at least one signal at legacy frequencies, obviating cabling. A typical example would be rebroadcasting the audio component (mono, stereo, or any of the numerous more sophisticated sound formats associated with DVDs and motion pictures), sans cabling, to a nearby stereo system (e.g, 2006 or 2009).

There's still another distinct but similar approach that can prove very useful, a hybrid of single- and multi-stage transmission best called “meta-transmission”. As in FIGS. 19 and 20, the transmitter (2102) accepts an analog composite of multiple radio-frequency carriers (2101), but unlike those figures', these carriers represent either frequency-shifted (via mixing or DUCs, say) or frequency-multiplied (via-unsurprisingly-frequency multipliers) legacy-frequency carriers. (Importantly, these carriers needn't necessarily be constructed in the manner this representation suggests—that is, in many cases the higher-frequency, ready-for-simple-downconversion-to-legacy-RF carrier is easily [i.e., with no extra effort] directly creatable from the baseband signal with many standard AM, FM, and PM modulation formats using previously noted embodiments of the compositor, the desired formats being directly moveable without effect on their message content.) This allows the various rebroadcasting receivers (2104, 2107, and 2110) to avoid the otherwise necessary remodulation step, instead directly downconverting the incoming signal(s) (typically selectively) to the desired legacy frequency(s).

For example, a narrowband RF downconverting transceiver (2104) downconverts one signal from the composite (2103) and rebroadcasts it on the desired legacy frequency (2105) to a nearby standard AM/FM receiver.

Similarly, a multi-channel downconverting transceiver (2107) consisting, as above (2007), of multiple receivers and mixers/dividers in one “box”, or a (typically single) more sophisticated decompositor unit, or even (since no remodulation is involved) a simple single mixer/divider applied uniformly to the desired signals (the frequency spacing and mixing/division relationships then being determined on the sending side in the process of generating the original analog composite of multiple carriers [2101]) frequency-adjusts the desired subset of signals (2108) derived from the original broadcast (2103) to the desired legacy frequencies, which resulting carrier signals are received by one or more media presentation devices, such as an AM/FM/TV stereo (2109) or a simple AM/FM stereo (with one or more resulting stations available).

Finally, and akin to the last example in the preceding two figures, a frequency-adapted AM/FM receiver and/or television (2110) derives a plurality of signals derived from the initially broadcast composite (2103), using one or more of them internally, and downconverting (typically other, but not necessarily) selected signals to rebroadcast (2111) without remodulation to nearby receivers (such as a rebroadcast of the stereo or other audio to a nearby FM or other audio radio receiver—cf. 2011).

It's important to note that the details of the downconversion and retransmission process can vary substantially, the final legacy frequencies being controlled by the original higher frequencies with an inflexible or “dumb” downconverter, or the particular legacy frequencies might be controlled on the downconverter side if it's “smart” enough to adjust its own mixing or frequency division and associated filtering. The details of this are not an object of the present invention.

### Baseband Compositing

There's another system that could be applied to all of these multi-stage approaches which could offer numerous advantages.

It's possible to composite not only carriers with each other, but carriers (typically, and usually preferably, low-frequency) with a baseband signal, this composite then being treated as just another baseband signal by a modulator, thereby encapsulating additional information with the baseband signal into a single carrier. Using the proper filters (or, in the case of presentation audio, simply relying on the limits of human hearing), this can (if one wishes) be done completely transparently from the ultimate recipients' perspective. This allows one to use standard off-the-shelf transmitters and receivers (provided they supply adequate bandwidth for one's particular purposes) to transduce not only the baseband signals for which they were intended, but whatever else one might want to convey to the target devices.

FM stereo uses a primitive, limited version of this approach to transmit the analog ultrasonic signal necessary to reconstruct stereo audio when used to modify the sonic monaural signal; similarly, other schemes will encode an extremely low frequency (under 20Hz) signal for control purposes. But applying to baseband compositing the wideband approaches described in previous embodiments, we can (and in one of the compositors contexts of compositing multiple [e.g.] presentation signals, will sometimes wish to) go further and actually encode full-blown presentation signals as desired directly into the putative baseband stream.

(For purposes of the compositor, “presentation signal” is defined as a signal which is offered as-is to the user, subject to user modifications [volume, tone, brightness, contrast, etc.]—signals directly ready for human consumption, not requiring any modifications regarding content. For example, the monophonic L+R component of an FM stereo signal is a presentation signal, whereas the neither the encoded nor decoded L−R is, since it is not designed to be presented as-is to a human listener, instead being used to modify another signal [in the latter case, the erstwhile monophonic presentation signal of L+R] to derive still other signals [the left and right channels of stereo audio, these signals then presented to the user instead of the monophonic L+R].)

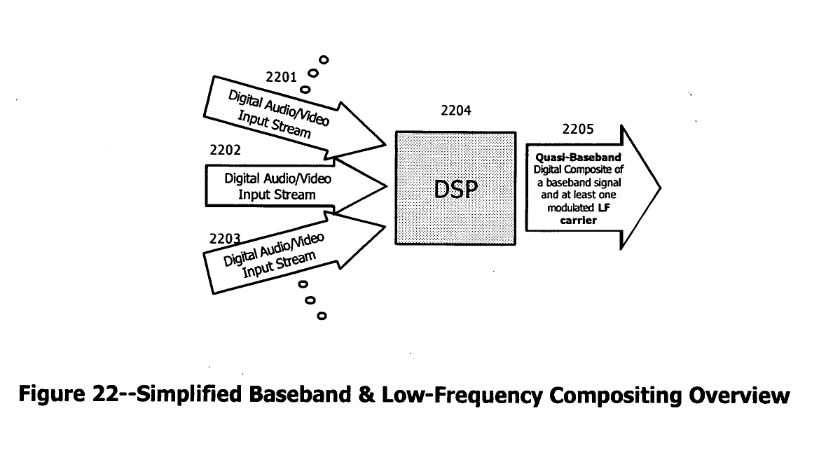

FIG. 22 depicts a basic, archetypical instance of this baseband and low-frequency compositing, which instance can be applied to any of the preceding embodiments. A plurality of digital inputs (2201-2203) is received by the processor (2204) where all but one of the signals are used to modulate a carrier as described earlier, except (typically) at as low a frequency as possible given the bandwidth needs of other signals forthwith to be composited. These signals are then composited by the processor and output as a single, quasi-baseband composite wave (2005). It's important to note the core differences between this and the previously described aspects of this compositor: this includes in the composite an unmodulated, baseband signal, the accompanying, typically low-frequency, carrier(s) being not necessarily merely for control or baseband signal-modification purposes, but themselves possibly full presentation signals.

Powerfully, this quasi-baseband composite can be treated as a baseband input in any of the preceding embodiments (resulting in a sort of meta-composite-a composite of composites), but a further modification is needed from the perspective of the overall system: not just the invention but the target device must be sensitive to the additional, non-baseband signals if the device is to utilize them (or, depending on the device and the signal, if it's merely to avoid being confused by them). Also, depending on the bandwidth requirements of the carriers and baseband signal being composited, the receiving hardware and software may require larger-than-usual-for-baseband bandwidth capabilities.

So FIG. 22 can helpfully be seen as a special-case enhancement schema for any of the embodiments' (even its own) baseband input portions, but it's also instructive to realize that any of those embodiments, by (1) removing or bypassing the broadcast-related amplification and transmission components, (2) removing or bypassing any redundant modulators for composite unmodulated baseband input, and (3) modulating the remaining signals at LF (instead of IF or RF) could also function as the means for modulating the LF carriers and compositing them with said baseband input. (As this LF composite can in turn, as shown above and mentioned immediately above, be used as a quasi-baseband input to an overarching, subsuming instance of the compositor, the compositor is in just this sense potentially indefinitely recursive.)

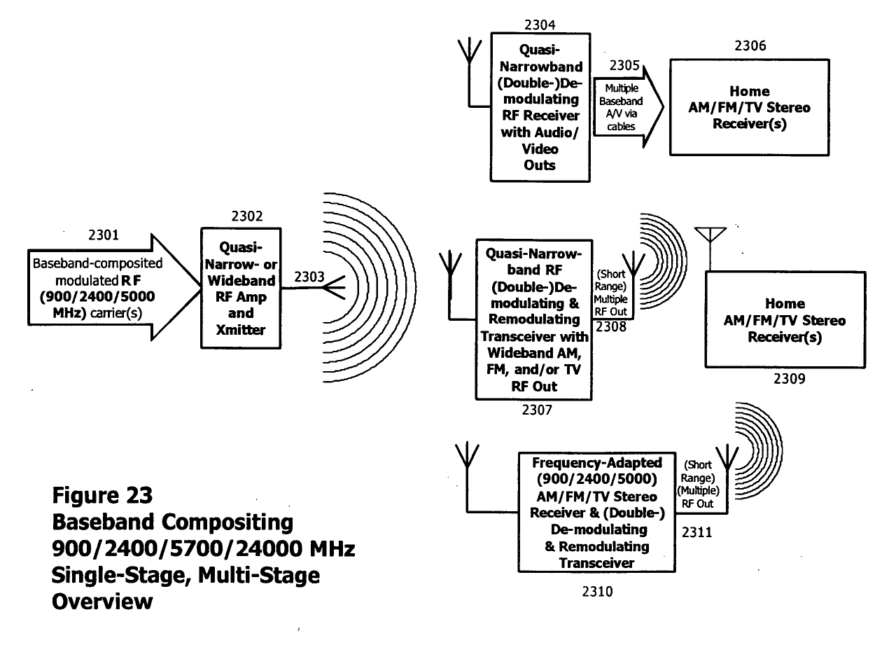

FIG. 23 portrays several typical uses of this aspect of the invention in contexts of single-stage-, multi-stage-, and meta-transmission in the 900, 2400, 5700, or 24000 MHz frequency bands. (Baseband compositing, particularly of presentation signals, is currently less useful for legacy devices since legacy devices don't understand such signals in their entirety-hence there's little incentive to use the more heavily regulated, lower-power legacy frequency spectra such as commercial AM, FM, television, and so forth.)

The incoming, baseband-composited (as per FIG. 22—adaptations any of the previous baseband-receiving embodiments) and then modulated (and possibly composited again, all this as per any previous carrier-modulating embodiment) RF carrier (2301) is received by the quasi-narrow (if the only carried signal is a single baseband composite) or wideband (if the incoming carrier is a supercarrier of multiple RF carriers) transmitter (2302), the received signal being immediately broadcast (2003).

A single-stage, narrowband (perhaps better called quasi-narrowband, since the single carrier signal received is itself composite) receiver (2304) picks up (at least the relevant portion of) the signal (2303). This receiver is labelled “(Double-) Demodulating” since the receiver first demodulates the carrier (as with any ordinary radio receiver), but then further demodulates any (typically LF) modulated carrier(s) composited with the pure-baseband signal(s), outputting the resulting baseband signals (2305) via cabling to any of one or more conventional AM/FM or television receivers (2306), or (of course) any other audio, video, or generally wired-signal-receiving device, as per the design of a particular instantiation.

A multi-stage version has a similar receiver (2307) that is also a remodulating transmitter. After receiving and (double-) demodulating the signals precisely as did the previous receiver (2304), the resulting baseband signals are used to modulate carriers which are broadcast (2308) to nearby legacy devices (e.g., 2309) via their legacy frequencies. (The particular legacy frequencies chosen, and the means by which they are chosen, obviously and importantly will vary with the particular design instantiated, which precise details are not an object of this invention.)

This capability can be built-in to a frequency-adapted AM/FM receiver or television (2310; or nearly any other penultimate target device), paralleling the non-baseband-composited version (2010), but with at least one of the baseband signals used to modulate a carrier at a legacy frequency (2311), to then be received by one or more legacy devices (e.g., 2309), being beforehand demodulated from a baseband-composite signal.

### Direct Digital Output Compositing

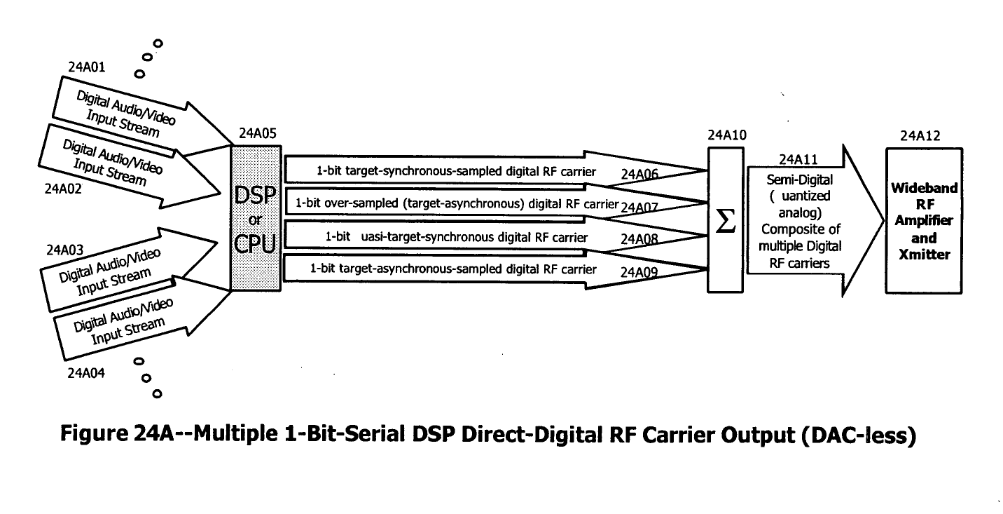

In some transmission/reception scenarios, the DSP can generate the signal to be transmitted more even more directly, the DSP output not (as is usual) encoding the signal to be transmitted (whether a baseband signal or a carrier signal is meant), but instead being the baseband or carrier signal (or rather, typically, a pre-filtering version of that signal-a literal, perfect square wave would require infinite bandwidth, but this perfection is never achieved nor often wanted in reality). This is paradigmatically apropos when transmitting to a digital receiver (using a modulation appropriate for digital, such as MSK, GMSK, BPSK, QPSK, 8PSK, OQPSK, DQPSK, FSK, VSB, QAM, PHS, and so forth), but in many cases even a 1-bit-absolute digital signal can be produced in such a way as to approximate a particular analog signal expected by a receiver. (A 1-bit delta signal is different, in that FIG. 24A depicts one conceptually simple embodiment.

First, and as usual, digital AN inputs (24A01-24A04) are received by the DSP (24A05). (It's important generally, but particularly important with the more-purely-digital embodiments, to recognize that the inputs needn't be AN inputs, but can in principle be absolutely any digital signals.)

The DSP then converts the received signals into a series of 1-bit digital streams (24A06-24A09) in any of a variety of ways (depending completely upon the modulation format the DSP is programmed to use), four of which (though the quantity and type are arbitrary) are depicted here. Each of the four output streams in this embodiment is directly an RF carrier. The DSP might be programmed to directly and synchronously (and therefore perfectly) generate a 1-bit RF carrier encoding the signal the receiver expects (24A06); or it might (24A07) be programmed to oversample the carrier (permitting carriers of a variety of frequencies, but requiring a higher sampling rate and typically offering only an approximation of the ideal carrier); or it might generate a quasi-synchronous signal (24A08), not even attempting to generate the “perfect” carrier, but sampling the carrier just often enough (the sampling rate possibly varying significantly, even instantaneously) to ensure successful transmission to the receiver (obviously this requires a particularly clear understanding of the relationship between the transmission and the receiver); or (least typically) it might generate an undersampled signal (24A09), which signal would exhibit degradation-yet in some cases the degradation may be acceptable in comparison with the hardware power available and the exact use of the signal by the receiver, particularly if the undersampling frequency is optimized. (The precise natures of any encoding schemes will vary with the intended use and receiver and are not objects of this invention.) These four carriers are then summed (24A10), typically (though not necessarily) using an analog summer, the composite (24A11) then being amplified and transmitted (24A12).

(It's particularly important to note that any or all of these streams may be of the same type-the variety depicted is shown only for expansiveness.)

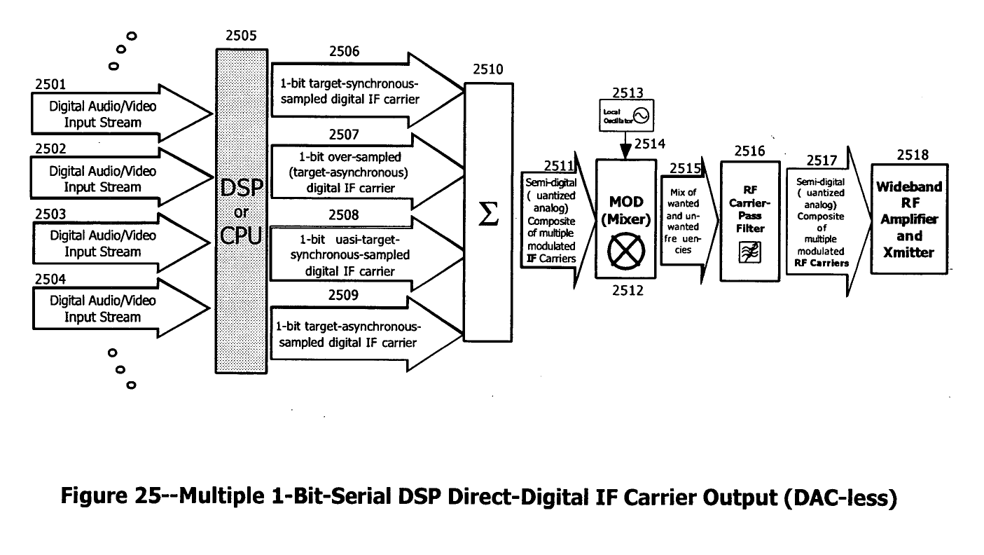

FIG. 25 depicts another use of direct digital output compositing. Like FIG. 24A, FIG. 25 offers carrier output, but usefully at an intermediate frequency.

Digital streams (2501-2504) are received by the DSP (2505), which processes them into four IF carriers in ways parallel to that of FIG. 24A. The DSP may generate an IF carrier synchronously and (with respect to sampling timing) perfectly (2506); it may (typically asynchronously relative to carrier frequency) oversample the carrier, gaining flexibility and breadth at the expense of perfect fidelity (2507); it might quasi-synchronously sample the desired carrier (2508), ideally (and this by design) sampling at times most relevant to the receiver to convey all desired data without generating a “perfect” carrier; or it might asynchronously undersample the desired carrier (2509), creating a significant fidelity loss that might be acceptable in certain scenarios, given the reduction in digital processing power requirements. (As in FIG. 24A, this last carrier (2509) would require particular attention to the needs of the receiver.) These four carriers are then summed (2510), the composite (2511) then being sent to a mixer (2512). In this example, a single mixer with a single local oscillator (2513) and local oscillator input (2514) is used. To preserve the simplicity of the figure, and since the more complicated details are adequately spelled out in previous figures (e.g., FIGS. 10A-10D), the precise results of the mixing are here only summarized rather than elaborated: the mixer output (2515) is sent to a relevantly configured RF carrier-pass filter (2516), the output from that (2517) being just the RF carriers desired, which carriers are then amplified and transmitted (2518).

$$sin ( u ) \cdot sin ( v ) = {\frac{1}{2} [ cos ( u - v ) - cos ( u + v ) ]}_{cos ( u - v ) cos ( v - u )}$$

Obviously, frequency multiplication or even digital upconversion could be used here instead, but to save space (and since these are basically covered elsewhere), these embodiments are herewith mentioned but not depicted.

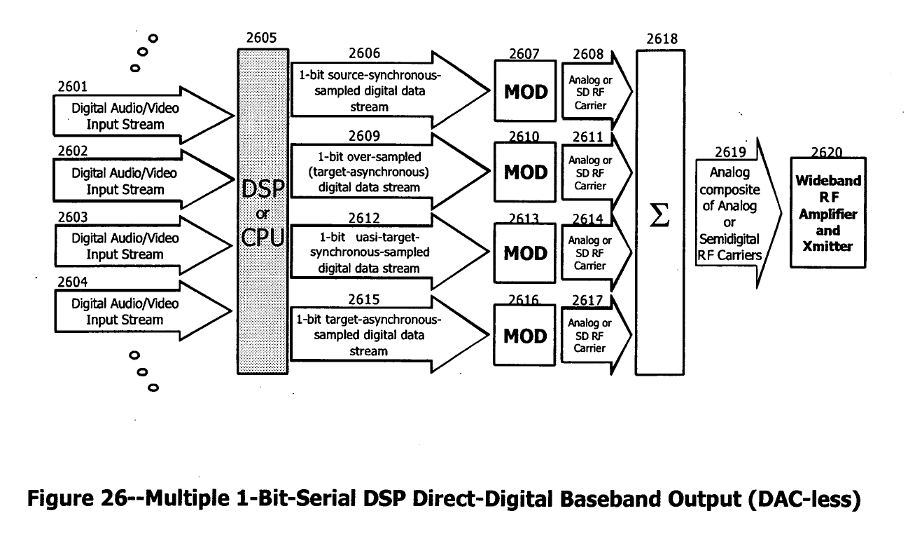

FIG. 26 shows yet another way to harness and composite direct digital output using common but powerful analog modulators.

As in the previous two figures, four digital input streams (2601-2604) are received by the DSP; the differences after that are quite significant even while partially parallel. The DSP here is converting the received signals not into carriers but into 1-bit baseband (i.e., subject to future modulation) data streams. (In some cases, the conversion will be fairly trivial, basically just serializing the parallel bits in each byte or word of data, perhaps with some protocol data interspersed or interleaved; in others, the conversion will be much more involved; in neither case are the details of these conversions objects of the present invention.) The first data stream (2606) is (as are 24A06 and 2506 before it) a synchronously sampled digital data stream, being a perfect (with respect to sample timing) instance of the desired baseband data stream. The second stream (2609) is an oversampled version of the desired data stream, as above gaining in flexibility but losing in fidelity and remaining processing power. The third stream (2612) is, as described in FIGS. 24A and 25, quasi-synchronously sampled. The fourth stream (2615) is asynchronously sampled (but not oversampled), losing fidelity but reducing processing power requirements, as with its peers in FIGS. 24A and 25.

Each DSP-generated, 1-bit baseband stream (2606, 2609, 2612, 2615) is sent to a corresponding modulator (2607, 2610, 2613, 2616). The details of the modulators are not objects of the invention, but they may be anything from simple AM, FM, or PM modulators (modulating, in this example, an RF carrier [though it could, mutatis mutandis, be an IF carrier] by the particular input [2606, 2609, 2612, 2615] received) to more sophisticated (often proprietary) variations and protocols. The results of such modulation, a series of (in this example, RF and analog) modulated carriers (2608, 2611, 2614, 2617), are then summed (2618), the analog composite of these carriers (2619) then being broadcast (2620).

It's also possible to have multi-bit purely digital embodiments, but those are reducible to either complementary single-bit streams or, ultimately, ordinary DAC embodiments (belying the purely digital nature of this species of the multi-bit genus, though it's perhaps coarser than a typical DAC embodiment-semi-digital 2-bit or 4-bit DAC circuitry, e.g., rather than the more plainly analog 16-bit or 32-bit, e.g.)

### Spread Spectrum Compositing

Spread spectrum technologies offer numerous benefits (as well as some costs) compared with traditional, spectrum-minimizing approaches, and it requires nearly no schematic changes in the previous embodiments to adapt the compositor for composite spread spectrum transmission.

Spread spectrum is typically taken to consist of two approaches: frequency hopping, which is instantaneously narrow but spread over time, and direct sequence spread spectrum, which is instantaneously spread. (There are other variants [e.g., time-hopping] and hybrids, but applying the compositor to those approaches would not be a difficult exercise for one skilled in the art given the disclosure below.)

Frequency hopping—the simpler of the two techniques—takes what would be a single fixed-frequency transmission and converts it into a stream of transmissions sequentially over many different frequencies. The hopping algorithms and parameters are in principle as varied as designers' imaginings, but traditionally they use a pseudo-random noise (PN) code to pseudo-randomize the jumping, thereby gaining substantial resistance to unauthorized detection, eavesdropping, interference, and jamming. (The receiver uses the same PN code to precisely anticipate the jumps and so receive the signal without degradation.)

Adapting the compositor to frequency hopping usually means simply modifying the DSP programming to insert the appropriate frequency-hopping algorithm and associated arguments. For example, consider the simplest (if not, as of this writing, the most practical) embodiment, FIG. 1. The DSP (104) outputs a composite of multiple RF carriers. Traditionally, each of those carriers would be more-or-less fixed in centerline frequency, at least for the duration of a given transmission. But with the proper frequency-hopping algorithm and data inserted-which software is not an object of this invention—the frequencies of any carriers can hop just exactly as desired with no further schematic changes being required. (Of course, a frequency hopping embodiment might require hardware require changes not noticeable in the diagram, such as using analog components particularly capable of handling extremely rapid and substantial changes in frequencies, or even merely of handling an even broader bandwidth than might otherwise be used in compositing.)

One type of exception to this rule is the external modulator discussed in its own major section above In this case, the DSP's frequency-hopping algorithm will not alter the carriers directly since the output from the DSP is not the carrier but a (potentially modified and properly formatted) control or even baseband signal. Rather, the hopping control would come via the DSP's (rapidly) adjusting the carrier centerline frequency of the modulator(s), often requiring specially capable modulators.

Direct sequence spread spectrum is another animal entirely, significantly more subtle, even magical to the uninitiated. But it's no problem whatever to adapt the compositor toward this clever and capable end.

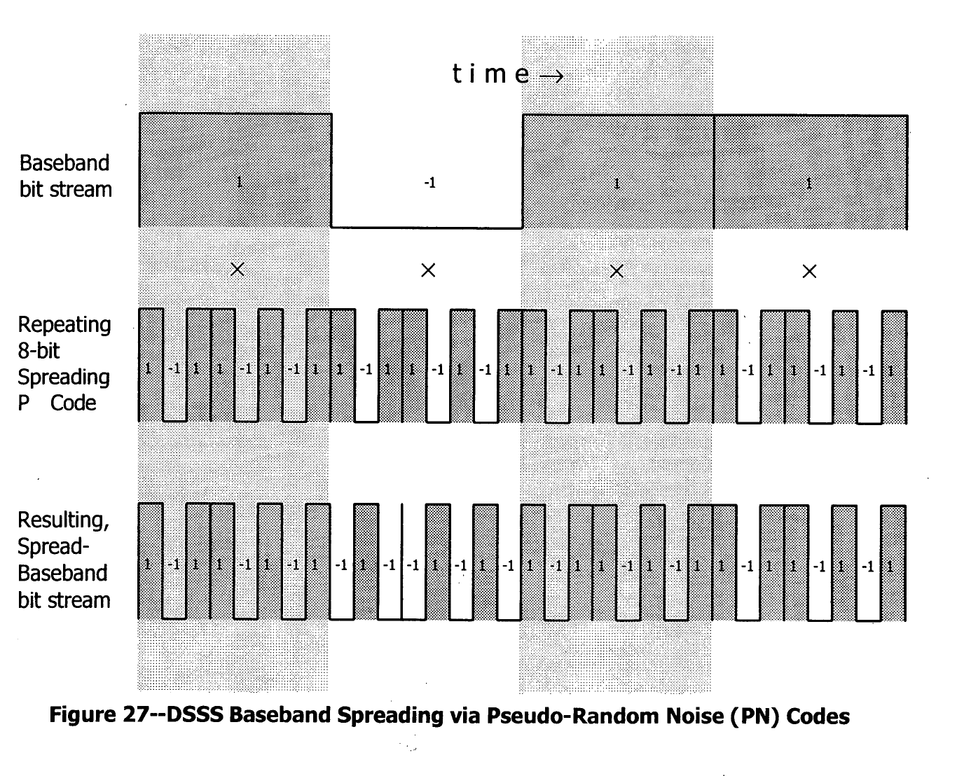

In contrast with frequency hopping, direct sequence spread spectrum spreads the transmitted signal continuously rather than continually. As shown in FIG. 27 (with “0” being replaced by “−1” syntactically to simplify the math-semantically, all that matters is that the stream is two-valued), it does this by multiplying each symbol (typically one bit, but sometimes a single signal will encompass multiple bits) of the baseband signal by a pseudo-random noise code and putting the entire result into the symbol's time slot in the signal, thus substantially increasing the frequency and spreading the signal, i.e., causing the bandwidth consumption to increase dramatically (though at substantially lower, even noise-like power levels per Hz of spectrum consumed). While this higher spectrum width is a drawback-other things being equal, using less bandwidth is most always better than using more-it has advantages that, in many applications, far outweigh that drawback: because of this spreading (and feasibly depending on clever selection of classes of PN codes), not only does DSSS have the benefits listed above for frequency hopping, but amazingly, many transmitters can share the very same centerline frequency and bandwidth without (significant) interference. Receivers extract the relevant signal by multiplying the newly received incoming signals by the identical PN code: the desired signal comes through unscathed, while other, undesired signals are nearly zeroed out by the multiplication. The spread signal is fairly immune to interference from unwanted narrowband signals within the spread spectrum, and conversely appears to narrowband receivers as an indiscernible increase in background noise, not significantly interfering with them due to the extremely low amplitude and pseudo-random nature of the spread spectrum signal.

DSSS typically uses BPSK (Binary Phase Shift Keying) or QPSK (Quaternary Phase Shift Keying), but in principle one could use any modulation type-which type is a matter of indifference to the compositor.

How would DSSS be implemented in the compositor? Let's consider again the simplest embodiment as portrayed in FIG. 1, since the same approach applies to any other embodiment, mutatis mutandis. The fundamental difference would typically be one only of software, simply multiplying the baseband signal times the PN code as described above, and using that product to modulate the carrier(s). (As with FHSS, there would likely be other engineering changes having to do with bandwidth required, filtering, and so forth, but the important details of this will vary with each specific, concrete application and go well beyond the scope of the invention.)

### Combined Embodiments

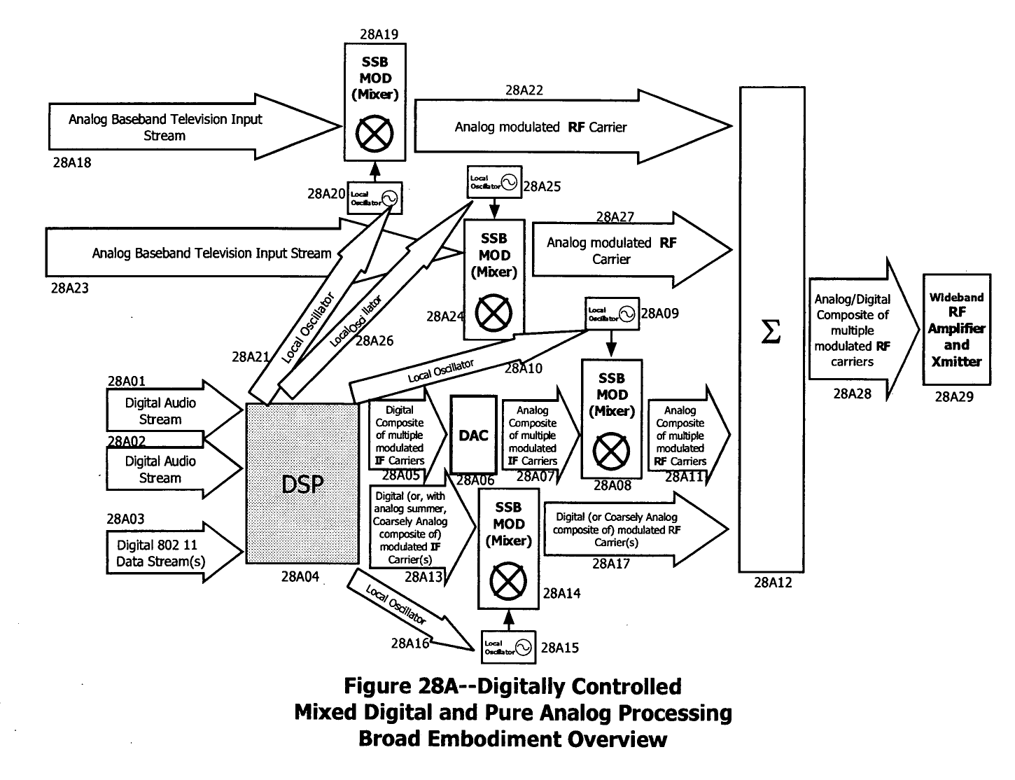

It's useful to understand how various technologies can be used to offer high-utility composite signals, but given that broad conceptual infrastructure (though by no means comprehensive—with the depth, breadth, and pace of technology, such is as impossible as it is unnecessary), it's also useful to see from a higher level some broader embodiments of the compositor, incorporating simultaneously numerous technologies explored above. Such an instance of the compositor could be very useful in optimizing for both cost and flexibility, having certain common signals digitally controlled but processed in analog while leaving the digital signal processing horsepower available for ad hoc modulation of nearly any variety. An example is depicted in FIG. 28A.

FIG. 28A is initially deceptively similar to preceding figures. Three digital input streams (28A01-03) are received by the DSP (28A04), but there the identity ceases. Even before then, actually: the third depicted digital input (28A03) contains one or more data streams intended specifically for 802.11* (the asterisk indicating any of the particular variants within the 802.11 family, as discussed above) wireless broadcast.

The two digital audio input streams (28A01, 02) are processed by the DSP (28A04) into modulated IF (or possibly LF) carriers and then summed, this composite (28A05) then converted to analog by a DAC (28A06), the analog composite then being upconverted by the SSB modulator (28A08), which modulator receives its multiplier local oscillator signal (28A09) under the control (28A10) of the DSP (28A04, of course, this could be a separate control processor—the point is that it's under a digital processor's control, not that it's the same DSP necessarily). The analog upconverted and hence RF carrier (28A11) is then sent to the summer (28A12) to be combined with other signals to form a fuller composite.

The digital 802.11* data stream(s) (28A03) follow a similar path. The DSP (28A04) converts the stream(s) into one or more modulated IF carriers (28A13), the precise conversion process varying wildly with the particular protocol in question, none of which are objects of this invention; if more than one 802.11* carrier is produced, the result (28A13) is a composite of all of them. The (composite) carrier is then sent to an SSB modulator (28A14) for upconversion-this could be a digital modulator (e.g., a DUC), or (if the IF carrier (28A13) is binary, or if a DAC [not shown] is used) analog (perhaps with a slight incoming voltage adjustment, particularly if, as depicted, there's no DAC). The modulator's local oscillator signal (28A15) is, again, controlled (28A16) by the DSP (28A04). The resulting (possibly composite) digital or coarsely analog carrier (28A17) is then sent to the summer (28A12).

Also, two analog baseband television input streams (28A18, -23) are in this depiction received by the system as a whole, but not by the DSP (28A04): these streams are processed entirely in analog while under digital control. The first stream (28A18) is sent to an SSB (or nearly SSB) modulator (28A19), whose local oscillator (28A20) is controlled (28A21) by the DSP (28A04). The resulting analog modulated RF carrier (28A22) is sent to the summer (28A12). The second stream (28A23) is handled likewise, being sent to an upconverting modulator (28A24) whose local oscillator (28A25) is controlled (28A26) by the DSP (28A04; or any digital control processor broadly construed), the resulting carrier (28A27) going to the summer (28A12).

The summer (28A12), receiving collectively the results of all the analog and digital processing, outputs a genuine composite of multiple modulated RF carriers (28A28) which is then transmitted (28A29).

### A Look at Television

With these technically distinctive embodiments behind us, it may be useful to describe the utility and implementation of the compositor at a higher, less technically detailed (but no less important) level by looking at various attempts to accomplish a particular high-level task: broadcasting television signals—conventional analog, SDTV, and HDTV—from a variety of sources to a variety of receivers in a home or office.

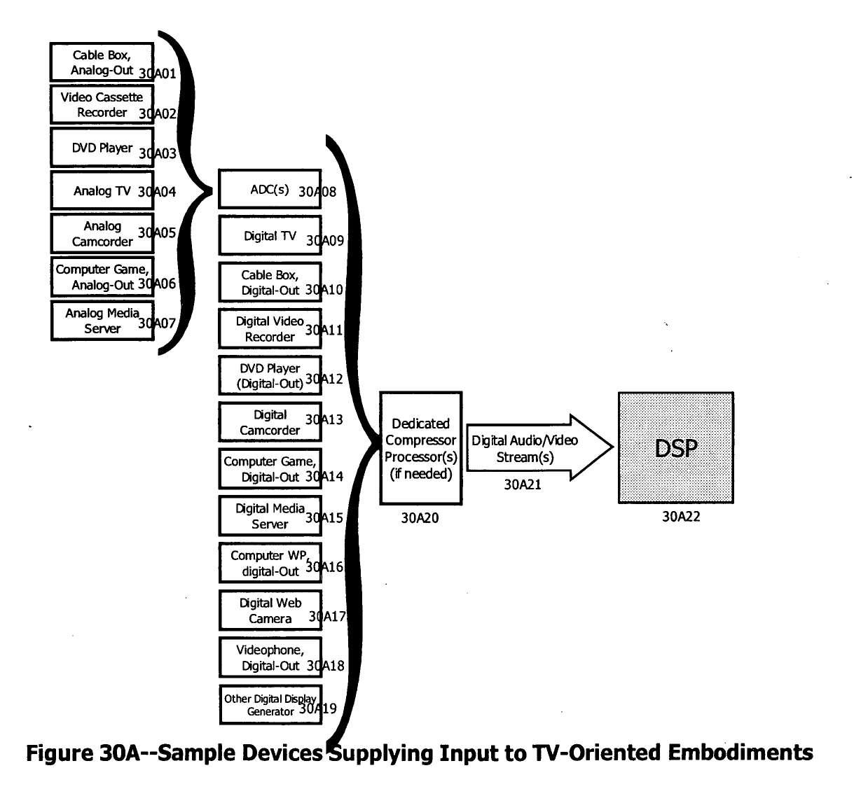

Preliminarily, one should briefly consider the wide variety of devices that might offer input into the compositor as applied to television output, as shown in FIG. 30A.

Older (and ubiquitous) video-outputting devices will commonly be exclusively analog. In this example, we note a cable channel selection box (30A01), video cassette recorder (30A02), DVD player (30A03), conventional analog TV (30A04) with an output feed, conventional analog camcorder with TV-out capability (30A05), and an analog game-display output (30A06) from a video card in a PC (broadly construed, including notebook computers and game consoles, e.g.), which output would typically be TV-out (directly allowing others to follow the game on TV), though it could be in other formats (e.g., analog RGB) so long as the rest of the hardware and software were designed with such in mind. Finally, one could connect an analog-output media server (30A07), a relatively new genre of device for homes or offices which is designed to collect, store, and send entertainment or other media streams to nearby presentation devices.

Any number of these analog devices pass their signals to a suitable quantity of analog-to-digital converters (30A08), which converters are collectively the first of the set of digital video-outputting devices.

The second is a Digital TV with digital auxiliary video out (30A09). (If the digital TV uses analog output, then it is the equivalent for this figure of 30A04; if an analog TV somehow has digital-out, then it is the equivalent of 30A08.) Next is a cable channel selector box (30A10) with digital output, followed by a digital video recorder (30A11—e.g., TiVo or ReplayTV) which permits digital output, a DVD player (30A1 2) which allows digital-out, a digital camcorder (30A13—the preceding parenthetical remarks about digital television apply, mutatis mutandis, here as well), and a computer game as above but with digital video out (30A14). Finally is a digital-output media server (30A15), parallel to the analog version mentioned above (30A07).

Wrapping up the digital-video-out devices in this figure are potentially lower bit-rate devices. One might not only have a game on TV, but even a word processor (30A16), particularly with HDTV. Now whether or not this output will directly have a lower bit rate depends completely upon the nature of the output. If it's simple, uncompressed DVI video output, the bit rate will be the same as with a same-resolution and same-color-depth game, regardless of the comparatively static nature of a word processing screen. However, if the outgoing data are compressed by the source PC in some way (as is the case using desktop-sharing software, or using any of the various MPEG compression schemes), then the bit rate for output will be dramatically lower than for the game since the word processor display area is generally static. (Additionally, a typical gaming scenario does not permit the PC's CPU to spend time doing serious compression work, since that might substantially reduce game performance, which performance is not an issue with simple tasks like word processing.)

Similarly, a simple digital video camera (e.g., a “webcam” [30A17]) will often have a lower bit rate due to some combination of lower frame rates, lower resolution, lower color depths, and built-in compression, as will a typical digital videophone (30A18) or any of many other simpler, digital-image-generating devices (30A19).

Output from any of these devices may optionally (i.e., as the design engineer sees fit) be passed through one or more dedicated compressor processors (30A18). The algorithms that are relevant will depend upon the format and content of the digital signals, but typical methods include MPEG, QuickTime, RealVideo, and WMV/WMA. The digital video streams (30A19), compressed or raw, are then accepted by a DSP (30A20, though possibly more than one DSP is involved a this stage), whence the compositor proceeds as depicted in earlier embodiments.

Once the input is accepted, however, what the DSP does with it and the compositor's proximate, intermediate, and ultimate output depends, of course, on the remainder of the embodiment, including not only the underlying technical methods (which are often enough similar or equivalent in ultimate result), but the intended usage of the compositor. Hence there are several output approaches one might take for a TV-oriented application of the compositor.

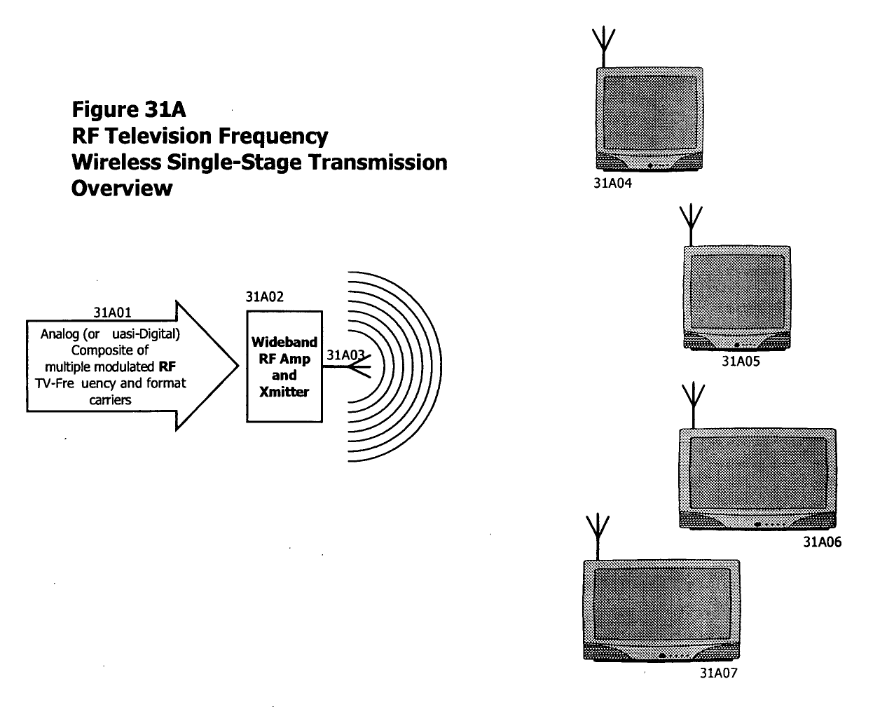

The simplest approach would be that shown in FIG. 31A: a very direct application of the compositor resulting in a simple transmission of the composite of the desired signals in the formats and at the frequencies the legacy receivers, including HDTV receivers, expect. (In the American system, broadcast digital television channels receive spectrum allocations identical in position and size to their analog predecessors of the same channel number.) Indeed, given previous disclosure, the picture barely requires words: some embodiment of the compositor generates an analog (or quasi-digital--the distinction is typically vague with respect to the composite of carriers [or often even individual “digital” carriers], even when it's clear with respect to the data being carried) composite of carriers (31A01), which is then (recapitulating the close of every compositor core embodiment) broadcast (31A02), the result being an RF composite signal (31A03) easily receivable, channel by channel, by conventional televisions (31A04-5) or digital HDTVs (31A05-6).

There's just one problem with this ultimate in simplicity: as of this writing, this approach is illegal in the United States without an FCC TV broadcast license except at powers so low as to make successful transmission impractical at any but the very shortest of ranges. Similar restrictions apply in all or nearly all developed countries.

$$ⅆ u / ⅆ t = {ω}_{1} + {m}_{1} ( t )$$

$$ⅆ v / ⅆ t = {ω}_{2} + {m}_{2} ( t )$$

$$u = {\int }_{0}^{t} \frac{ⅆ u}{ⅆ t} ⅆ t = {ω}_{1} t + {\int }_{0}^{t} {m}_{1} ( τ ) ⅆ τ$$

$$sin ( u ) + sin ( v ) = 2 cos ( \frac{u - v}{2} ) sin ( \frac{u + v}{2} ) v = {\int }_{0}^{t} \frac{ⅆ u}{ⅆ t} ⅆ t = {ω}_{2} t + {\int }_{0}^{t} {m}_{2} ( τ ) ⅆ τ$$

Fortunately, this is anything but the end of the story. We can adapt some of the more sophisticated previous compositor embodiments to accomplish the same or similar ends by subtler means.

$$f = \frac{( {ω}_{1} + {m}_{1} ( t ) ) + ( {ω}_{2} + {m}_{2} ( t ) )}{2} A = {cos ( \frac{u - v}{2} )}_{{ω}_{1}} \\$$

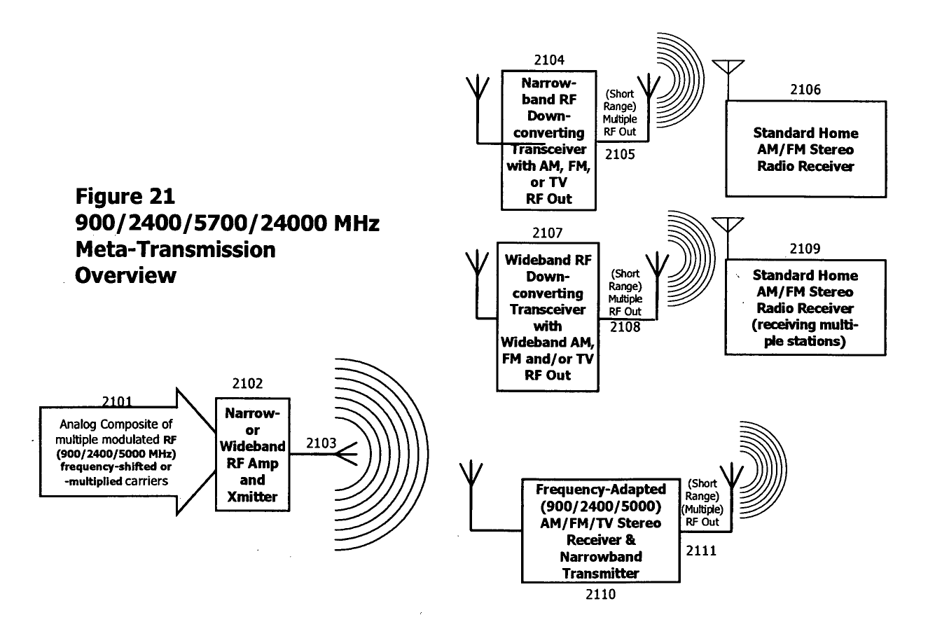

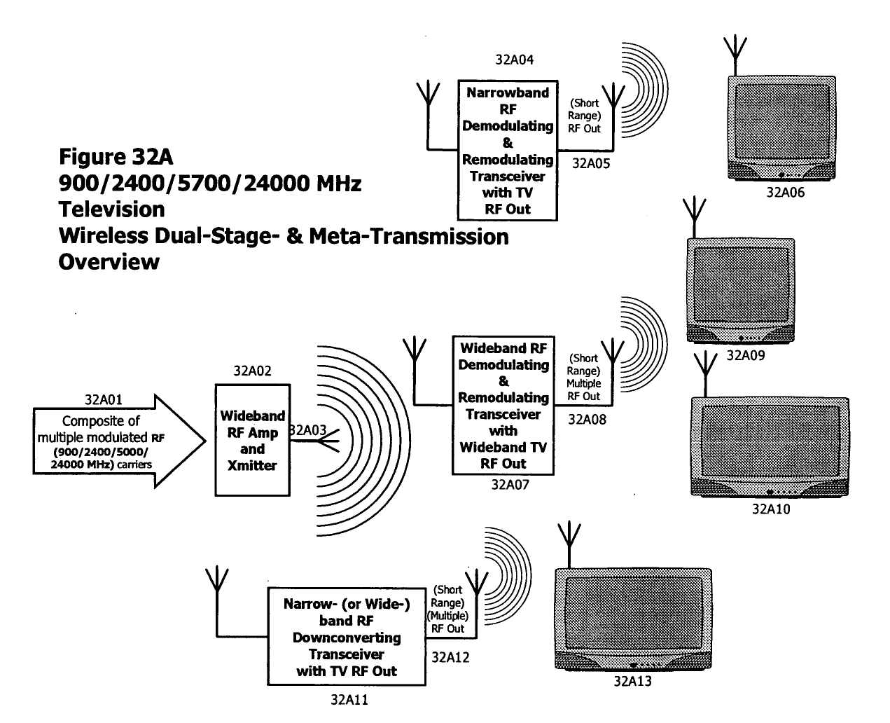

FIG. 32A offers another take on FIGS. 20 and 21, e.g., specifically adapted for television. As in FIG. 31A, some embodiment of the core of compositor generates a composite of multiple RF carriers (32A01), but rather than compositing television frequencies and formats, the device uses one (or more) of the higher, less-regulated frequencies (roughly 900, 2400, 5700, or 24000 MHz, e.g.) in whatever modulation format(s) the designers find optimal for dual-stage and/or meta-transmission. This composite is sent to the transmitter (32A02) and broadcast (32A03). A narrowband receiver (32A04) receives and demodulates the signal to baseband, then remodulates the signal to TV-frequency RF and transmits that signal (32A05) to a nearby television (32A06). A wideband receiver (32A07) receives multiple (in this instance, two) television channels via the aforementioned higher, less regulated frequencies, demodulating the pair of baseband signals and remodulating and transmitting them at the desired (ideally adjacent) RF television frequencies (32A08). A pair of off-the-shelf televisions—one conventional (32A09), one HDTV (32A10) in this example—receive whichever of the pair of carriers that they're tuned to. Finally, a narrowband (it could just as well be wideband, of course) simple downconverting transceiver (32A11) moves the desired signal(s) to television frequency (via mixing or frequency dividing, e.g.) and rebroadcasts it or them (32A12), a television (32A13—HDTV in this example) nearby receiving the signal.

ω_{z} This partially resolves the practical issue of broadcast signal strength; yet even with a nearby transmitter, signal reception may prove problematic due simply to ultra-low FCC limits on signal strength in the television band.

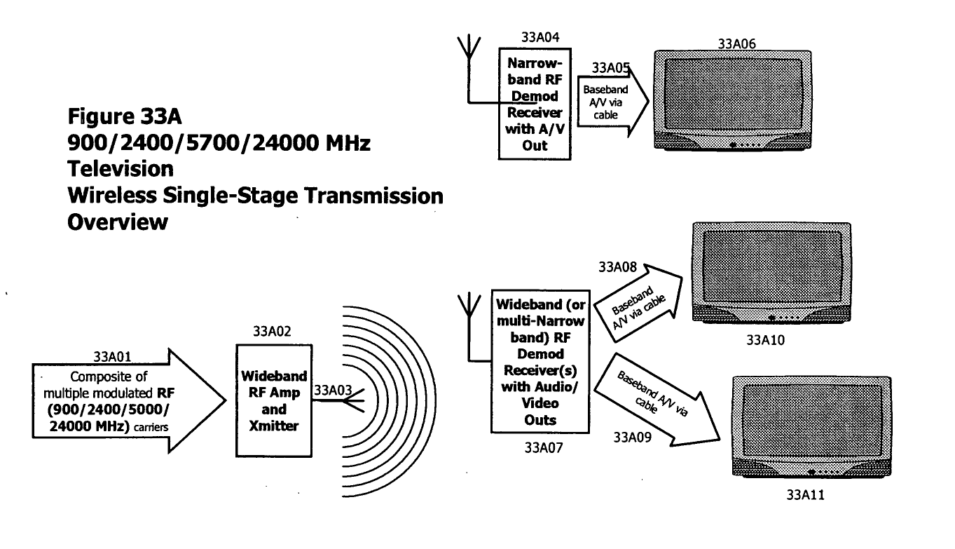

FIG. 33A (somewhat parallel to FIG. 19) offers the obvious solution here, making the final stage via wires rather than ultra-low-power wireless television transmission. The composite of the desired carriers (33A01) is received by the transmitter (33A02) and broadcast (33A03) to the 900, 2400, 5700, or 24000 MHz receivers. The simplest receiver (33A04) demodulates one of the carriers and then passes the baseband A/V signal (or signals) to a television (33A06). A more sophisticated receiver (33A07) demodulates a pair of carriers, sending by wire a signal (33A08, -09) to each of a corresponding pair of televisions (33A10, -11).

Finally, an attractive option for digital carriage of television signals (even analog signals converted to digital) will be via a member of the popular 802.11 series of wireless standards. While the compositor does not apply at all to non-composite 802.11* (the “*” here is meant as a wildcard to include all the subvariants), it can still be an extremely useful complement in special cases—such as the broadcast of multiple television signals to nearby televisions.

A typical high-quality HDTV signal consumes nearly 20 megabits of 802.11a or −g's practical ideal bandwidth of 20-25 megabits a second. While this leaves some room (ideally) for a small amount of additional data, in practice its problematic, and a large amount of data (e.g., another television signal—even a small one) is simply unworkable.

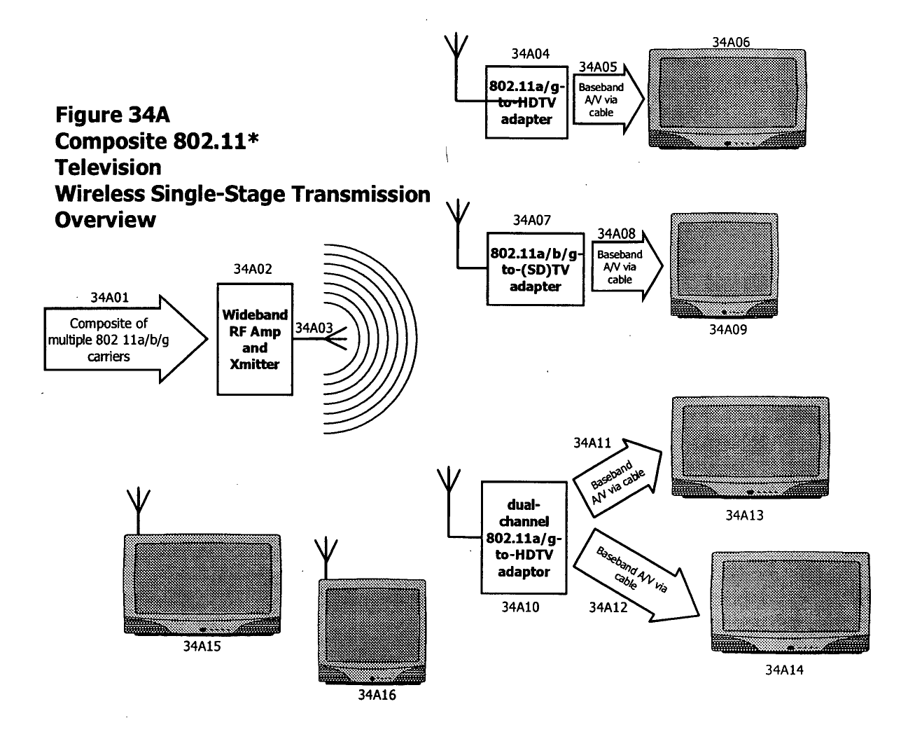

One simple and cost-effective way around this problem is simply to generate and transmit a composite of multiple independent channels, each received by ordinary, off-the-shelf 802.11* receivers. This is shown in FIG. 34A. (More precisely, the composite transmission aspects are depicted—802.11* is an interactive standard [from a network interface perspective], each receiving device also transmitting and vice versa, but the compositing and its utility are collectively the focus here.)

A composite of multiple 802.11-series signals (34A01) is sent to the wideband transmitter (34A02), which then broadcasts them (34A03). (Note that it could sometimes be slightly misleading to novices to call these composited signals simply “carriers”, in that some elements of the series [currently a and g, e.g., with more coming in the near future] use orthogonal frequency division multiplexing [OFDM], such carriers themselves therefore consisting of numerous correlated subcarriers, each subcarrier carrying a small, incomplete portion of the individual message being transmitted at the moment—quite different from the compositor, which much more flexibly composites potentially completely unrelated and uncorrelated message signals to be received potentially by completely unrelated receivers. This noted, further details of the particular modulation approaches used by the various members of the 802.11 family are not material here.)

A simple 802.11a/g receiver (34A04—more precisely, an interactive transceiver as noted above, but the focus here is on the reception component, as is the case for each so-called 802.11 “receiver”) receives a single wireless channel and conducts that signal (in digital form, ideally) to a television (34A06—either conventional TV if the signal is converted to genuine analog first, or SDTV or, as shown, HDTV). If the bandwidth of this single channel is otherwise unused or very lightly used, and if the incoming signal quality is very high, this will permit an entire HDTV channel to be broadcast in near-real-time. (“Near-real” simply to point out that one may well wish to buffer the signal to preclude the almost inevitable occasional delays in transmission, particular if the network channel is being at all shared, or if there's a microwave oven or other 2.4 GHz device nearby [with respect to 802.11g; 802.11a is in the 5700 MHz range].)

Very similarly, another simple receiver (34A07) has an option to receive slower 802.11b signals (in the same frequency band as 802.11g, but using DSSS instead of OFDM—a more robust signal in some cases, but with less bandwidth). 802.11b does not have sufficient bandwidth for an HDTV signal; it does have sufficient bandwidth for a digitized conventional NTSC or PAL signal with compression, or a standard-definition digital television signal (34A08), which is then received by the relevant sort of television (34A09-SDTV, in this example).

One may also have a dual-channel receiver (34A10, akin to 33A07), which then would send one baseband television signal each (34A11, -12) to a pair of, in this example high-definition, televisions (34A13, -14).

Finally, a manufacturer could easily physically integrate 802.11* networking with televisions (31A15, 31A16), making such “transparent” from a user's perspective.

But the compositor makes this genuinely feasible and convenient, allowing multiple channels (wireless network, and therefore [indirectly] television) to be transmitted simultaneously, using established technical standards (with the resulting design and manufacturing cost advantages) and working easily within current (2003) FCC regulations.

Similar applications of the compositor, for similar reasons, appear to apply to the forthcoming 802.16, 802.20, and other similar wireless standards, though this cannot be detailed until the specifications are finalized.

What is claimed is:

1. A local multi-casting system comprising:
means to receive media input;
means to simultaneously wirelessly broadcast a plurality of media signals without interleaving the media signals in transmission; and
means to digitally control receipt and broadcast of media via software.

2. The system of claim 1 further comprising:
wireless broadcast a plurality of media signals using legacy radio frequencies and encoded in legacy modulation formats.

3. The system of claim 1 further comprising:
wireless broadcast of a plurality of media signals using 900-MHz-range radio frequencies.

4. The system of claim 1 further comprising:
wireless broadcast of a plurality of media signals using 2400-MHz-range radio frequencies.

5. The system of claim 1 further comprising:
wireless broadcast of a plurality of media signals using 5700-MHz-range radio frequencies.

6. The system of claim 1 further comprising:
wireless broadcast of a plurality of media signals using 24000-MHz-range radio frequencies.

7. The system of claim 1 further comprising:
means to store received media;
means to digitally control playback of stored media via software.

8. The system of claim 7 further comprising:
means to arrange timing, destination, and specific content of media broadcast via software.

9. The system of claim 1 further comprising:
at least one receiver's using a high-gain receiving antenna oriented to receive the system's wireless broadcast.

10. A digitally controlled signal processing system including:
at least two independent baseband input signals;
at least one digital processor substantially controlling the signal processing;
at least one algorithm, each used by at least one digital processor (“processor”), controlling in conjunction with associated hardware at least one modulated carrier wave in accord with at least one selected modulation format as applied to at least one baseband input signal;
means for processing a plurality of modulation formats;
means for simultaneously processing at least two simple modulated carrier waves of different frequencies; and
means to sum at least two of the modulated carrier waves of different frequencies to create at least one composite supercarrier modulated carrier wave.

11. The system of claim 12, also including a means of amplifying the composite supercarrier prior to transmission.

12. The system of claim 10, also including a means of wireless transmission.

13. The system of claim 10, wherein the means of wireless transmission is via electromagnetic radiation.

14. The system of claim 10 with at least one analog-to-digital converter translating analog input into digital for at least one processor's input.

15. The system of claim 10, also including at least one digital-to-analog converter intervening between at least one processor and the summer.

16. The system of claim 10 in which the summer comprises software programming.

17. The system of claim 10 in which the summer comprises hardware.

18. The system of claim 10, also including at least one algorithm, each used by at least one processor, to digitally create via output sampling at least one modulated carrier wave.

19. The system of claim 10, also including at least one algorithm used by at least one processor, to create the parameters needed by a DS/NCO.

20. The system of claim 10 also including at least one algorithm used by at least one processor to create the parameters needed by a VCO.
